(19) United States
(12) Patent Application Publication
(10) Pub. No.: US 2008/0176596 A1
(43) Pub. Date: Jul. 24, 2008

(54) Communication apparatus, phone set, communication system, communication method and communication program

(75) Inventors: Yongjin Jung, Kanagawa (JP); Kentaro Nakamura, Kanagawa (JP); Masafumi Matsuda, Tokyo (JP); Masaki Kasahara, Tokyo (JP); Kumiko Tokuhara, Tokyo (JP); Akira Tange, Tokyo (JP); Toru Sasaki, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/009,585

(22) Filed: Jan. 18, 2008

(30) Foreign Application Priority Data
Jan. 22, 2007 (JP) JP2007-011899

(51) Int. Cl. H04M 1/00

(52) U.S. Cl. 455/552.1

(57) ABSTRACT

In the present invention, there is provided a communication apparatus including: a first communication section for a communication through a first communication path; a second communication section for a communication through a second communication path; a communication-path determination section to determine whether a present communication path currently being used is the same as a specified communication path specified as a communication path to be used, where the present communication path and the specified communication path are one of the first and second communication path, respectively; and a communication-path switching section to replace one of the first and second communication sections with the other communication section in order to replace the present communication path with the specified communication path in the course of a communication if the determination result produced by the communication-path determination section indicates that the present communication path is not the same as the specified communication path.

### CROSS REFERENCES TO RELATED APPLICATIONS

The present invention contains subject matter related to Japanese Patent Application JP 2007-011899 filed in the Japan Patent Office on Jan. 22, 2007, the entire contents of which being incorporated herein by reference.

### BACKGROUND OF THE INVENTION

1. Field of the Invention

The present invention relates to a communication apparatus, a phone set, a communication system, a communication method and a communication program. For example, the present invention can be well and properly applied to portable communication terminals allowing users of the portable communication terminals each carrying out functions of a communication apparatus to have a phone conversation between the users.

2. Description of the Related Art

By virtue of a function of a phone set making use of the Internet as a path of a communication through a point of access to a radio LAN (Local Area Network), any specific portable communication terminal in related art can be connected to another portable communication terminal for a communication purpose so as to allow the user of the specific portable communication terminal to have a phone conversation with the user of the other portable communication terminal. For more information, the reader is suggested to refer to Japanese Patent Laid-open No. 2006-323448.

In the following description, a phone set making use of the Internet as a communication path through an access point of a radio LAN is referred to as a network phone set whereas the function of a network phone set is referred to as a network phone function.

### SUMMARY OF THE INVENTION

By the way, there has also been proposed a portable communication terminal in related art that can be connected to another portable communication terminal for a communication purpose by virtue of a function of a portable phone set in addition to the network phone function described above so as to allow the user of the proposed portable communication terminal to have a phone conversation with the user of the other portable communication terminal. A portable phone set is defined as a phone set making use of a public phone line network as a path of a communication through a base station provided for portable phone sets. In the following description, the function of a portable phone set is referred to as a portable phone function.

By the way, with the proposed portable communication terminal in related art communicating with another portable communication terminal for the purpose of a phone conversation by making use of either the network phone function or the portable network function, the user of the proposed portable communication terminal in related art may desire to newly connect the proposed portable communication terminal in related art to the other portable communication terminal in related art for the purpose of a communication to continue the phone conversation by replacing the network phone function with the portable network function or replacing the portable phone function with the network phone function due to, for example, a phone-charge reason or a reason of the phone-usage environment, the user needs to enter a communication termination instruction to the proposed portable communication terminal in related art in order to end the communication with the other portable communication terminal. Then, the user needs to carry out an operation to newly connect the proposed portable communication terminal in related art to the other portable communication terminal in related art by making use of the portable phone function or the network phone function for the purpose of a communication to resume the suspended phone conversation. For example, the user carries out the operation to newly connect the proposed portable communication terminal in related art to the other portable communication terminal in related art by once again entering the phone number of the other portable communication terminal in related art to the proposed portable communication terminal in related art. That is to say, when the user wants the proposed portable communication terminal in related art to change the path of a communication in the course of the communication between the proposed portable communication terminal in related art and the other portable communication terminal in related art, the user needs to carry out a cumbersome operation. That is to say, there is a problem of a difficulty to change the path of a communication.

Addressing the problem described above, inventors of the present invention have innovated a communication apparatus, a phone set, a communication system, a communication method and a communication program that allow the path of a communication to be changed in the course of the communication.

In the following description, a communication path being used in the present communication between a communication apparatus according to the present invention and another communication terminal is referred to as a present communication path, which can be a first communication path or a second communication path. On the other hand, a communication path specified by the user as a path to be used for carrying a continuing communication with the other communication terminal is referred to as a specified communication path, which can be the first communication path or the second communication path.

In order to solve the problem described above:

in a communication carried out by a communication apparatus according to the present invention by making use of either a first communication section for carrying out a communication with another communication apparatus through the first communication path or a second communication section for carrying out a communication with the other communication apparatus through the second communication path, the communication apparatus according to the invention produces a result of determination as to whether or not a present communication path is the same communication path as a specified communication path; and

if the result of the determination indicates that the present communication path is not the same communication path as the specified communication path, the communication apparatus according to the invention changes the first or second communication section carrying out the present communication with the other communication terminal with the second or first communication section respectively in a communication-section switching operation.

Thus, in the course of a communication with another communication terminal, the communication apparatus according to the present invention is capable of easily changing the first or second communication section currently carrying out the communication with the second or first communication section in a communication-section switching operation without the need for the user to carry out a cumbersome operation.

In accordance with the present invention, it is possible to implement a communication apparatus, a phone set, a communication system, a communication method and a communication program that allow the path of a communication to be changed with ease in the course of a communication as follows:

In a communication carried out by a communication apparatus according to the present invention by making use of either a first communication section for carrying out a communication with another communication apparatus through the first communication path or a second communication section for carrying out a communication with the other communication apparatus through the second communication path, the communication apparatus according to the invention produces a result of determination as to whether or not a present communication path is the same communication path as a specified communication path; and

if the result of the determination indicates that the present communication path is not the same communication path as the specified communication path, the communication apparatus according to the invention changes the first or second communication section carrying out the present communication with the other communication terminal with the second or first communication section respectively in a communication-section switching operation.

### BRIEF DESCRIPTION OF THE DRAWINGS

These and other objects and features of the present invention will become clear from the following description of the preferred embodiments given with reference to the accompanying diagrams, in which:

FIG. 1 is a block diagram roughly showing the configuration of a communication apparatus according to an embodiment of the present invention;

FIG. 2 is a diagram roughly showing an entire communication system according to a first embodiment of the present invention;

FIG. 3 is a block diagram showing a detailed configuration of a portable communication terminal according to the first embodiment of the present invention;

FIG. 4 is an explanatory diagram showing a phone-number list;

FIG. 5 is an explanatory diagram roughly showing switching of a communication path from a public phone-line network to the Internet;

FIG. 6 is an explanatory diagram roughly showing switching of a communication path from the Internet to the public phone-line network;

FIG. 7 shows a flowchart representing the procedure of first processing to switch a communication path;

FIG. 8 shows a flowchart representing the procedure of second processing to switch a communication path;

FIG. 9 is a diagram roughly showing an entire communication system according to a second embodiment of the present invention; and

FIG. 10 is a block diagram showing a detailed configuration of a portable communication terminal according to the second embodiment of the present invention.

### DETAILED DESCRIPTION OF THE PREFERRED EMBODIMENTS

Preferred embodiments of the invention are explained in detail by referring to diagrams as follows.

### (1) Overview of the Embodiments

As described above, in the following description, a communication path being used in the present communication between a communication apparatus according to the present invention and another communication terminal is referred to as a present communication path, which can be a first communication path or a second communication path. On the other hand, a communication path specified by the user as a path to be used for carrying a continuing communication with the other communication terminal is referred to as a specified communication path, which can be the first communication path or the second communication path.

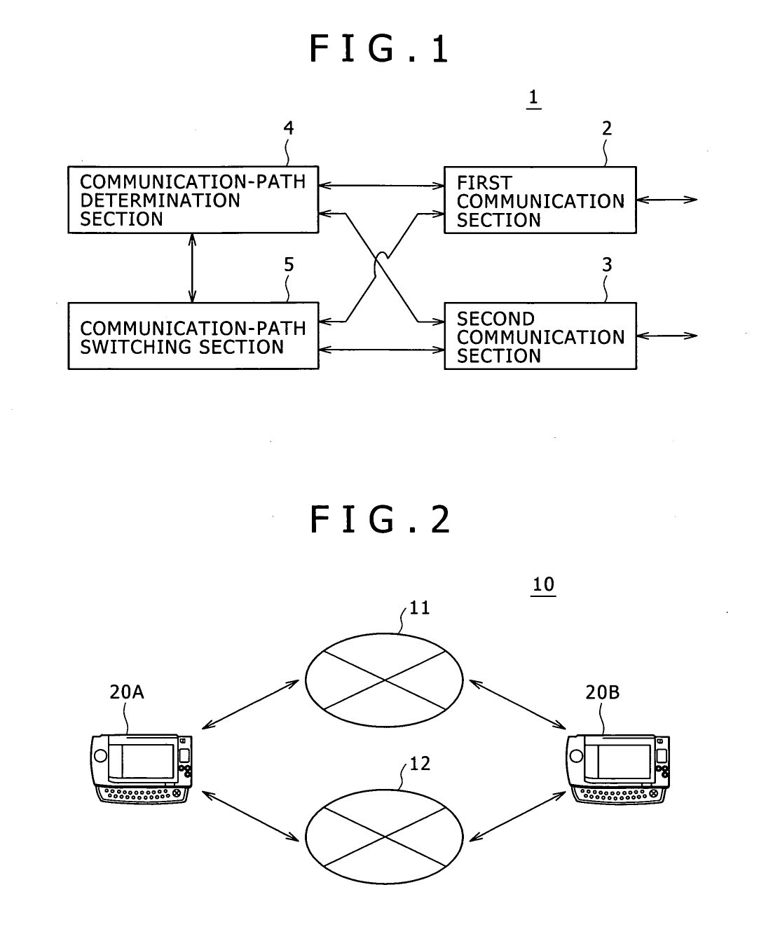

FIG. 1 is a block diagram roughly showing the entire configuration of a communication apparatus 1 according to an embodiment of the present invention. A first communication section 2 employed in the communication apparatus 1 is a unit for carrying out a communication with another communication apparatus through the first communication path. By the same token, a second communication section 3 employed in the communication apparatus 1 is a unit for carrying out a communication with another communication apparatus through the second communication path. A communication-path determination section 4 employed in the communication apparatus 1 is a unit for producing a result of determination as to whether or not a present communication path is the same communication path as a specified communication path. A communication-path switching section 5 employed in the communication apparatus 1 is a unit for replacing the first or second communication section carrying out the present communication with the other communication apparatus with the second or first communication section respectively in a communication-section switching operation if the determination result produced by the communication-path determination section 4 indicates that present communication path is not the same communication path as the specified communication path.

With the configuration described above, in the course of a communication with another communication apparatus, the communication apparatus 1 is capable of easily replacing the first or second communication section carrying out the communication with the second or first communication section respectively in a communication-section switching operation without the need for the user to carry out a cumbersome operation. Thus, in the course of a communication with another communication apparatus, the communication apparatus 1 is capable of easily changing the path of the communication.

### (2) First Embodiment

### (2-1) Configuration of the Communication System

FIG. 2 is a diagram roughly showing an entire communication system 10 according to a first embodiment of the present invention. The communication system 10 includes first and second portable communication terminals 20A and 20B, to which the communication apparatus 1 described above by referring to FIG. 1 is applied. The first and second portable communication terminals 20A and 20B each have a function of a portable phone set used for a phone conversation between the users of the first and second portable communication terminals 20A and 20B. A portable phone set is defined as a phone set making use of a public phone line network 11 as a first path of a communication through a base station provided for portable phone sets. It is to be noted that the base station itself is not shown in the figure. In the following description, the function of a portable phone set is referred to as a portable phone function. In addition, the first and second portable communication terminals 20A and 20B each also have a function of a network phone set used for a phone conversation between the users of the first and second portable communication terminals 20A and 20B. A network phone set is defined as a phone set making use of the Internet 12 as a second path of a communication through a point of access to a LAN (Local Area Network). It is to be noted that the access point itself is not shown in the figure. In the following description, the function of a network phone set is referred to as a network phone function.

In actuality, the communication system 10 shown in FIG. 2 includes more portable communication terminals besides the first portable communication terminal 20A and the second portable communication terminal 20B. However, the first portable communication terminal 20A and the second portable communication terminal 20B represent any two of all portable communication terminals included in the communication system 10.

Thus, by making use of the portable phone function, either one of the first and second portable communication terminals 20A and 20B in the communication system 10 can be connected to the base station through a radio connection and is thus made capable of carrying out a communication for a phone conversation with the other one of the first and second portable communication terminals 20A and 20B from the base station through the public communication-line network 11, which is connected to the base station. By the same token, by making use of the network phone function, either one of the first and second portable communication terminals 20A and 20B in the communication system 10 can be linked to the access point through a radio connection and is thus made capable of carrying out a communication for a phone conversation with the other one of the first and second portable communication terminals 20A and 20B from the access point through the Internet 12, which is connected to the access point.

### (2-2) Circuit Configuration of the Portable Communication Terminal

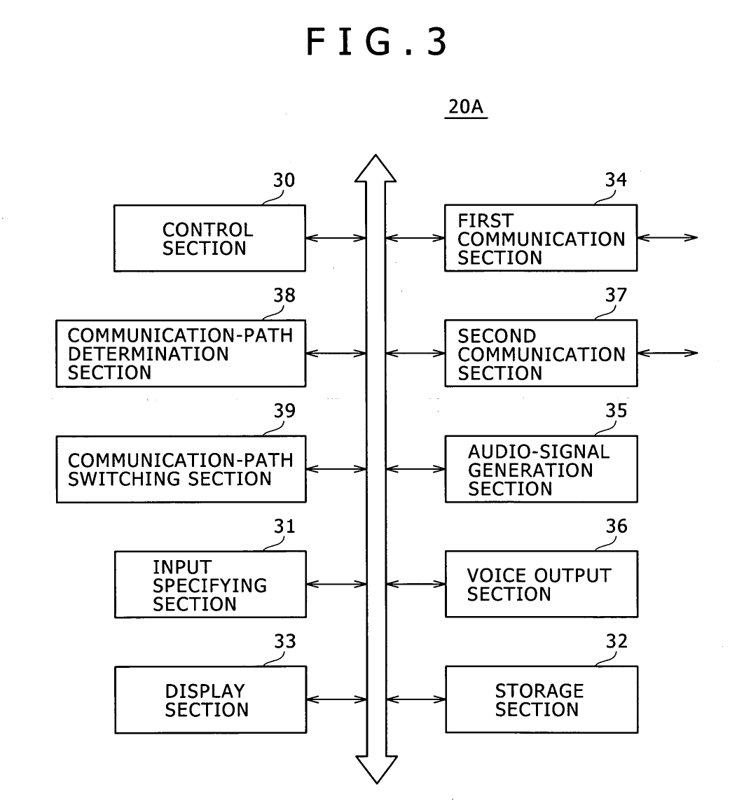

The first and second portable communication terminals 20A and 20B, which are employed in the communication system 10, have configurations identical with each other. Thus, the detailed hardware configuration of only the first portable communication terminal 20A is explained below by referring to a functional block diagram of FIG. 3. That is to say, the detailed hardware configuration of the second portable communication terminal 20B is not explained and, therefore, no functional block diagram showing the second portable communication terminal 20B is given. A control section 30 employed in the first portable communication terminal 20A is a unit for carrying out various kinds of processing, for example, in accordance with operations carried out by the user on a variety of keys employed in an input specifying section 31 in order to enter a variety of instructions to the first portable communication terminal 20A.

By the way, a phone number is assigned to each of the first and second portable communication terminals 20A and 20B as an identification unique to each of the first and second portable communication terminals 20A and 20B. The phone number is used by the portable phone function as an identification for linking the first or second portable communication terminal 20A and 20B to the second and first portable communication terminal 20B or 20A respectively in a radio connection. In the following description, a phone number used by the portable phone function as a unique identification is referred to as a portable phone number.

In addition, another phone number is assigned to each of the first and second portable communication terminals 20A and 20B as an identification unique to each of the first and second portable communication terminals 20A and 20B. The phone number is used by the network phone function as an identification for linking the first or second portable communication terminal 20A and 20B to the second and first portable communication terminal 20B or 20A respectively in a radio connection. In the following description, a phone number used by the network phone function as a unique identification is referred to as a network phone number or an Internet phone number.

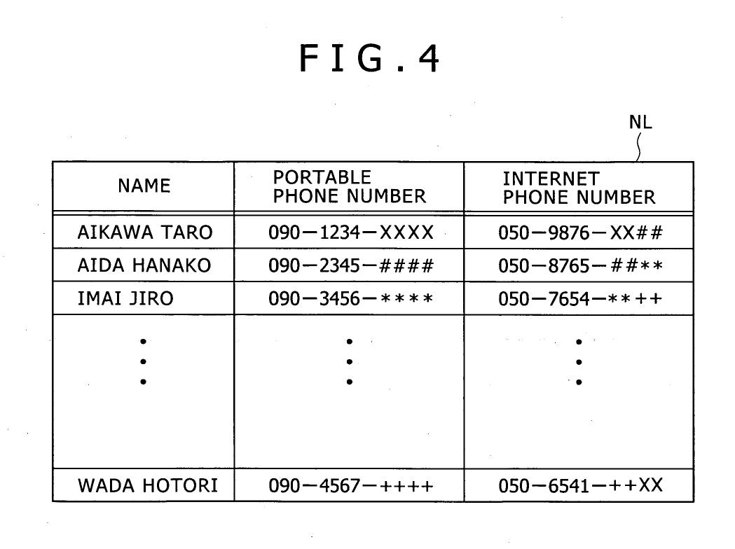

FIG. 4 is an identification list, generated by the control section 30 and stored in a storage section 32, showing the name of each phone-conversation partner or a user owning the other portable communication terminal, a portable phone number and a network phone number, which are assigned to the other portable communication terminal by associating the name, the portable phone number and the network phone number with each other. The other portable communication terminal is a portable communication terminal other than the portable communication terminal owned by the user. In the above description, the first portable communication terminal 20A is the portable communication terminal owned by the user whereas the second portable communication terminal 20B is the other portable communication terminal. In the following description, the identification list is referred to as a phone-number list NL.

When the user operates the input specifying section 31 in order to enter a request to search for the phone number of another user who owns the second portable communication terminal 20B and is to serve as a phone-conversation partner, the control section 30 reads out the phone-number list NL from the storage section 32. Then, the control section 30 generates data of a screen for allowing the user to select a phone number from those shown on the phone-number list NL and outputs the data to a display section 33. The display section 33 makes use of the data of a screen for selecting a phone number to display the screen, which is not shown in the figure. With a screen displayed on the display section 33 as the screen used by the user for selecting a phone number, let us assume for example that the user operates the input specifying section 31 to select the portable phone number of the second portable communication terminal 20B owned by the other user to serve as a phone-conversation partner from phone numbers appearing on the screen and enters a call instruction to make an outgoing phone call to the second portable communication terminal 20B. In this case, the control section 30 creates portable-phone call data according to the entered call instruction. In the following description, a call instruction to make an outgoing phone call for the second portable communication terminal 20B by making use of a portable phone number is referred to as a portable-phone call instruction.

The portable-phone call data includes a portable phone number specified by the user as communication-partner specifying information showing the second portable communication terminal 20B owned by another user to serve as a phone-conversation partner. In addition, the portable-phone call data also includes a portable phone number assigned to the first portable communication terminal 20A as communication-originator specifying information showing the first portable communication terminal 20A owned by the user serving as the phone-conversation originator. On top of that, the portable-phone call data also includes communication-path specifying information showing the public communication-line network 11 to be used in a communication for a phone conversation by execution of the portable phone function. The control section 30 then outputs the portable-phone call data to a first communication section 34.

The first communication section 34 carries out processing determined in advance on the portable-phone call data received from the control section 30 in order to generate a portable-phone call signal and sends the signal to a base station provided for portable phone sets. In this way, the first communication section 34 sends the portable-phone call signal to the second portable communication terminal 20B from the base station through the public communication-line network 11, which is connected to the base station, in order to call the other user operating the second portable communication terminal 20B by making use of the portable phone function.

Then, the first communication section 34 receives a connection permission signal from the second portable communication terminal 20B through the base station. For example, the second portable communication terminal 20B sends such a connection permission signal to the first portable communication terminal 20A when the other user operating the second portable communication terminal 20B enters an on-hook instruction to the second portable communication terminal 20B. An on-hook instruction is a connection permission instruction allowing a connection of a communication to be established between the first portable communication terminal 20A and the second portable communication terminal 20B. Then, the first communication section 34 carries out processing determined in advance on the connection permission signal in order to generate connection permission data and supplies the data to the control section 30. On the basis of the connection permission data received from the first communication section 34, the control section 30 recognizes the establishment of the connection of a communication making use of the public communication-line network 11 between the first portable communication terminal 20A and the second portable communication terminal 20B. Then, the control section 30 notifies a communication-path switching section 39 that a connection of a communication making use of the public communication-line network 11 has been established between the first portable communication terminal 20A and the second portable communication terminal 20B.

In accordance with the notice received from the control section 30, the communication-path switching section 39 connects the first communication section 34 to an audio-signal generation section 35 and a voice output section 36. The audio-signal generation section 35 such as a microphone is a unit for converting a voice output by the user into audio data. Connected to the first communication section 34, the audio-signal generation section 35 picks a voice output by the user, generates audio data of the voice and outputs the data to the first communication section 34. In the following description, such audio data is referred to as outgoing audio data. The first communication section 34 carries out processing determined in advance on the outgoing audio data received from the audio-signal generation section 35 in order to generate an audio signal referred to hereafter as an outgoing audio signal and sends the outgoing audio signal to the base station. Thus, the first communication section 34 sends the outgoing audio signal to the second portable communication terminal 20B from the base station through the public communication-line network 11, which is connected to the base station.

At that time, when the second portable communication terminal 20B sends an audio signal conveying a voice of the other user operating the second portable communication terminal 20B to the first portable communication terminal 20A through the public communication-line network 11, the first communication section 34 receives the audio signal through the base station. In the following description, the audio signal received by the first portable communication terminal 20A from the second portable communication terminal 20B is referred to as an incoming audio signal. The first communication section 34 carries out processing determined in advance on the incoming audio signal in order to generate audio data referred to hereafter as incoming audio data and outputs the incoming audio data to the voice output section 36. The voice output section 36 such as a speaker is a unit for converting incoming audio data into a voice. Receiving the incoming audio data from the first communication section 34, the voice output section 36 outputs a voice based on the data. In this way, the control section 30 lets a phone conversation between the user of the first portable communication terminal 20A and the user of the second portable communication terminal 20B go on.

In addition, the first communication section 34 may receive a portable phone arrival signal indicating an incoming call for the first portable communication terminal 20A from the second portable communication terminal 20B through the base station as a signal sent by the second portable communication terminal 20B through the public communication-line network 11, which is connected to the base station. The portable phone arrival signal conveys a portable phone number assigned to the first portable communication terminal 20A. The portable phone number assigned to the first portable communication terminal 20A is communication-partner specifying information specified by the other user operating the second portable communication terminal 20B as information showing the first portable communication terminal 20A, which is a portable communication terminal held by a user to serve as the phone-conversation partner of the other user operating the second portable communication terminal 20B. In addition, the portable phone arrival signal also conveys a portable phone number assigned to the second portable communication terminal 20B. The portable phone number assigned to the second portable communication terminal 20B is communication-originator specifying information showing the second portable communication terminal 20B, which is a portable communication terminal held by the other user serving as a phone-conversation originator. On top of that, the portable phone arrival signal also conveys communication-path specifying information showing the public communication-line network 11 to be used in a communication for a phone conversation by execution of the portable phone function.

Receiving the portable phone arrival signal, the first communication section 34 carries out processing determined in advance on the signal in order to obtain portable phone arrival data and supplies the data to the control section 30. In accordance with the portable phone arrival data, the control section 30 rings a ringer not shown in the figure or drives a vibrator also not shown in the figure in order to put the first portable communication terminal 20A in a vibration state. In this way, the first portable communication terminal 20A notifies the user of an incoming phone call.

In addition, the control section 30 collates a portable phone number indicated by the communication-originator specifying information included in the portable phone arrival data with all portable phone numbers on the phone-number list NL stored in the storage section 32 in order to identify the name of the other user operating the second portable communication terminal 20B serving as the communication originator. The user of the second portable communication terminal 20B is a phone-conversation partner making the incoming phone call for the user of the first portable communication terminal 20A by making use of the portable phone function. On the basis of the name identified as the name of the other user operating the second portable communication terminal 20B and the portable phone arrival data, the control section 30 generates incoming-call notification screen data and outputs the incoming-call notification screen data to the display section 33 in order to display an incoming-call notification screen based on the incoming-call notification screen data on the display section 33. It is to be noted that the incoming-call notification screen itself is not shown in the figure.

In this case, the incoming-call notification screen displays the name of the other user operating the second portable communication terminal 20B, a portable phone number assigned to the second portable communication terminal 20B and information on a communication path used in the present communication. The name of the other user operating the second portable communication terminal 20B is the name a phone-conversation partner making the incoming phone call for the user of the first portable communication terminal 20A. The portable phone number is a phone number indicated by the communication-originator specifying information. The information on a communication path used in the present communication is, for example, the name of the communication path. In this way, the incoming-call notification screen displayed by the control section 30 on the display section 33 shows the name of the other user making a request for a phone conversation with the user of the first portable communication terminal 20A, a portable phone number assigned to the second portable communication terminal 20B held by the other user and the name of the communication path used in the present communication.

At that time, if the user of the first portable communication terminal 20A operates the input specifying section 31 in order to enter an on-hook instruction serving as an instruction allowing a connection of a communication with the second portable communication terminal 20B to be established to the first portable communication terminal 20A, the control section 30 generates connection permission data showing permission of the connection of a communication and supplies the data to the first communication section 34. The first communication section 34 carries out processing determined in advance on the connection permission data received from the control section 30 in order to generate a connection permission signal and sends the signal to the base station. In this way, the first communication section 34 sends the connection permission signal to the second portable communication terminal 20B from the base station through the public communication-line network 11, which is connected to the base station, in order to establish the connection of a communication between the first portable communication terminal 20A and the second portable communication terminal 20B.

In addition, the control section 30 also notifies the communication-path switching section 39 that the connection permission signal has been sent by the control section 30 to the first communication section 34. In accordance with the notice received from the control section 30, the communication-path switching section 39 connects the first communication section 34 to the audio-signal generation section 35 and the voice output section 36. In a way similar to what has been described above, the control section 30 controls the first communication section 34 to send outgoing audio data generated by the audio-signal generation section 35 to the second portable communication terminal 20B through the public communication-line network 11 as an outgoing audio signal. In addition, the control section 30 also controls the first communication section 34 to receive an incoming audio signal from the second portable communication terminal 20B and supplies the signal to the voice output section 36 for outputting the signal as a voice conveyed by the signal. In this way, when the first portable communication terminal 20A receives an incoming call from the second portable communication terminal 20B and the user of the first portable communication terminal 20A allows a response to the incoming call to be returned to the second portable communication terminal 20B, the control section 30 establishes a communication for a phone conversation between the user of the first portable communication terminal 20A and the other user operating the second portable communication terminal 20B.

As described above, when the user operates the input specifying section 31 in order to enter a request to search for the phone number of another user who owns the second portable communication terminal 20B and is to serve as a phone-conversation partner, the control section 30 reads out the phone-number list NL from a storage section 32. Then, the control section 30 generates data of a screen for selecting a phone number on the basis of the phone-number list NL and outputs the data to the display section 33. The display section 33 makes use of the data of a screen used for selecting a phone number to display the screen, which is not shown in the figure. With a screen displayed on the display section 33 as the screen used for selecting a phone number, let us assume for example that the user operates the input specifying section 31 to select the network phone number of the second portable communication terminal 20B owned by the other user to serve as a phone-conversation partner from phone numbers appearing on the screen and enters a call instruction to make an outgoing phone call for the second portable communication terminal 20B. In this case, the control section 30 creates network-phone call data according to the entered call instruction. In the following description, a call instruction to make an outgoing phone call for the second portable communication terminal 20B by making use of a network phone number is referred to as a network-phone call instruction.

The network-phone call data includes a network phone number specified by the user as communication-partner specifying information showing the second portable communication terminal 20B owned by another user to serve as a phone-conversation partner. In addition, the network-phone call data also includes a network phone number assigned to the first portable communication terminal 20A as communication-originator specifying information showing the first portable communication terminal 20A owned by the user serving as the phone-conversation originator. On top of that, the network-phone call data also includes communication-path specifying information showing the Internet 12 to be used in a communication for a phone conversation by execution of the network phone function. The control section 30 then outputs the network-phone call data to a second communication section 37.

The second communication section 37 carries out processing determined in advance on the network-phone call data received from the control section 30 in order to generate a network-phone call signal and sends the signal to a point of access to the LAN. In this way, the second communication section 37 sends the network-phone call signal to the second portable communication terminal 20B from the access point through the Internet 12, which is connected to the access point, in order to call the other user operating the second portable communication terminal 20B by making use of the network phone function.

Then, the second communication section 37 receives a connection permission signal from the second portable communication terminal 20B through the access point. For example, the second portable communication terminal 20B sends such a connection permission signal to the first portable communication terminal 20A when the other user operating the second portable communication terminal 20B enters an on-hook instruction to the second portable communication terminal 20B. An on-hook instruction is a connection permission instruction allowing a connection of a communication to be established between the first portable communication terminal 20A and the second portable communication terminal 20B. Then, the second communication section 37 carries out processing determined in advance on the connection permission signal in order to generate connection permission data and supplies the data to the control section 30. On the basis of the connection permission data received from the second communication section 37, the control section 30 recognizes the establishment of the connection of a communication making use of the Internet 12 between the first portable communication terminal 20A and the second portable communication terminal 20B. Then, the control section 30 notifies the communication-path switching section 39 that a connection of a communication making use of the Internet 12 has been established between the first portable communication terminal 20A and the second portable communication terminal 20B.

In accordance with the notice received from the control section 30, the communication-path switching section 39 connects the second communication section 37 to the audio-signal generation section 35 and the voice output section 36. Connected to the second communication section 37, the audio-signal generation section 35 collects a voice output by the user, generates audio data of the voice and outputs the data to the second communication section 37. In the following description, such audio data is referred to as outgoing audio data. The second communication section 37 carries out processing determined in advance on the outgoing audio data received from the audio-signal generation section 35 in order to generate an audio signal referred to hereafter as an outgoing audio signal and sends the outgoing audio signal to the access point. Thus, the second communication section 37 sends the outgoing audio signal to the second portable communication terminal 20B from the access point through the Internet 12, which is connected to the access point.

At that time, when the second portable communication terminal 20B sends an audio signal conveying a voice of the other user operating the second portable communication terminal 20B to the first portable communication terminal 20A through the Internet 12, the second communication section 37 receives the audio signal through the access point as an incoming audio signal. In the following description, the audio signal received by the first portable communication terminal 20A from the second portable communication terminal 20B is referred to as an incoming audio signal. The second communication section 37 carries out processing determined in advance on the incoming audio signal in order to generate audio data referred to hereafter as incoming audio data and outputs the incoming audio data to the voice output section 36. Receiving the incoming audio data from the second communication section 37, the voice output section 36 outputs a voice based on the data. In this way, the control section 30 lets a phone conversation between the user of the first portable communication terminal 20A and the user of the second portable communication terminal 20B go on.

In addition, the second communication section 37 may receive a network phone arrival signal indicating an incoming call for the first portable communication terminal 20A from the second portable communication terminal 20B through the access point as a signal sent by the second portable communication terminal 20B through the Internet 12, which is connected to the access point. The network phone arrival signal conveys a network phone number assigned to the first portable communication terminal 20A. The network-phone number assigned to the first portable communication terminal 20A is communication-partner specifying information specified by the other user operating the second portable communication terminal 20B as information showing the first portable communication terminal 20A, which is a network communication terminal held by a user to serve as the phone-conversation partner of the other user operating the second portable communication terminal 20B. In addition, the network phone arrival signal also conveys a network phone number assigned to the second portable communication terminal 20B. The network-phone number assigned to the second portable communication terminal 20B is communication-originator specifying information showing the second portable communication terminal 20B, which is a network communication terminal held by the other user serving as a phone-conversation originator. On top of that, the network phone arrival signal also conveys communication-path specifying information showing the Internet 12 to be used in a communication for a phone conversation by execution of the network phone function.

Receiving the network-phone arrival signal, the second communication section 37 carries out processing determined in advance on the signal in order to obtain network-phone arrival data and supplies the data to the control section 30. In accordance with the network-phone arrival data, the control section 30 rings a ringer not shown in the figure or drives a vibrator also not shown in the figure in order to put the first portable communication terminal 20A in a vibration state. In this way, the first portable communication terminal 20A notifies the user of an incoming phone call.

In addition, the control section 30 collates a network-phone number indicated by the communication-originator specifying information included in the network-phone arrival data with all network-phone numbers put on the phone-number list NL stored in the storage section 32 in order to identify the name of the other user operating the second portable communication terminal 20B serving as the communication originator. The user of the second portable communication terminal 20B is a phone-conversation partner making the incoming phone call for the user of the first portable communication terminal 20A by making use of the network-phone function. On the basis of the name identified as the name of the other user operating the second portable communication terminal 20B and the network-phone arrival data, the control section 30 generates incoming-call notification screen data and outputs the incoming-call notification screen data to the display section 33 in order to display an incoming-call notification screen based on the incoming-call notification screen data on the display section 33. It is to be noted that the incoming-call notification screen itself is not shown in the figure.

In this case, the incoming-call notification screen displays the name of the other user operating the second portable communication terminal 20B, a network-phone number assigned to the second portable communication terminal 20B and information on a communication path used in the present communication. The name of the other user operating the second portable communication terminal 20B is the name a phone-conversation partner making the incoming phone call for the user of the first portable communication terminal 20A. The network-phone number is a phone number indicated by the communication-originator specifying information. The information on a communication path used in the present communication is, for example, the name of the communication path. In this way, the incoming-call notification screen displayed by the control section 30 on the display section 33 shows the name of the other user making a request for a phone conversation with the user of the first portable communication terminal 20A, a network-phone number assigned to the second portable communication terminal 20B held by the other user and the name of the communication path used in the present communication.

At that time, if the user of the first portable communication terminal 20A operates the input specifying section 31 in order to enter an on-hook instruction serving as an instruction allowing a connection of a communication with the second portable communication terminal 20B to be established to the first portable communication terminal 20A, the control section 30 generates connection permission data showing permission of the connection of a communication and supplies the data to the second communication section 37. The second communication section 37 carries out processing determined in advance on the connection permission data received from the control section 30 in order to generate a connection permission signal and sends the signal to the access point. In this way, the second communication section 37 sends the connection permission signal to the second portable communication terminal 20B from the access point through the Internet 12, which is connected to the access point, in order to establish the connection of a communication between the first portable communication terminal 20A and the second portable communication terminal 20B.

In addition, the control section 30 also notifies the communication-path switching section 39 that the connection permission signal has been sent by the control section 30 to the second communication section 37. In accordance with the notice received from the control section 30, the communication-path switching section 39 connects the second communication section 37 to the audio-signal generation section 35 and the voice output section 36. In a way similar to what has been described above, the control section 30 controls the second communication section 37 to send outgoing audio data generated by the audio-signal generation section 35 to the second portable communication terminal 20B through the Internet 12 as an outgoing audio signal. In addition, the control section 30 also controls the second communication section 37 to receive an incoming audio signal from the second portable communication terminal 20B and supplies the signal to the voice output section 36 for outputting the signal as a voice conveyed by the signal. In this way, when the first portable communication terminal 20A receives an incoming call from the second portable communication terminal 20B and the user of the first portable communication terminal 20A allows a response to the incoming call to be returned to the second portable communication terminal 20B, the control section 30 establishes a communication for a phone conversation between the user of the first portable communication terminal 20A and the other user operating the second portable communication terminal 20B.

By the way, a communication based on the portable phone function can be carried out by making use of the public communication-line network 11 connected to a number of installed base stations without regard to whether the first portable communication terminal 20A and the second portable communication terminal 20B are used indoors or outdoors. Thus, a communication based on the portable phone function offers a merit that the communication can be carried out at any place almost without limitations on the communication locations. In the case of a communication based on the portable phone function, however, a communication company must, for example, maintain and manage the public communication-line network 11 used as a path of communication and a number of installed base stations connected to the public communication-line network 11. For this reason, the communication company charges relatively high communication fees to users utilizing communications based on the portable phone function for their phone conversations in order to cover the cost to maintain and manage the public communication-line network 11 and the numerous installed base stations.

On the other hand, a communication based on the network phone function is carried out by making use of the Internet 12 connected to very few access points in comparison with the base points and, in addition, the access points are installed mostly indoors. For this reason, in the case of a communication based on the network phone function, the communication locations are considerably limited. Since a communication based on the network phone function is carried out by making use of the Internet 12 already utilized in communications between computers and other communications as a path of communication, however, the communication based on the network phone function offers a merit of a very low communication fee to be charged to a user making use the communication in a phone conversation.

For the reasons described above, the control section 30 allows the user to properly select either the network phone function or the portable phone function in accordance with the condition for utilizing the first portable communication terminal 20A and use the selected function for carrying out a communication with a phone-conversation partner. The condition for utilizing the first portable communication terminal 20A includes the phone-usage environment and the communication fee.

### (2-3) Communication-Path Switching Processing

The following description explains detailed communication-path switching processing carried out in the first portable communication terminal 20A in the course of a communication with the second portable communication terminal 20B to switch a communication path used in the communication from the public communication-line network 11 to the Internet 12 or from the Internet 12 to the public communication-line network 11.

First of all, in addition to the configuration described above, the storage section 32 employed in the first portable communication terminal 20A is used for storing also communication-path information indicating that the Internet 12 is a communication path to be used in communications with the second portable communication terminal 20B. The manufacturer of the first portable communication terminal 20A stores the communication-path information in the storage section 32, for example, at a time the first portable communication terminal 20A is shipped from the factory. Thus, even if the second portable communication terminal 20B requests the use of the public communication-line network 11 as a communication path in a communication carried out between the first portable communication terminal 20A and the second portable communication terminal 20B in accordance with an incoming call received by the first portable communication terminal 20A from the second portable communication terminal 20B for example, the control section 30 employed in the first portable communication terminal 20A switches the communication path requested by the second portable communication terminal 20B as a communication path to be used in the communication between the first portable communication terminal 20A and the second portable communication terminal 20B from the public communication-line network 11 to the Internet 12 indicated by the communication-path information stored in the storage section 32.

In addition, if the user does not particularly specify a communication path to be used in a communication with the second portable communication terminal 20B by operating the input specifying section 31 when using the first portable communication terminal 20A, the control section 30 assumes that the user has specified the Internet 12 set by the manufacturer of the first portable communication terminal 20A at a time the first portable communication terminal 20A was shipped from the factory. That is to say, the control section 30 uses the Internet 12 set by the manufacturer of the first portable communication terminal 20A at a time the first portable communication terminal 20A was shipped from the factory as a default communication path. Thus, even if the second portable communication terminal 20B requests the use of the public communication-line network 11 as a communication path in a communication carried out between the first portable communication terminal 20A and the second portable communication terminal 20B in accordance with an incoming call received by the first portable communication terminal 20A from the second portable communication terminal 20B for example, the control section 30 employed in the first portable communication terminal 20A sustains the setting to switch the communication path to be used in the communication with the second portable communication terminal 20B from the public communication-line network 11 to the Internet 12 indicated by the communication-path information stored in the storage section 32 as it is.

However, the user is allowed to operate the input specifying section 31 in order to specify the public communication-line network 11 as a communication path to be used in a communication with the second portable communication terminal 20B. In this case, the control section 30 outputs communication-path specifying information indicating the public communication-line network 11 specified by the user to the storage section 32 to be stored over the Internet 12 already stored in the storage section 32 in order to update the communication-path specifying information, that is, in order to update the default communication path. Thus, even if the second portable communication terminal 20B requests the use of the Internet 12 as a communication path in a communication carried out between the first portable communication terminal 20A and the second portable communication terminal 20B in accordance with an incoming call received by the first portable communication terminal 20A from the second portable communication terminal 20B for example, the control section 30 employed in the first portable communication terminal 20A switches the communication path to be used in the communication with the second portable communication terminal 20B from the Internet 12 to the public communication-line network 11 indicated by the updated communication-path information stored in the storage section 32.

With a communication path specified by the user as a communication path to be used in a communication to be carried out between the first portable communication terminal 20A and the second portable communication terminal 20B for example in accordance with an incoming call received from the second portable communication terminal 20B as described above, when the connection of the communication between the first portable communication terminal 20A and the second portable communication terminal 20B is established as evidenced by connection permission data sent to the second portable communication terminal 20B by way of the first communication section 34 or the second communication section 37, the control section 30 notifies the communication-path determination section 38 that the connection of the communication between the first portable communication terminal 20A and the second portable communication terminal 20B has been established. Notified by the control section 30 that the connection of the communication between the first portable communication terminal 20A and the second portable communication terminal 20B has been established, the communication-path determination section 38 detects the first communication section 34 or the second communication section 37 as a communication section currently operating in the communication carried out between the first portable communication terminal 20A and the second portable communication terminal 20B on the basis of, for example, the operating states of the first communication section 34 and the second communication section 37 or the state of the connection between the first communication section 34 and the audio-signal generation section 35 as well as the state of the connection between the first communication section 34 and the voice output section 36 and the state of the connection between the second communication section 37 and the audio-signal generation section 35 as well as the state of the connection between the second communication section 37 and the voice output section 36. The operating state of the first communication section 34 includes the existence/non-existence of a transfer of data between the first communication section 34 and the audio-signal generation section 35 as well as the existence/non-existence of a transfer of data between the first communication section 34 and the voice output section 36. By the same token, the operating state of the second communication section 37 includes the existence/non-existence of a transfer of data between the second communication section 37 and the audio-signal generation section 35 as well as the existence/non-existence of a transfer of data between the second communication section 37 and the voice output section 36.

Then, in accordance with the result of the detection of the first communication section 34 or the second communication section 37 as a communication section operating in the communication carried out between the first portable communication terminal 20A and the second portable communication terminal 20B, the communication-path determination section 38 recognizes a communication path used in the communication carried out between the first portable communication terminal 20A and the second portable communication terminal 20B. To put it in detail, if the communication-path determination section 38 detects the first communication section 34 as a communication section operating in the communication carried out between the first portable communication terminal 20A and the second portable communication terminal 20B, the communication-path determination section 38 recognizes the public communication-line network 11 as a communication path used in the communication. If the communication-path determination section 38 detects the second communication section 37 as a communication section operating in the communication carried out between the first portable communication terminal 20A and the second portable communication terminal 20B, on the other hand, the communication-path determination section 38 recognizes the Internet 12 as a communication path used in the communication. Then, the communication-path determination section 38 reads out communication-path information from the storage section 32.

Subsequently, the communication-path determination section 38 compares the present communication path with the specified communication path in order to produce a result of determination as to whether or not the present communication path is the same communication path as the specified communication path. As described earlier, the present communication path is the communication path recognized as a communication path currently used in the communication carried out between the first portable communication terminal 20A and the second portable communication terminal 20B whereas the specified communication path is a communication path indicated by the communication-path information read out from the storage section 32. The communication-path determination section 38 then supplies the result of the determination to the communication-path switching section 39.

If the determination result produced by the communication-path determination section 38 shows that the communication path recognized as a communication path currently used in the communication carried out between the first portable communication terminal 20A and the second portable communication terminal 20B is the same communication path as a communication path indicated by the communication-path information read out from the storage section 32, the communication-path switching section 39 sustains the communication path currently used in the communication as it is without any switching operation. That is to say, the communication-path switching section 39 sustains the connection between the first communication section 34 and the audio-signal generation section 35 as well as the connection between the first communication section 34 and the voice output section 36 or the connection between the second communication section 37 and the audio-signal generation section 35 as well as the connection between the second communication section 37 and the voice output section 36 as a connection conforming to the communication currently carried out between the first portable communication terminal 20A and the second portable communication terminal 20B.

If the determination result produced by the communication-path determination section 38 shows that the communication path recognized as a communication path currently used in the communication carried out between the first portable communication terminal 20A and the second portable communication terminal 20B is not the same communication path as a communication path indicated by the communication-path information read out from the storage section 32, on the other hand, the communication-path switching section 39 generates a communication-path switching request and sends the request to the second portable communication terminal 20B as a request for switching of a communication path.

In accordance with a communication path specified by the user in advance, the communication-path switching section 39 may change a communication path currently used in the communication carried out between the first portable communication terminal 20A and the second portable communication terminal 20B from the public communication-line network 11 to the Internet 12 or, conversely, from the Internet 12 to the public communication-line network 11. First of all, the following description explains a case in which the communication-path switching section 39 changes the public communication-line network 11 currently used in the communication carried out between the first portable communication terminal 20A and the second portable communication terminal 20B to the Internet 12 specified by the user in advance. Then, the following description explains a case in which the communication-path switching section 39 changes the Internet 12 currently used in the communication carried out between the first portable communication terminal 20A and the second portable communication terminal 20B to the public communication-line network 11 specified by the user in advance.

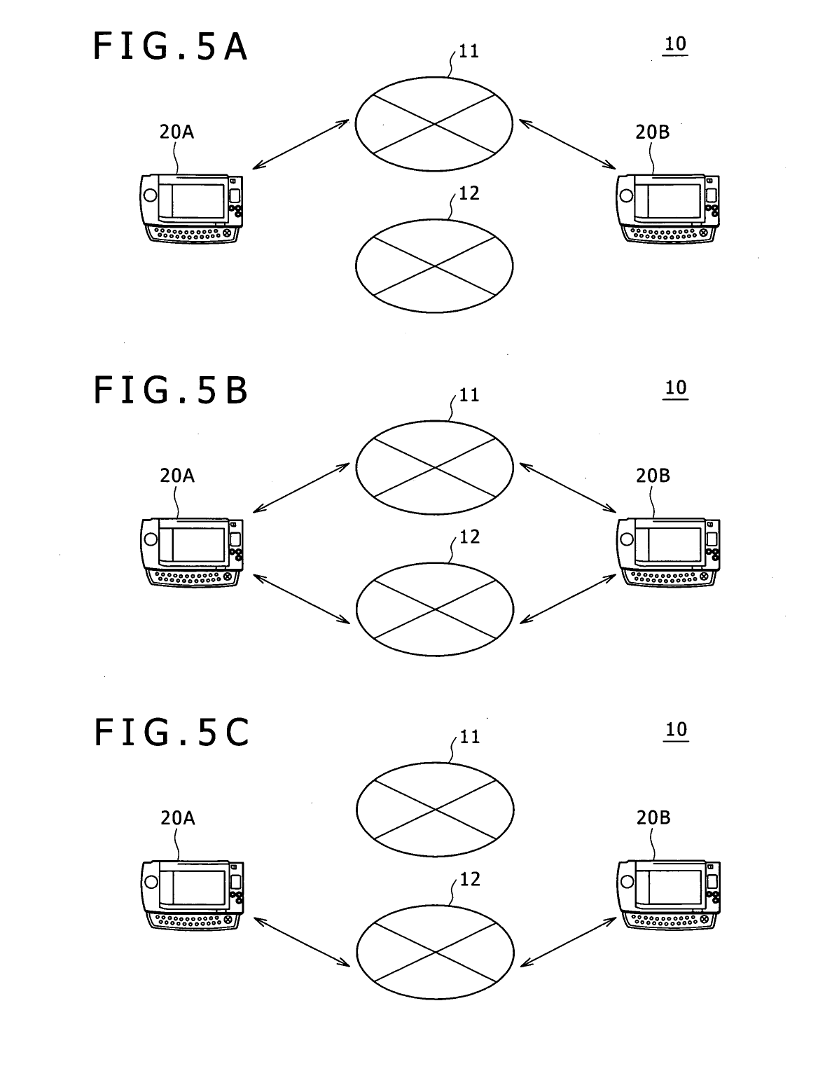

As shown in FIGS. 5A to 5C, when the communication-path switching section 39 changes the public communication-line network 11 currently used in the communication carried out between the first portable communication terminal 20A and the second portable communication terminal 20B to the Internet 12 specified by the user in advance, the communication-path switching section 39 requests the control section 30 to supply a portable phone number assigned to the second portable communication terminal 20B, which is communicating with the first portable communication terminal 20A. That is to say, the communication-path switching section 39 acquires a portable phone number indicated by communication-originator specifying information included in portable-phone call data received from the second portable communication terminal 20B when the second portable communication terminal 20B made a call for the first portable communication terminal 20A.

Then, the communication-path switching section 39 reads out the phone-number list NL shown in FIG. 4 from the storage section 32 and searches the phone-number list NL for a network phone number associated with the portable phone number acquired from the control section 30. As described above, the portable phone number acquired from the control section 30 is a portable phone number assigned to the second portable communication terminal 20B as a phone number used for communicating with the first portable communication terminal 20A through the public communication-line network 11. Thus, the network phone number associated with the portable phone number acquired from the control section 30 is a network phone number assigned to the second portable communication terminal 20B as a phone number used for communicating with the first portable communication terminal 20A through the Internet 12. Then, the communication-path switching section 39 generates a communication-path switching request in accordance with the result of the search process.

The communication-path switching request includes the network phone number obtained as a result of the process to search the phone-number list NL as communication-path switching partner specifying information showing the second portable communication terminal 20B to serve as a switching partner in the operation to switch the communication path. In addition, the communication-path switching request also includes a network phone number assigned to the first portable communication terminal 20A as communication-path switching originator specifying information showing the first portable communication terminal 20A serving as a switching originator in the operation to switch the communication path. Then, the communication-path switching section 39 outputs the communication-path switching request to the second communication section 37.

The second communication section 37 carries out processing determined in advance on the communication-path switching request received from the communication-path switching section 39 in order to generate a communication-path switching request signal and sends the signal to an access point, which eventually should pass on the signal to the second portable communication terminal 20B through the Internet 12. Then, the second communication section 37 enters a state of waiting for a connection permission signal permitting a connection of a communication making use of the Internet 12 from the second portable communication terminal 20B for a connection permission signal waiting period set in advance as a period starting from a point of time the second communication section 37 sends the communication-path switching request signal to the access point. The second portable communication terminal 20B sends such a connection permission signal to the first portable communication terminal 20A in response to the communication-path switching request signal received from the first portable communication terminal 20A.

If the first portable communication terminal 20A currently communicating with the second portable communication terminal 20B through the public communication-line network 11 is not located in the communication area of the access point for example, the communication-path switching request signal is not sent to the second portable communication terminal 20B making use of the Internet 12, then the second communication section 37 will not be capable of receiving the connection permission signal permitting a connection of a communication making use of the Internet 12 from the second portable communication terminal 20B. Thus, in this case, the second communication section 37 will not receive the connection permission signal permitting a connection of a communication making use of the Internet 12 from the second portable communication terminal 20B even after the lapse of the connection permission signal waiting period since the point of time the second communication section 37 sends the communication-path switching request signal to the access point. In addition, even if the first portable communication terminal 20A currently communicating with the second portable communication terminal 20B through the public communication-line network 11 is located in the communication area of the access point but the second portable communication terminal 20B is not located in the communication area of any access point, the second communication section 37 will not be capable of receiving the connection permission signal permitting a connection of a communication making use of the Internet 12 from the second portable communication terminal 20B. Thus, in this case, the second communication section 37 will not receive the connection permission signal permitting a connection of a communication making use of the Internet 12 from the second portable communication terminal 20B even after the lapse of the connection permission signal waiting period since the point of time the second communication section 37 sends the communication-path switching request signal to the access point for the same reason. If the second communication section 37 does not receive the connection permission signal permitting a connection of a communication making use of the Internet 12 from the second portable communication terminal 20B even after the lapse of the connection permission signal waiting period since the point of time the second communication section 37 sends the communication-path switching request signal to the access point, the second communication section 37 notifies the communication-path switching section 39 that the second communication section 37 did not receive the connection permission signal.

When the second communication section 37 notifies the communication-path switching section 39 that the second communication section 37 did not receive the connection permission signal permitting a connection of a communication making use of the Internet 12 from the second portable communication terminal 20B even after the lapse of the connection permission signal waiting period since the point of time the second communication section 37 sent the communication-path switching request signal to the access point, the communication-path switching section 39 determines that a connection of a communication between the first portable communication terminal 20A and the second portable communication terminal 20B cannot be established by making use of the Internet 12. In this case, the communication-path switching section 39 sustains the connection between the first communication section 34 and the audio-signal generation section 35 as well as the connection between the first communication section 34 and the voice output section 36. Thus, the communication-path switching section 39 continues the communication carried out between the first portable communication terminal 20A and the second portable communication terminal 20B by making use the public communication-line network 11.

If the first portable communication terminal 20A currently communicating with the second portable communication terminal 20B through the public communication-line network 11 and the second portable communication terminal 20B are located in the communication areas of different access points, on the other hand, the communication-path switching request signal can be sent to the second portable communication terminal 20B through the Internet 12 from the closest access point. In this case, the second communication section 37 receives the connection permission signal permitting a connection of a communication making use of the Internet 12 from the second portable communication terminal 20B through the closest access point prior to the lapse of the connection permission signal waiting period since the point of time the second communication section 37 sent the communication-path switching request signal. Then, the second communication section 37 carries out processing determined in advance on the connection permission signal permitting a connection of a communication making use of the Internet 12 in order to generate connection permission data and outputs the data to the communication-path switching section 39.

Receiving the connection permission data from the second communication section 37, the communication-path switching section 39 recognizes that a connection of a communication between the first portable communication terminal 20A and the second portable communication terminal 20B has been established by making use of the Internet 12. Then, the communication-path switching section 39 disconnects the first communication section 34 and the audio-signal generation section 35 from each other. At the same time, the communication-path switching section 39 sets the connection between the audio-signal generation section 35 and the second communication section 37 in place of the first communication section 34. After the connection between the first communication section 34 and the audio-signal generation section 35 is switched to the connection between the second communication section 37 and the audio-signal generation section 35, the communication-path switching section 39 supplies a communication-path switching command for changing the communication path from the public communication-line network 11 to the Internet 12 to the second communication section 37 as a command for the second communication section 37 so as to start receiving outgoing audio data, which has been output by the audio-signal generation section 35 so far to the first communication section 34, beginning from the head of the outgoing audio data.

At that time, even though the audio-signal generation section 35 and the first communication section 34 have been disconnected from each other, the first communication section 34 continues processing carried out on outgoing audio data received prior to the disconnection from the audio-signal generation section 35 and sends the result of the processing to a base station, which passes on the result to the second portable communication terminal 20B through the public communication-line network 11, as an outgoing audio signal. As the processing carried out on the outgoing audio data received prior to the disconnection from the audio-signal generation section 35 and the sending of the result of the processing to the base station as an outgoing audio signal are ended, the communication carried out by making use of the portable phone function as a communication with the second portable communication terminal 20B is all ended. When the second communication section 37 receives the communication-path switching command cited above from the communication-path switching section 39, the second communication section 37 starts the communication making use of the network phone function as a communication with the second portable communication terminal 20B. At that time, the second communication section 37 carries out processing determined in advance on the communication-path switching command in order to generate a communication-path switching command signal and sends the communication-path switching command signal to the closest access point. In addition, the second communication section 37 carries out processing determined in advance also on outgoing audio data received from the audio-signal generation section 35 after the communication-path switching command received from the communication-path switching section 39 in order to generate an outgoing audio signal and sends the outgoing audio signal to the closest access point. In this way, the second communication section 37 sends the communication-path switching command signal and the outgoing audio signal sequentially one signal after another to the second portable communication terminal 20B from the closest access point through the Internet 12, which is connected to the access point.

When the second communication section 37 sends the communication-path switching command signal to the second portable communication terminal 20B, in response to the communication-path switching command signal, the second portable communication terminal 20B should send a communication-path switching completion signal to the first portable communication terminal 20A through the Internet 12 in place of the public communication-line network 11 as a signal indicating the completion of a process carried out by the second portable communication terminal 20B to switch the communication path from the public communication-line network 11 to the Internet 12. After the communication-path switching completion signal, the second portable communication terminal 20B should send an incoming audio signal to the first portable communication terminal 20A through the Internet 12 in place of the public communication-line network 11 in response to the outgoing audio signal received from the first portable communication terminal 20A. That is to say, the first portable communication terminal 20A is in a state of waiting for the communication-path switching completion signal and the incoming audio signal after the communication-path switching completion signal. As the second communication section 37 receives the communication-path switching completion signal sent by the second portable communication terminal 20B through the Internet 12 from the closest access point, the second communication section 37 carries out processing determined in advance on the communication-path switching completion signal in order to generate communication-path switching completion data and supplies the data to the communication-path switching section 39.

The second communication section 37 supplies the communication-path switching completion data to the communication-path switching section 39 in order to notify the communication-path switching section 39 that the second portable communication terminal 20B has completed a process carried out thereby to switch the communication path, which is used by the first portable communication terminal 20A for sending outgoing audio signals to the second portable communication terminal 20B and receiving incoming audio signals from the second portable communication terminal 20B, from the public communication-line network 11 to the Internet 12.

By the way, as long as the first communication section 34 receives an incoming audio signal sent by the second portable communication terminal 20B through the public communication-line network 11 from the base station, the first communication section 34 continues processing carried out on the incoming audio signal even after the first portable communication terminal 20A has switched the path of sending of an outgoing audio signal to the second portable communication terminal 20B from the public communication-line network 11 to the Internet 12. Then, the first communication section 34 supplies the incoming audio signal received from the second portable communication terminal 20B through the base station to the voice output section 36 for outputting incoming audio data based on the incoming audio signal. As the process carried out to receive an incoming audio signal sent by the second portable communication terminal 20B through the public communication-line network 11 from the base station and the process to supply the incoming audio signal to the voice output section 36 are ended, the communication carried out by making use of the portable phone function to receive an incoming audio signal as a communication with the second portable communication terminal 20B is all ended. Then, the first communication section 34 notifies the communication-path switching section 39 that the communication carried out by making use of the portable phone function to receive an incoming audio signal as a communication with the second portable communication terminal 20B has all been ended. Notified that the communication carried out by making use of the portable phone function to receive an incoming audio signal as a communication with the second portable communication terminal 20B has all been ended, the communication-path switching section 39 terminates the process to switch the path, which is used by the first portable communication terminal 20A for sending outgoing audio signals to the second portable communication terminal 20B and receiving incoming audio signals from the second portable communication terminal 20B, from the public communication-line network 11 to the Internet 12. In addition, as the process carried out by the first communication section 34 to receive an incoming audio signal sent by the second portable communication terminal 20B through the public communication-line network 11 from the base station is completed, the communication-path switching section 39 disconnects the first communication section 34 and the voice output section 36 from each other, connecting the voice output section 36 to the second communication section 37 in place of the first communication section 34.

When the second communication section 37 receives an incoming audio signal sent by the second portable communication terminal 20B through the Internet 12 from the closest access point as an audio signal following the communication-path switching completion signal, the second communication section 37 carries out processing determined in advance on the audio signal in order to generate incoming audio data. Then, if the second communication section 37 has been connected to the voice output section 36 at the beginning of the process to generate the incoming audio data, the second communication section 37 supplies the incoming audio data to the voice output section 36. If the second communication section 37 has not been connected to the voice output section 36 at the beginning of the process to generate the incoming audio data, however, the second communication section 37, for example, holds the generated incoming audio data temporarily till a process carried out by the first communication section 34 to supply incoming audio data to the voice output section 36 is completed and the communication-path switching section 39 disconnects the first communication section 34 from the voice output section 36, connecting the voice output section 36 to the second communication section 37 in place of the first communication section 34. As the communication-path switching section 39 connects the voice output section 36 to the second communication section 37 in place of the first communication section 34, the second communication section 37 starts a process of supplying the incoming audio data held thereby temporarily to the voice output section 36.

To put it in detail, the second communication section 37 compares a connection switching point of time with a data generation start point of time. The connection switching point of time is a point of time at which the communication-path switching section 39 disconnects the first communication section 34 and the voice output section 36 from each other, connecting the voice output section 36 to the second communication section 37 in place of the first communication section 34 whereas the data generation start point of time is a point of time at which the second communication section 37 starts the generation of incoming audio data from an incoming audio signal. If the result of the comparison carried out by the second communication section 37 indicates that the connection switching point of time coincides with the data generation start point of time, the second communication section 37 immediately starts a process of supplying the incoming audio data, the generation of which has been started, to the voice output section 36. In this way, the second communication section 37 is capable of preventing a voice output by the voice output section 36 as a voice of the other user operating the second portable communication terminal 20B from being interrupted due to an operation to switch the communication path from the public communication-line network 11 to the Internet 12 in the course of a phone conversation.

If the result of the comparison carried out by the second communication section 37 indicates that the connection switching point of time leads ahead of the data generation start point of time, the second communication section 37 carries out the process to generate incoming audio data from an incoming audio signal at a processing speed higher than a normal processing speed and supplies the incoming audio data to the voice output section 36 while generating the data at the same time. In this way, the second communication section 37 is capable of effectively preventing a voice output by the voice output section 36 as a voice of the other user operating the second portable communication terminal 20B from being interrupted due to an operation to switch the communication path from the public communication-line network 11 to the Internet 12 in the course of a phone conversation.

If the result of the comparison carried out by the second communication section 37 indicates that the connection switching point of time lags behind the data generation start point of time, the second communication section 37, for example, holds the generated incoming audio data temporarily till a process carried out by the first communication section 34 to supply incoming audio data to the voice output section 36 is completed and the communication-path switching section 39 disconnects the first communication section 34 from the voice output section 36, connecting the voice output section 36 to the second communication section 37 in place of the first communication section 34. As the communication-path switching section 39 connects the voice output section 36 to the second communication section 37 in place of the first communication section 34, the second communication section 37 starts a process of supplying the incoming audio data held thereby temporarily to the voice output section 36 by increasing the amount of data supplied per time unit to a magnitude a little bit greater than the amount of data supplied per time unit in a normal state. As the second communication section 37 completes the process of supplying the incoming audio data held thereby temporarily to the voice output section 36, the second communication section 37 generates incoming audio data from the next incoming audio signal, and supplies the incoming audio data to the voice output section 36 by sustaining the amount of data supplied per time unit at a magnitude equal to the amount of data supplied per time unit in a normal state while generating the data at the same time. In this way, if the result of the comparison carried out by the second communication section 37 indicates that the connection switching point of time lags behind the data generation start point of time, the second communication section 37 temporarily keeps incoming audio data reproduced from an incoming audio signal and outputs the temporarily kept incoming audio data to the voice output section 36 by increasing the amount of data supplied per time unit to a magnitude a little bit greater than the amount of data supplied per time unit in a normal state so that the voice output section 36 generates a voice of the other user operating the second portable communication terminal 20B in a fast feed operation till the process carried out by the second communication section 37 to output the temporarily kept incoming audio data to the voice output section 36 is completed. In this way, the second communication section 37 is capable of preventing a voice output by the voice output section 36 as a voice of the other user operating the second portable communication terminal 20B from being lost due to an operation to switch the communication path from the public communication-line network 11 to the Internet 12 in the course of a phone conversation and capable of preventing a voice output by the voice output section 36 as a voice of the other user operating the second portable communication terminal 20B from being delayed by a period corresponding to the amount of incoming audio data held temporarily.

As described above, communication-path information stored in the storage section 32 may indicate that the user of the first portable communication terminal 20A has specified the Internet 12 in advance as a communication path to be used in communications with the second portable communication terminal 20B while an incoming call is received by the first portable communication terminal 20A from the second portable communication terminal 20B as a call requesting the first portable communication terminal 20A to start a communication with the second portable communication terminal 20B through the public communication-line network 11. In this case, if the first portable communication terminal 20A and the second portable communication terminal 20B are located in the communication areas of different access points, the communication path used in communications between the second portable communication terminal 20B and the first portable communication terminal 20A can be switched with ease from the public communication-line network 11 to the Internet 12 without need for each of the users to carry out any cumbersome operations.

That is to say, if the first portable communication terminal 20A can be connected by a specific user operating the first portable communication terminal 20A to the second portable communication terminal 20B through the Internet 12 for the purpose of communications with the second portable communication terminal 20B after an incoming call made by another user operating the second portable communication terminal 20B as another user to serve as a phone-conversation partner of the specific user by using the portable phone function has been received by the first portable communication terminal 20A as a call requesting the first portable communication terminal 20A to start a communication with the second portable communication terminal 20B through the public communication-line network 11, the communication path used in communications between the second portable communication terminal 20B and the first portable communication terminal 20A can be switched with ease from the public communication-line network 11 to the Internet 12 wanted by the user of the first portable communication terminal 20A serving as the communication-path switching originator without need for each of the specific and other users to carry out any cumbersome operations in conformity to the fact that the first portable communication terminal 20A has been connected to the second portable communication terminal 20B through the Internet 12 in advance by the specific user, for example, desiring to pay as much a low phone charge as possible for a communication carried out to implement a phone conversation. As a result, the communication path used in a communication between the second portable communication terminal 20B and the first portable communication terminal 20A can be switched with ease from the public communication-line network 11 to the Internet 12 in the course of the communication.

By the way, the above description explains a case in which the first portable communication terminal 20A serves as the originator of a request for a process to switch the communication path used in communications between the second portable communication terminal 20B and the first portable communication terminal 20A from the public communication-line network 11 to the Internet 12 and, thus, the second portable communication terminal 20B serves as the communication-path switching partner. The following description explains a case in which the second portable communication terminal 20B serves as the originator of a request for a process to switch the communication path used in communications between the second portable communication terminal 20B and the first portable communication terminal 20A from the public communication-line network 11 to the Internet 12 and, thus, the first portable communication terminal 20A serves as the communication-path switching partner. In this case, the second portable communication terminal 20B serving as the originator of a request for a process to switch the communication path carries out the same processing as the processing described above in the course of a communication carried out between the first portable communication terminal 20A and the second portable communication terminal 20B in accordance with a call received from the first portable communication terminal 20A. In addition, the second communication section 37 employed in the first portable communication terminal 20A serving as the communication-path switching partner receives a communication-path switching request signal sent by the second portable communication terminal 20B through the Internet 12 from the closest access point in the course of the same communication carried out between the first portable communication terminal 20A and the second portable communication terminal 20B. The second communication section 37 employed in the first portable communication terminal 20A carries out processing determined in advance on the communication-path switching request signal in order to derive a communication-path switching request from the signal and supplies the request to the communication-path switching section 39.

Receiving the communication-path switching request from the second communication section 37, the communication-path switching section 39 generates communication-path switching permission data for permitting a connection of a communication through the Internet 12 and outputs the communication-path switching permission data to the second communication section 37. The second communication section 37 carries out processing determined in advance on the communication-path switching permission data in order to generate a communication-path switching permission signal and sends the signal to the closest access point. In this way, the second communication section 37 sends the communication-path switching permission signal to the second portable communication terminal 20B from the closest access point through the Internet 12, which is connected to the access point.

Then, when the second communication section 37 receives a communication-path switching command signal sent by the second portable communication terminal 20B through the Internet 12 in response to the communication-path switching permission signal from the closest access point, the second communication section 37 carries out processing determined in advance on the communication-path switching command signal in order to derive a communication-path switching command from the signal and supplies the command to the communication-path switching section 39. The communication-path switching command received from the second communication section 37 notifies the communication-path switching section 39 of a request for a process to switch the path, which is used by the first portable communication terminal 20A for sending outgoing audio signals to the second portable communication terminal 20B and receiving incoming audio signals from the second portable communication terminal 20B, from the public communication-line network 11 to the Internet 12.

On the basis of the communication-path command received from the second communication section 37, the communication-path switching section 39 recognizes the establishment of the connection of a communication making use of the Internet 12 between the first portable communication terminal 20A and the second portable communication terminal 20B. Then, the communication-path switching section 39 disconnects the first communication section 34 and the audio-signal generation section 35 from each other, connecting the audio-signal generation section 35 to the second communication section 37 in place of the first communication section 34. After the connection between the first communication section 34 and the audio-signal generation section 35 is switched to the connection between the second communication section 37 and the audio-signal generation section 35, the communication-path switching section 39 supplies communication-path switching completion data to the second communication section 37 to notify the second communication section 37 of the completion of the communication-path switching process of changing the communication path from the public communication-line network 11 to the Internet 12 so as to start receiving outgoing audio data, which has been output by the audio-signal generation section 35 so far to the first communication section 34, beginning from the head of the outgoing audio data.

At that time, even though the audio-signal generation section 35 and the first communication section 34 have been disconnected from each other, the first communication section 34 continues processing carried out on outgoing audio data received prior to the disconnection from the audio-signal generation section 35 and sends the result of the processing to a base station, which passes on the result to the second portable communication terminal 20B through the public communication-line network 11, as an outgoing audio signal. As the processing carried out on outgoing audio data received prior to the disconnection from the audio-signal generation section 35 and the sending of the result of the processing to the base station as an outgoing audio signal are ended, the communication carried out by making use of the portable phone function as a communication with the second portable communication terminal 20B is all ended. When the second communication section 37 receives the communication-path switching completion data cited above from the communication-path switching section 39, the second communication section 37 starts the communication making use of the network phone function as a communication with the second portable communication terminal 20B. At that time, the second communication section 37 carries out processing determined in advance on the communication-path switching completion data in order to generate a communication-path switching completion signal and sends the communication-path switching completion signal to the closest access point in response to the communication-path switching command signal received from the second portable communication terminal 20B. In addition, the second communication section 37 carries out processing determined in advance also on outgoing audio data received from the audio-signal generation section 35 after the communication-path switching completion data received from the communication-path switching section 39 in order to generate an outgoing audio signal and sends the outgoing audio signal to the closest access point. In this way, the second communication section 37 sends the communication-path switching completion signal and the outgoing audio signal sequentially one signal after another to the second portable communication terminal 20B from the closest access point through the Internet 12, which is connected to the access point.

By the way, as long as the first communication section 34 receives an incoming audio signal sent by the second portable communication terminal 20B through the public communication-line network 11 from the base station, the first communication section 34 continues processing carried out on the incoming audio signal even after the first portable communication terminal 20A has switched the path of sending of an outgoing audio signal to the second portable communication terminal 20B from the public communication-line network 11 to the Internet 12. Then, the first communication section 34 supplies the incoming audio signal received from the second portable communication terminal 20B through the base station to the voice output section 36 for outputting incoming audio data based on the incoming audio signal. As the process carried out to receive an incoming audio signal sent by the second portable communication terminal 20B through the public communication-line network 11 from the base station and the process to supply the incoming audio signal to the voice output section 36 are ended, the communication carried out by making use of the portable phone function to receive an incoming audio signal as a communication with the second portable communication terminal 20B is all ended. Then, the first communication section 34 notifies the communication-path switching section 39 that the communication carried out by making use of the portable phone function to receive an incoming audio signal as a communication with the second portable communication terminal 20B has all been ended in order to request the communication-path switching section 39 to terminate the process to switch the path, which is used by the first portable communication terminal 20A for sending outgoing audio signals to the second portable communication terminal 20B and receiving incoming audio signals from the second portable communication terminal 20B, from the public communication-line network 11 to the Internet 12. In addition, as the process carried out by the first communication section 34 to receive an incoming audio signal sent by the second portable communication terminal 20B through the public communication-line network 11 from the base station is completed, the communication-path switching section 39 disconnects the first communication section 34 and the voice output section 36 from each other, connecting the voice output section 36 to the second communication section 37 in place of the first communication section 34.

When the second communication section 37 receives an incoming audio signal sent by the second portable communication terminal 20B through the Internet 12 from the closest access point as an audio signal following the communication-path switching command signal, the second communication section 37 carries out processing determined in advance on the audio signal in order to generate incoming audio data. Then, if the second communication section 37 has been connected to the voice output section 36 at the beginning of the process to generate the incoming audio data, the second communication section 37 supplies the incoming audio data to the voice output section 36. If the second communication section 37 has not been connected to the voice output section 36 at the beginning of the process to generate the incoming audio data, however, the second communication section 37, for example, holds the generated incoming audio data temporarily till a process carried out by the first communication section 34 to supply incoming audio data to the voice output section 36 is completed and the communication-path switching section 39 disconnects the first communication section 34 from the voice output section 36, connecting the voice output section 36 to the second communication section 37 in place of the first communication section 34. As the communication-path switching section 39 connects the voice output section 36 to the second communication section 37 in place of the first communication section 34, the second communication section 37 starts a process of supplying the incoming audio data held thereby temporarily to the voice output section 36.

To put it in detail, the second communication section 37 compares a connection switching point of time with a data generation start point of time. The connection switching point of time is a point of time at which the communication-path switching section 39 disconnects the first communication section 34 and the voice output section 36 from each other, connecting the voice output section 36 to the second communication section 37 in place of the first communication section 34 whereas the data generation start point of time is a point of time at which the second communication section 37 starts the generation of incoming audio data from an incoming audio signal. If the result of the comparison carried out by the second communication section 37 indicates that the connection switching point of time coincides with the data generation start point of time, the second communication section 37 immediately starts a process of supplying the incoming audio data, the generation of which has been started, to the voice output section 36. In this way, the second communication section 37 is capable of preventing a voice output by the voice output section 36 as a voice of the other user operating the second portable communication terminal 20B from being interrupted due to an operation to switch the communication path from the public communication-line network 11 to the Internet 12 in the course of a phone conversation.

If the result of the comparison carried out by the second communication section 37 indicates that the connection switching point of time leads ahead of the data generation start point of time, the second communication section 37 carries out the process to generate incoming audio data from an incoming audio signal at a processing speed higher than a normal processing speed and supplies the incoming audio data to the voice output section 36 while generating the data at the same time. In this way, the second communication section 37 is capable of effectively preventing a voice output by the voice output section 36 as a voice of the other user operating the second portable communication terminal 20B from being interrupted due to an operation to switch the communication path from the public communication-line network 11 to the Internet 12 in the course of a phone conversation.

If the result of the comparison carried out by the second communication section 37 indicates that the connection switching point of time lags behind the data generation start point of time, the second communication section 37, for example, holds the generated incoming audio data temporarily till a process carried out by the first communication section 34 to supply incoming audio data to the voice output section 36 is completed and the communication-path switching section 39 disconnects the first communication section 34 from the voice output section 36, connecting the voice output section 36 to the second communication section 37 in place of the first communication section 34. As the communication-path switching section 39 connects the voice output section 36 to the second communication section 37 in place of the first communication section 34, the second communication section 37 starts a process of supplying the incoming audio data held thereby temporarily to the voice output section 36 by increasing the amount of data supplied per time unit to a magnitude a little bit greater than the amount of data supplied per time unit in a normal state. As the second communication section 37 completes the process of supplying the incoming audio data held thereby temporarily to the voice output section 36, the second communication section 37 generates incoming audio data from the next incoming audio signal, and supplies the incoming audio data to the voice output section 36 by sustaining the amount of data supplied per time unit at a magnitude equal to the amount of data supplied per time unit in a normal state while generating the data at the same time. In this way, if the result of the comparison carried out by the second communication section 37 indicates that the connection switching point of time lags behind the data generation start point of time, the second communication section 37 temporarily keeps incoming audio data reproduced from an incoming audio signal and outputs the temporarily kept incoming audio data to the voice output section 36 by increasing the amount of data supplied per time unit to a magnitude a little bit greater than the amount of data supplied per time unit in a normal state so that the voice output section 36 generates a voice of the other user operating the second portable communication terminal 20B in a fast feed operation till the process carried out by the second communication section 37 to output the temporarily kept incoming audio data to the voice output section 36 is completed. In this way, the second communication section 37 is capable of preventing a voice output by the voice output section 36 as a voice of the other user operating the second portable communication terminal 20B from being lost due to an operation to switch the communication path from the public communication-line network 11 to the Internet 12 in the course of a phone conversation and capable of preventing a voice output by the voice output section 36 as a voice of the other user operating the second portable communication terminal 20B from being delayed by a period corresponding to the amount of incoming audio data held temporarily.

As described above, when the first portable communication terminal 20A starts a communication with the second portable communication terminal 20B as a communication through the public communication-line network 11 in accordance with a call sent by the first portable communication terminal 20A to the second portable communication terminal 20B, the first portable communication terminal 20A receives a communication-path switching request signal sent by the second portable communication terminal 20B through the Internet 12. In this case, in accordance with what has been specified by the other user operating the second portable communication terminal 20B in the communication-path switching request signal, the communication path used in communications between the second portable communication terminal 20B and the first portable communication terminal 20A can be switched with ease from the public communication-line network 11 to the Internet 12 without need for each of the users to carry out any cumbersome operations.

To put it in detail, after the first user of the first portable communication terminal 20A starts a communication with the second user of the second portable communication terminal 20B as a communication through the public communication-line network 11 by making an outgoing portable phone call to the second user, the first portable communication terminal 20A receives a communication-path switching request signal sent by the second portable communication terminal 20B through the Internet 12. In this case, due to the fact that the Internet 12 has been specified in advance as a communication path by the second user, for example, desiring to pay as much a low phone charge as possible for a communication carried out to implement a phone conversation, the communication path used in communications between the second portable communication terminal 20B and the first portable communication terminal 20A can be switched with ease from the public communication-line network 11 to the Internet 12 wanted by the user of the second portable communication terminal 20B serving as the communication-path switching originator without need for each of the first and second users to carry out any cumbersome operations. As a result, the path of a communication can be changed easily in the course of the communication.

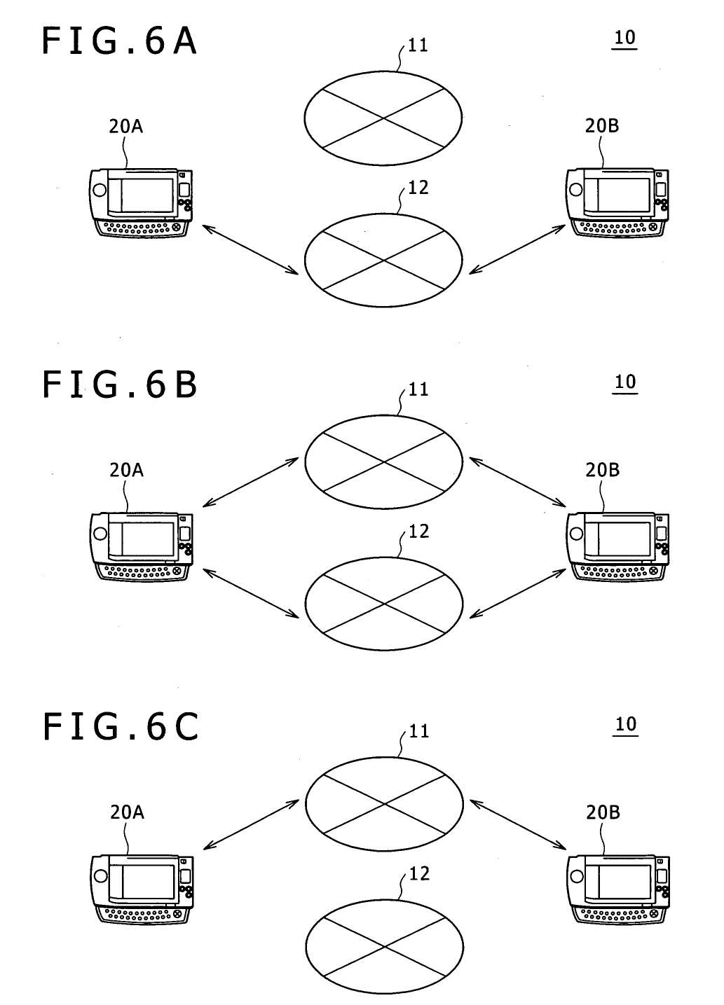

As shown in FIGS. 6A to 6C, when the communication-path switching section 39 changes the Internet 12 currently used in the communication carried out between the first portable communication terminal 20A and the second portable communication terminal 20B to the public communication-line network 11 specified by the user in advance, the communication-path switching section 39 requests the control section 30 to supply a network phone number assigned to the second portable communication terminal 20B communicating with the first portable communication terminal 20A. That is to say, the communication-path switching section 39 acquires a network phone number indicated by communication-originator specifying information included in network-phone call data received from the second portable communication terminal 20B when the second portable communication terminal 20B made a call for the first portable communication terminal 20A.

Then, the communication-path switching section 39 reads out the phone-number list NL shown in FIG. 4 from the storage section 32 and searches the phone-number list NL for a portable phone number associated with the network phone number acquired from the control section 30. As described above, the network phone number acquired from the control section 30 is a network phone number assigned to the second portable communication terminal 20B as a phone number used for communicating with the first portable communication terminal 20A through the Internet 12. Thus, the portable phone number associated with the network phone number acquired from the control section 30 is a portable phone number assigned to the second portable communication terminal 20B as a phone number used for communicating with the first portable communication terminal 20A through the public communication-line network 11. Then, the communication-path switching section 39 generates a communication-path switching request in accordance with the result of the search process.

The communication-path switching request includes the portable phone number obtained as a result of the process to search the phone-number list NL as communication-path switching partner specifying information showing the second portable communication terminal 20B to serve as a switching partner in the operation to switch the communication path. In addition, the communication-path switching request also includes a portable phone number assigned to the first portable communication terminal 20A as communication-path switching originator specifying information showing the first portable communication terminal 20A serving as a switching originator in the operation to switch the communication path. Then, the communication-path switching section 39 outputs the communication-path switching request to the first communication section 34.

The first communication section 34 carries out processing determined in advance on the communication-path switching request received from the communication-path switching section 39 in order to generate a communication-path switching request signal and sends the signal to a base station. Then, the first communication section 34 enters a state of waiting for a connection permission signal permitting a connection of a communication making use of the public communication-line network 11 from the second portable communication terminal 20B for a connection permission signal waiting period set in advance as a period starting from a point of time the first communication section 34 sends the communication-path switching request signal to the base station. The second portable communication terminal 20B sends such a connection permission signal to the first portable communication terminal 20A in response to the communication-path switching request signal received from the first portable communication terminal 20A.

If the first portable communication terminal 20A currently communicating with the second portable communication terminal 20B through the Internet 12 is not located in the communication area of the base station for example, since the communication-path switching request signal is not sent to the second portable communication terminal 20B making use of the public communication-line 11, the first communication section 34 will not be capable of receiving the connection permission signal permitting a connection of a communication making use of the public communication-line network 11 from the second portable communication terminal 20B. Thus, in this case, the first communication section 34 will not receive the connection permission signal permitting a connection of a communication making use of the public communication-line network 11 from the second portable communication terminal 20B even after the lapse of the connection permission signal waiting period since the point of time the first communication section 34 sends the communication-path switching request signal to the base station. In addition, even if the first portable communication terminal 20A currently communicating with the second portable communication terminal 20B through the Internet 12 is located in the communication area of the base station but the second portable communication terminal 20B is not located in the communication area of any base station, the first communication section 34 will not be capable of receiving the connection permission signal permitting a connection of a communication making use of the public communication-line network 11 from the second portable communication terminal 20B. Thus, in this case, the first communication section 34 will not receive the connection permission signal permitting a connection of a communication making use of the public communication-line network 11 from the second portable communication terminal 20B even after the lapse of the connection permission signal waiting period since the point of time the first communication section 34 sends the communication-path switching request signal to the base station for the same reason. If the first communication section 34 does not receive the connection permission signal permitting a connection of a communication making use of the public communication-line network 11 from the second portable communication terminal 20B even after the lapse of the connection permission signal waiting period since the point of time the first communication section 34 sends the communication-path switching request signal to the base station, the first communication section 34 notifies the communication-path switching section 39 that the first communication section 34 did not receive the connection permission signal.

When the first communication section 34 notifies the communication-path switching section 39 that the first communication section 34 did not receive the connection permission signal permitting a connection of a communication making use of the public communication-line network 11 from the second portable communication terminal 20B even after the lapse of the connection permission signal waiting period since the point of time the first communication section 34 sent the communication-path switching request signal to the base station, the communication-path switching section 39 determines that a connection of a communication between the first portable communication terminal 20A and the second portable communication terminal 20B cannot be established by making use of the public communication-line network 11. In this case, the communication-path switching section 39 sustains the connection between the second communication section 37 and the audio-signal generation section 35 as well as the connection between the second communication section 37 and the voice output section 36. Thus, the communication-path switching section 39 continues the communication carried out between the first portable communication terminal 20A and the second portable communication terminal 20B by making use of the Internet 12.

If the first portable communication terminal 20A currently communicating with the second portable communication terminal 20B through the Internet 12 and the second portable communication terminal 20B are located in the communication areas of different base stations, on the other hand, the communication-path switching request signal can be sent to the second portable communication terminal 20B through the public communication-line network 11 from the closest base station. In this case, the first communication section 34 receives the connection permission signal permitting a connection of a communication making use of the public communication-line network 11 from the second portable communication terminal 20B through the closest base station prior to the lapse of the connection permission signal waiting period since the point of time the first communication section 34 sent the communication-path switching request signal. Then, the first communication section 34 carries out processing determined in advance on the connection permission signal permitting a connection of a communication making use of the public communication-line network 11 in order to generate connection permission data and outputs the data to the communication-path switching section 39.

Receiving the connection permission data from the first communication section 34, the communication-path switching section 39 recognizes that a connection of a communication between the first portable communication terminal 20A and the second portable communication terminal 20B has been established by making use of the public communication-line network 11. Then, the communication-path switching section 39 disconnects the second communication section 37 and the audio-signal generation section 35 from each other. At the same time, the communication-path switching section 39 sets the connection between the first communication section 34 and the audio-signal generation section 35. After the connection between the second communication section 37 and the audio-signal generation section 35 is switched to the connection between the first communication section 34 and the audio-signal generation section 35, the communication-path switching section 39 supplies a communication-path switching command for changing of the communication path from the Internet 12 to the public communication-line network 11 to the first communication section 34 as a command for the first communication section 34 so as to start receiving outgoing audio data, which has been output by the audio-signal generation section 35 so far to the second communication section 37, beginning from the head of the outgoing audio data.

At that time, even though the audio-signal generation section 35 and the second communication section 37 have been disconnected from each other, the second communication section 37 continues processing carried out on outgoing audio data received prior to the disconnection from the audio-signal generation section 35 and sends the result of the processing to an access point, which passes on the result to the second portable communication terminal 20B through the Internet 12, as an outgoing audio signal. As the processing carried out on outgoing audio data received prior to the disconnection from the audio-signal generation section 35 and the sending of the result of the processing to the access point as an outgoing audio signal are ended, the communication carried out by making use of the network phone function as a communication with the second portable communication terminal 20B is all ended. When the first communication section 34 receives the communication-path switching command cited above from the communication-path switching section 39, the first communication section 34 starts the communication making use of the portable phone function as a communication with the second portable communication terminal 20B. At that time, the first communication section 34 carries out processing determined in advance on the communication-path switching command in order to generate a communication-path switching command signal and sends the communication-path switching command signal to the closest base station. In addition, the first communication section 34 carries out processing determined in advance also on outgoing audio data received from the audio-signal generation section 35 after the communication-path switching command received from the communication-path switching section 39 in order to generate an outgoing audio signal and sends the outgoing audio signal to the closest base station. In this way, the first communication section 34 sends the communication-path switching command signal and the outgoing audio signal sequentially one signal after another to the second portable communication terminal 20B from the closest base station through the public communication-line network 11, which is connected to the base station.

When the first communication section 34 sends the communication-path switching command signal to the second portable communication terminal 20B, in response to the communication-path switching command signal, the second portable communication terminal 20B should send a communication-path switching completion signal to the first portable communication terminal 20A through the public communication-line network 11 in place of the Internet 12 as a signal indicating the completion of a process carried out by the second portable communication terminal 20B to switch the communication path from the Internet 12 to the public communication-line network 11. After the communication-path switching completion signal, the second portable communication terminal 20B should send an incoming audio signal to the first portable communication terminal 20A through the public communication-line network 11 in place of the Internet 12 in response to the outgoing audio signal received from the first portable communication terminal 20A. That is to say, the first portable communication terminal 20A is in a state of waiting for the communication-path switching completion signal and the incoming audio signal after the communication-path switching completion signal. As the first communication section 34 receives the communication-path switching completion signal sent by the second portable communication terminal 20B through the public communication-line network 11 from the closest base station, the first communication section 34 carries out processing determined in advance on the communication-path switching completion signal in order to generate communication-path switching completion data and supplies the data to the communication-path switching section 39.

The first communication section 34 supplies the communication-path switching completion data to the communication-path switching section 39 in order to notify the communication-path switching section 39 that the second portable communication terminal 20B has completed a process carried out thereby to switch the communication path, which is used by the first portable communication terminal 20A for sending outgoing audio signals to the second portable communication terminal 20B and receiving incoming audio signals from the second portable communication terminal 20B, from the Internet 12 to the public communication-line network 11.

By the way, as long as the second communication section 37 receives an incoming audio signal sent by the second portable communication terminal 20B through the Internet 12 from the access point, the second communication section 37 continues processing carried out on the incoming audio signal even after the first portable communication terminal 20A has switched the path of sending of an outgoing audio signal to the second portable communication terminal 20B from the Internet 12 to the public communication-line network 11. Then, the second communication section 37 supplies the incoming audio signal received from the second portable communication terminal 20B through the access point to the voice output section 36 for outputting incoming audio data based on the incoming audio signal. As the process carried out to receive an incoming audio signal sent by the second portable communication terminal 20B through the Internet 12 from the access point and the process to supply the incoming audio signal to the voice output section 36 are ended, the communication carried out by making use of the network phone function to receive an incoming audio signal as a communication with the second portable communication terminal 20B is all ended. Then, the second communication section 37 notifies the communication-path switching section 39 that the communication carried out by making use of the network phone function to receive an incoming audio signal as a communication with the second portable communication terminal 20B has all been ended. Notified that the communication carried out by making use of the network phone function to receive an incoming audio signal as a communication with the second portable communication terminal 20B has all been ended, the communication-path switching section 39 terminates the process to switch the path, which is used by the first portable communication terminal 20A for sending outgoing audio signals to the second portable communication terminal 20B and receiving incoming audio signals from the second portable communication terminal 20B, from the Internet 12 to the public communication-line network 11. In addition, as the process carried out by the second communication section 37 to receive an incoming audio signal sent by the second portable communication terminal 20B through the Internet 12 from the access point is completed, the communication-path switching section 39 disconnects the second communication section 37 and the voice output section 36 from each other, connecting the voice output section 36 to the first communication section 34 in place of the second communication section 37.

When the first communication section 34 receives an incoming audio signal sent by the second portable communication terminal 20B through the public communication-line network 11 from the closest base station as an audio signal following the communication-path switching completion signal, the first communication section 34 carries out processing determined in advance on the audio signal in order to generate incoming audio data. Then, if the first communication section 34 has been connected to the voice output section 36 at the beginning of the process to generate the incoming audio data, the first communication section 34 supplies the incoming audio data to the voice output section 36. If the first communication section 34 has not been connected to the voice output section 36 at the beginning of the process to generate the incoming audio data, however, the first communication section 34, for example, holds the generated incoming audio data temporarily till a process carried out by the second communication section 37 to supply incoming audio data to the voice output section 36 is completed and the communication-path switching section 39 disconnects the second communication section 37 from the voice output section 36, connecting the voice output section 36 to the first communication section 34 in place of the second communication section 37. As the communication-path switching section 39 connects the voice output section 36 to the first communication section 34 in place of the second communication section 37, the first communication section 34 starts a process of supplying the incoming audio data held thereby temporarily to the voice output section 36.

To put it in detail, the first communication section 34 compares a connection switching point of time with a data generation start point of time. The connection switching point of time is a point of time at which the communication-path switching section 39 disconnects the second communication section 37 and the voice output section 36 from each other, connecting the voice output section 36 to the first communication section 34 in place of the second communication section 37 whereas the data generation start point of time is a point of time at which the first communication section 34 starts the generation of incoming audio data from an incoming audio signal. If the result of the comparison carried out by the first communication section 34 indicates that the connection switching point of time coincides with the data generation start point of time, the first communication section 34 immediately starts a process of supplying the incoming audio data, the generation of which has been started, to the voice output section 36. In this way, the first communication section 34 is capable of preventing a voice output by the voice output section 36 as a voice of the other user operating the second portable communication terminal 20B from being interrupted due to an operation to switch the communication path from the Internet 12 to the public communication-line network 11 in the course of a phone conversation.

If the result of the comparison carried out by the first communication section 34 indicates that the connection switching point of time leads ahead of the data generation start point of time, the first communication section 34 carries out the process to generate incoming audio data from an incoming audio signal at a processing speed higher than a normal processing speed and supplies the incoming audio data to the voice output section 36 while generating the data at the same time. In this way, the first communication section 34 is capable of effectively preventing a voice output by the voice output section 36 as a voice of the other user operating the second portable communication terminal 20B from being interrupted due to an operation to switch the communication path from the Internet 12 to the public communication-line network 11 in the course of a phone conversation.

If the result of the comparison carried out by the first communication section 34 indicates that the connection switching point of time lags behind the data generation start point of time, the first communication section 34, for example, holds the generated incoming audio data temporarily till a process carried out by the second communication section 37 to supply incoming audio data to the voice output section 36 is completed and the communication-path switching section 39 disconnects the voice output section 36 from the second communication section 37, connecting the voice output section 36 to the first communication section 34 in place of the second communication section 37. As the communication-path switching section 39 connects the voice output section 36 to the first communication section 34 in place of the second communication section 37, the first communication section 34 starts a process of supplying the incoming audio data held thereby temporarily to the voice output section 36 by increasing the amount of data supplied per time unit to a magnitude a little bit greater than the amount of data supplied per time unit in a normal state. As the first communication section 34 completes the process of supplying the incoming audio data held thereby temporarily to the voice output section 36, the first communication section 34 generates incoming audio data from the next incoming audio signal, and supplies the incoming audio data to the voice output section 36 by sustaining the amount of data supplied per time unit at a magnitude equal to the amount of data supplied per time unit in a normal state while generating the data at the same time. In this way, if the result of the comparison carried out by the first communication section 34 indicates that the connection switching point of time lags behind the data generation start point of time, the first communication section 34 temporarily keeps incoming audio data reproduced from an incoming audio signal and outputs the temporarily kept incoming audio data to the voice output section 36 by increasing the amount of data supplied per time unit to a magnitude a little bit greater than the amount of data supplied per time unit in a normal state so that the voice output section 36 generates a voice of the other user operating the second portable communication terminal 20B in a fast feed operation till the process carried out by the first communication section 34 to output the temporarily kept incoming audio data to the voice output section 36 is completed. In this way, the first communication section 34 is capable of preventing a voice output by the voice output section 36 as a voice of the other user operating the second portable communication terminal 20B from being lost due to an operation to switch the communication path from the Internet 12 to the public communication-line network 11 in the course of a phone conversation and capable of preventing a voice output by the voice output section 36 as a voice of the other user operating the second portable communication terminal 20B from being delayed by a period corresponding to the amount of incoming audio data held temporarily.

As described above, communication-path information stored in the storage section 32 may indicate that the user of the first portable communication terminal 20A has specified the public communication-line network 11 in advance as a communication path to be used in communications with the second portable communication terminal 20B while an incoming call is received by the first portable communication terminal 20A from the second portable communication terminal 20B as a call requesting the first portable communication terminal 20A to start a communication with the second portable communication terminal 20B through the Internet 12. In this case, if the first portable communication terminal 20A and the second portable communication terminal 20B are located in the communication areas of different base stations, the communication path used in communications between the second portable communication terminal 20B and the first portable communication terminal 20A can be switched with ease from the Internet 12 to the public communication-line network 11 without need for each of the users to carry out any cumbersome operations.

That is to say, if the first portable communication terminal 20A can be connected by a specific user operating the first portable communication terminal 20A to the second portable communication terminal 20B through the public communication-line network 11 for the purpose of communications with the second portable communication terminal 20B after an incoming call made by another user operating the second portable communication terminal 20B as another user to serve as a phone-conversation partner of the specific user by using the network phone function has been received by the first portable communication terminal 20A as a call requesting the first portable communication terminal 20A to start a communication with the second portable communication terminal 20B through the Internet 12, the communication path used in communications between the second portable communication terminal 20B and the first portable communication terminal 20A can be switched with ease from the Internet 12 to the public communication-line network 11 wanted by the user of the first portable communication terminal 20A serving as the communication-path switching originator without need for each of the specific and other users to carry out any cumbersome operations in conformity to the fact that the first portable communication terminal 20A has been connected to the second portable communication terminal 20B through the public communication-line network 11 in advance by the specific user because, for example, the public communication-line network 11 is capable of preventing a phone conversation, which is carried out while the specific user is moving in most cases, from being interrupted. As a result, the communication path used in a communication between the second portable communication terminal 20B and the first portable communication terminal 20A can be switched with ease from the Internet 12 to the public communication-line network 11 in the course of the communication.

By the way, the above description explains a case in which the first portable communication terminal 20A serves as the originator of a request for a process to switch the communication path used in communications between the second portable communication terminal 20B and the first portable communication terminal 20A from the Internet 12 to the public communication-line network 11 and, thus, the second portable communication terminal 20B serves as the communication-path switching partner. The following description explains a case in which the second portable communication terminal 20B serves as the originator of a request for a process to switch the communication path used in communications between the second portable communication terminal 20B and the first portable communication terminal 20A from the Internet 12 to the public communication-line network 11 and, thus, the first portable communication terminal 20A serves as the communication-path switching partner. In this case, the second portable communication terminal 20B serving as the originator of a request for a process to switch the communication path carries out the same processing as the processing described above in the course of a communication carried out between the first portable communication terminal 20A and the second portable communication terminal 20B in accordance with a call received from the first portable communication terminal 20A. In addition, the first communication section 34 employed in the first portable communication terminal 20A serving as the communication-path switching partner receives a communication-path switching request signal sent by the second portable communication terminal 20B through the public communication-line network 11 from the closest base station in the course of the same communication carried out between the first portable communication terminal 20A and the second portable communication terminal 20B. The first communication section 34 employed in the first portable communication terminal 20A carries out processing determined in advance on the communication-path switching request signal in order to derive a communication-path switching request from the signal and supplies the request to the communication-path switching section 39.

Receiving the communication-path switching request from the first communication section 34, the communication-path switching section 39 generates communication-path switching permission data for permitting a connection of a communication through the public communication-line network 11 and outputs the communication-path switching permission data to the first communication section 34. The first communication section 34 carries out processing determined in advance on the communication-path switching permission data in order to generate a communication-path switching permission signal and sends the signal to the closest base station. In this way, the first communication section 34 sends the communication-path switching permission signal to the second portable communication terminal 20B from the closest base station through the public communication-line network 11, which is connected to the base station.

Then, when the first communication section 34 receives a communication-path switching command signal sent by the second portable communication terminal 20B through the public communication-line network 11 in response to the communication-path switching permission signal from the closest base station, the first communication section 34 carries out processing determined in advance on the communication-path switching command signal in order to derive a communication-path switching command from the signal and supplies the command to the communication-path switching section 39. The communication-path switching command received from the first communication section 34 notifies the communication-path switching section 39 of a request for a process to switch the path, which is used by the first portable communication terminal 20A for sending outgoing audio signals to the second portable communication terminal 20B and receiving incoming audio signals from the second portable communication terminal 20B, from the Internet 12 to the public communication-line network 11.

On the basis of the communication-path switching command received from the first communication section 34, the communication-path switching section 39 recognizes the establishment of the connection of a communication making use of the public communication-line network 11 between the first portable communication terminal 20A and the second portable communication terminal 20B. Then, the communication-path switching section 39 disconnects the second communication section 37 and the audio-signal generation section 35 from each other, connecting the audio-signal generation section 35 to the first communication section 34 in place of the second communication section 37. After the connection between the second communication section 37 and the audio-signal generation section 35 is switched to the connection between the first communication section 34 and the audio-signal generation section 35, the communication-path switching section 39 supplies communication-path switching completion data to the first communication section 34 to notify the first communication section 34 of the completion of the communication-path switching process of changing the communication path from the Internet 12 to the public communication-line network 11 so as to start receiving outgoing audio data, which has been output by the audio-signal generation section 35 so far to the second communication section 37, beginning from the head of the outgoing audio data.

At that time, even though the audio-signal generation section 35 and the second communication section 37 have been disconnected from each other, the second communication section 37 continues processing carried out on outgoing audio data received prior to the disconnection from the audio-signal generation section 35 and sends the result of the processing to an access point, which passes on the result of the processing to the second portable communication terminal 20B through the Internet 12, as an outgoing audio signal. As the processing carried out on outgoing audio data received prior to the disconnection from the audio-signal generation section 35 and the sending of the result of the processing to the access point as an outgoing audio signal are ended, the communication carried out by making use of the network phone function as a communication with the second portable communication terminal 20B is all ended. When the first communication section 34 receives the communication-path switching completion data cited above from the communication-path switching section 39, the first communication section 34 starts the communication making use of the portable phone function as a communication with the second portable communication terminal 20B. At that time, the first communication section 34 carries out processing determined in advance on the communication-path switching completion data in order to generate a communication-path switching completion signal and sends the communication-path switching completion signal to the closest base station in response to the communication-path switching command signal received from the second portable communication terminal 20B. In addition, the first communication section 34 carries out processing determined in advance also on outgoing audio data received from the audio-signal generation section 35 after the communication-path switching completion data received from the communication-path switching section 39 in order to generate an outgoing audio signal and sends the outgoing audio signal to the closest base station. In this way, the first communication section 34 sends the communication-path switching completion signal and the outgoing audio signal sequentially one signal after another to the second portable communication terminal 20B from the closest base station through the public communication-line network 11, which is connected to the base station.

By the way, as long as the second communication section 37 receives an incoming audio signal sent by the second portable communication terminal 20B through the Internet 12 from the access point, the second communication section 37 continues processing carried out on the incoming audio signal even after the first portable communication terminal 20A has switched the path of sending of an outgoing audio signal to the second portable communication terminal 20B from the Internet 12 to the public communication-line network 11. Then, the second communication section 37 supplies the incoming audio signal received from the second portable communication terminal 20B through the access point to the voice output section 36 for outputting incoming audio data based on the incoming audio signal. As the process carried out to receive an incoming audio signal sent by the second portable communication terminal 20B through the Internet 12 from the access point and the process to supply the incoming audio signal to the voice output section 36 are ended, the communication carried out by making use of the network phone function to receive an incoming audio signal as a communication with the second portable communication terminal 20B is all ended. Then, the second communication section 37 notifies the communication-path switching section 39 that the communication carried out by making use of the network phone function to receive an incoming audio signal as a communication with the second portable communication terminal 20B has all been ended in order to request the communication-path switching section 39 to terminate the process to switch the path, which is used by the first portable communication terminal 20A for sending outgoing audio signals to the second portable communication terminal 20B and receiving incoming audio signals from the second portable communication terminal 20B, from the Internet 12 to the public communication-line network 11. In addition, as the process carried out by the second communication section 37 to receive an incoming audio signal sent by the second portable communication terminal 20B through the Internet 12 from the access point is completed, the communication-path switching section 39 disconnects the second communication section 37 and the voice output section 36 from each other, connecting the voice output section 36 to the first communication section 34 in place of the second communication section 37.

When the first communication section 34 receives an incoming audio signal sent by the second portable communication terminal 20B through the public communication-line network 11 from the closest base station as an audio signal following the communication-path switching command signal, the first communication section 34 carries out processing determined in advance on the incoming audio signal in order to generate incoming audio data. Then, if the first communication section 34 has been connected to the voice output section 36 at the beginning of the process to generate the incoming audio data, the first communication section 34 supplies the incoming audio data to the voice output section 36. If the first communication section 34 has not been connected to the voice output section 36 at the beginning of the process to generate the incoming audio data, however, the first communication section 34, for example, holds the generated incoming audio data temporarily till a process carried out by the second communication section 37 to supply incoming audio data to the voice output section 36 is completed and the communication-path switching section 39 disconnects the second communication section 37 from the voice output section 36, connecting the voice output section 36 to the first communication section 34 in place of the second communication section 37. As the communication-path switching section 39 connects the voice output section 36 to the first communication section 34 in place of the second communication section 37, the first communication section 34 starts a process of supplying the incoming audio data held thereby temporarily to the voice output section 36.

To put it in detail, the first communication section 34 compares a connection switching point of time with a data generation start point of time. The connection switching point of time is a point of time at which the communication-path switching section 39 disconnects the second communication section 37 and the voice output section 36 from each other, connecting the voice output section 36 to the first communication section 34 in place of the second communication section 37 whereas the data generation start point of time is a point of time at which the first communication section 34 starts the generation of incoming audio data from an incoming audio signal. If the result of the comparison carried out by the first communication section 34 indicates that the connection switching point of time coincides with the data generation start point of time, the first communication section 34 immediately starts a process of supplying the incoming audio data, the generation of which has been started, to the voice output section 36. In this way, the first communication section 34 is capable of preventing a voice output by the voice output section 36 as a voice of the other user operating the second portable communication terminal 20B from being interrupted due to an operation to switch the communication path from the Internet 12 to the public communication-line network 11 in the course of a phone conversation.

If the result of the comparison carried out by the first communication section 34 indicates that the connection switching point of time leads ahead of the data generation start point of time, the first communication section 34 carries out the process to generate incoming audio data from an incoming audio signal at a processing speed higher than a normal processing speed and supplies the incoming audio data to the voice output section 36 while generating the data at the same time. In this way, the first communication section 34 is capable of effectively preventing a voice output by the voice output section 36 as a voice of the other user operating the second portable communication terminal 20B from being interrupted due to an operation to switch the communication path from the Internet 12 to the public communication-line network 11 in the course of a phone conversation.

If the result of the comparison carried out by the first communication section 34 indicates that the connection switching point of time lags behind the data generation start point of time, the first communication section 34, for example, holds the generated incoming audio data temporarily till a process carried out by the second communication section 37 to supply incoming audio data to the voice output section 36 is completed and the communication-path switching section 39 disconnects the second communication section 37 from the voice output section 36, connecting the voice output section 36 to the first communication section 34 in place of the second communication section 37. As the communication-path switching section 39 connects the voice output section 36 to the first communication section 34 in place of the second communication section 37, the first communication section 34 starts a process of supplying the incoming audio data held thereby temporarily to the voice output section 36 by increasing the amount of data supplied per time unit to a magnitude a little bit greater than the amount of data supplied per time unit in a normal state. As the first communication section 34 completes the process of supplying the incoming audio data held thereby temporarily to the voice output section 36, the first communication section 34 generates incoming audio data from the next incoming audio signal, and supplies the incoming audio data to the voice output section 36 by sustaining the amount of data supplied per time unit at a magnitude equal to the amount of data supplied per time unit in a normal state while generating the data at the same time. In this way, if the result of the comparison carried out by the first communication section 34 indicates that the connection switching point of time lags behind the data generation start point of time, the first communication section 34 temporarily keeps incoming audio data reproduced from an incoming audio signal and outputs the temporarily kept incoming audio data to the voice output section 36 by increasing the amount of data supplied per time unit to a magnitude a little bit greater than the amount of data supplied per time unit in a normal state so that the voice output section 36 generates a voice of the other user operating the second portable communication terminal 20B in a fast feed operation till the process carried out by the first communication section 34 to output the temporarily kept incoming audio data to the voice output section 36 is completed. In this way, the first communication section 34 is capable of preventing a voice output by the voice output section 36 as a voice of the other user operating the second portable communication terminal 20B from being lost due to an operation to switch the communication path from the Internet 12 to the public communication-line network 11 in the course of a phone conversation and capable of preventing a voice output by the voice output section 36 as a voice of the other user operating the second portable communication terminal 20B from being delayed by a period corresponding to the amount of incoming audio data held temporarily.

As described above, when the first portable communication terminal 20A starts a communication with the second portable communication terminal 20B as a communication through the Internet 12 in accordance with a call sent by the first portable communication terminal 20A to the second portable communication terminal 20B, the first portable communication terminal 20A receives a communication-path switching request signal sent by the second portable communication terminal 20B through the public communication-line network 11. In this case, in accordance with what has been specified by the other user operating the second portable communication terminal 20B in the communication-path switching request signal, the communication path used in communications between the second portable communication terminal 20B and the first portable communication terminal 20A can be switched with ease from the Internet 12 to the public communication-line network 11 without need for each the users to carry out any cumbersome operations.

To put it in detail, after a first user operating the first portable communication terminal 20A starts a communication with a second user operating the second portable communication terminal 20B as a communication through the Internet 12 by making an outgoing network phone call to the second user, the first portable communication terminal 20A receives a communication-path switching request signal sent by the second portable communication terminal 20B through the public communication-line network 11. In this case, due to the fact that the public communication-line network 11 has been specified in advance as a communication path by the second user because, for example, the public communication-line network 11 is capable of preventing a phone conversation, which is carried out while the second user is moving in most cases, the communication path used in communications between the second portable communication terminal 20B and the first portable communication terminal 20A can be switched with ease from the Internet 12 to the public communication-line network 11 wanted by the user of the second portable communication terminal 20B serving as the communication-path switching originator without need for each of the first and second users to carry out any cumbersome operations. As a result, the path of a communication can be changed easily in the course of the communication.

In addition, when a communication is carried out between the first portable communication terminal 20A and the second portable communication terminal 20B in accordance with a phone call sent by the first portable communication terminal 20A to the second portable communication terminal 20B or vice versa as described above, the control section 30 is capable of notifying the user of a communication path used in the communication by displaying information on the communication path on an incoming-call notification screen of the first portable communication terminal 20A or 20B. In addition, when the communication-path switching section 39 changes the communication path used in a communication between the first portable communication terminal 20A and the second portable communication terminal 20B from the public communication-line network 11 to the Internet 12 or vice versa in the course of the communication, the communication-path switching section 39 notifies the control section 30 of the post-switching communication path. Thus, even if the communication-path switching section 39 changes the communication path used in a communication between the first portable communication terminal 20A and the second portable communication terminal 20B from the public communication-line network 11 to the Internet 12 or vice versa in the course of the communication, the control section 30 is capable of notifying the users of the post-switching communication path by displaying information on the post-switching communication path on a predetermined display screen of each of the first portable communication terminal 20A and the second portable communication terminal 20B. That is to say, the control section 30 is capable of letting the user be aware of the post-switching communication path.

In addition, the input specifying section 31 is provided with a first communication-path specifying button to be operated by the user to specify the public communication-line network 11 as a desired communication path to be used in a communication between the first portable communication terminal 20A and the second portable communication terminal 20B and a second communication-path specifying button to be operated by the user to specify the Internet 12 as a desired communication path to be used in a communication between the first portable communication terminal 20A and the second portable communication terminal 20B. In addition, when the user operates either the first or second communication-path specifying button provided on the input specifying section 31 by, for example, pressing the button in order to specify the public communication-line network 11 or the Internet 12 as a desired communication path to be used in the course of a communication carried out between the first portable communication terminal 20A and the second portable communication terminal 20B in accordance with an incoming phone call made by another user operating the second portable communication terminal 20B, the control section 30 notifies the communication-path determination section 38 that a desired communication path has been specified by the user and informs the communication-path switching section 39 of the specified desired communication path.

When the control section 30 notifies the communication-path determination section 38 that a desired communication path to be used in a communication between the first portable communication terminal 20A and the second portable communication terminal 20B has been specified by the user in the course of the communication, the communication-path determination section 38 produces a result of determination as to whether the public communication-line network 11 or the Internet 12 is being used in the communication as the present communication path in the same way as what has been described before and compares the present communication path with the desired communication path specified by the user. Then, the same processing as what has been described before is carried out. Thus, when the user specifies a desired communication path to be used in a communication between the first portable communication terminal 20A and the second portable communication terminal 20B in the course of the communication and, as a result of the comparison, the communication-path determination section 38 determines that the communication path specified by the user as a desired communication path to be used in a communication between the first portable communication terminal 20A and the second portable communication terminal 20B is not the same communication path as a communication path currently being used in the communication as the present communication path, the communication-path switching section 39 is capable of changing the present communication path to the specified communication path. That is to say, the communication-path switching section 39 is capable of switching the present communication path from the public communication-line network 11 to the Internet 12 or from the Internet 12 to the public communication-line network 11.

If the communication-path determination section 38 produces a comparison result indicating that the communication path specified by the user as a communication path to be used in a communication between the first portable communication terminal 20A and the second portable communication terminal 20B is the same communication path as the communication path currently being used in the communication as the present communication path, on the other hand, the communication-path switching section 39 does not change the present communication path to the specified desired communication path. To put it concretely, if the communication path currently being used in the communication as the present communication path is the public communication-line network 11 and the user specifies a desired communication path as a communication path to be used in a communication between the first portable communication terminal 20A and the second portable communication terminal 20B in an operation carried out by mistakenly pressing the first communication-path specifying button of the input specifying section 31, the communication-path switching section 39 does not change the present communication path to the specified desired communication path. By the same token, if the communication path currently being used in the communication as the present communication path is the Internet 12 and the user specifies a desired communication path as a communication path to be used in a communication between the first portable communication terminal 20A and the second portable communication terminal 20B in an operation carried out by mistakenly pressing the second communication-path specifying button of the input specifying section 31, the communication-path switching section 39 does not change the present communication path to the specified desired communication path either. As a result, it is possible to prevent the processing load borne by the first portable communication terminal 20A from increasing unnecessarily.

In this way, while a communication is being carried out through the present communication path between the first portable communication terminal 20A and the second portable communication terminal 20B in accordance with an incoming phone call received from the second portable communication terminal 20B, the user of the first portable communication terminal 20A is capable of specifying a different communication path as a desired communication path to be used in the communication by carrying out a simple operation to merely press the first or second communication-path specifying button of the input specifying section 31 in order to switch the present communication path from the public communication-line network 11 to the Internet 12 or from the Internet 12 to the public communication-line network 11 with ease provided that the first portable communication terminal 20A and the second portable communication terminal 20B are currently located in the communication areas of different base stations or different access points.

To put it concretely, let us assume for example that, while a communication is being carried out through the public communication-line network 11 between the first portable communication terminal 20A and the second portable communication terminal 20B in accordance with an incoming portable phone call received from a user operating the second portable communication terminal 20B to serve as a phone conversation partner of the user of the first portable communication terminal 20A, the user of the first portable communication terminal 20A enters, for example, the inside of a train station and the inside of a train station is the communication area of an access point whereas the second portable communication terminal 20B is located in the communication area of another access point. The user of the first portable communication terminal 20A thinks that the inside of the train station may probably be in the communication area of an access point and desires, if possible, to have a phone conversation with the user of the second portable communication terminal 20B in a communication making use of the Internet 12 that does not charge a communication fee to the users. In this case, the user of the first portable communication terminal 20A can carry out a simple operation to merely press the second communication-path specifying button of the input specifying section 31 to specify the Internet 12 as a desired communication path in order to easily switch the present communication path between the first portable communication terminal 20A and the second portable communication terminal 20B currently carrying out the communication making use of the public communication-line network 11 from the public communication-line network 11 to the Internet 12. As a result, the present communication path used in a communication can be changed with ease in the course of the communication.

As another example, let us assume that, while a communication is being carried out through the Internet 12 between the first portable communication terminal 20A and the second portable communication terminal 20B in accordance with an incoming portable phone call received from a user operating the second portable communication terminal 20B to serve as a phone conversation partner of the user of the first portable communication terminal 20A, the user of the first portable communication terminal 20A must move from the inside of a coffeehouse in the communication area of an access point to the outside of the coffeehouse whereas both the first portable communication terminal 20A and the second portable communication terminal 20B are located in the communication areas of base stations. The user of the first portable communication terminal 20A thinks that the outside of the coffeehouse may probably be outside the communication area of the access point and desires, if possible, to continue the phone conversation with the user of the second portable communication terminal 20B in a communication making use of the public communication-line network 11 that allows the phone conversation to be sustained more easily. In this case, the user of the first portable communication terminal 20A can carry out a simple operation to merely press the first communication-path specifying button of the input specifying section 31 to specify the public communication-line network 11 as a desired communication path in order to easily switch the present communication path between the first portable communication terminal 20A and the second portable communication terminal 20B currently carrying out the communication making use of the Internet 12 from the Internet 12 to the public communication-line network 11. As a result, the present communication path used in a communication can be changed with ease in the course of the communication.

### (2-4) Procedure of Communication-Path Switching Processing

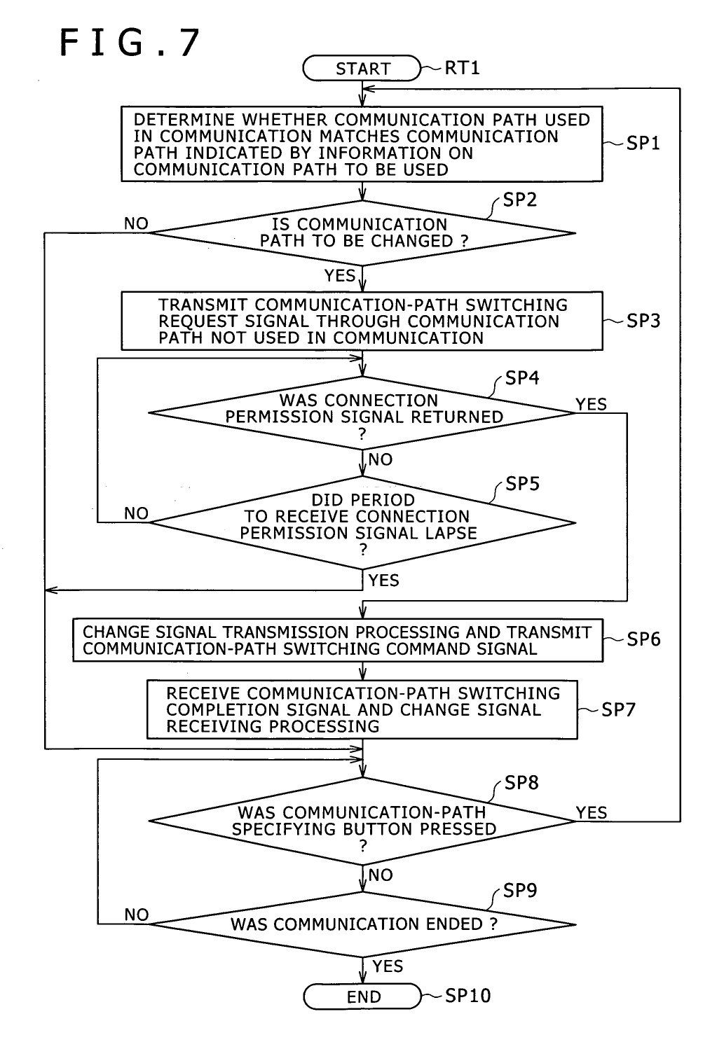

By referring to a flowchart shown in FIG. 7, the following description explains details of a procedure RT1 of processing carried out by the first portable communication terminal 20A serving as the originator of a communication-path switching request to change the communication path used in a communication carried out between the first portable communication terminal 20A and the second portable communication terminal 20B serving as the partner of the originator of the communication-path switching request from the public communication-line network 11 to the Internet 12 or vice versa in the course of the communication. In the following description, the processing carried out by the first portable communication terminal 20A serving as the originator of a communication-path switching request to change the communication path used in a communication between the first portable communication terminal 20A and the second portable communication terminal 20B from the public communication-line network 11 to the Internet 12 or vice versa in the course of the communication is referred to as first communication-path switching processing whereas the procedure for carrying out the first communication-path switching processing is referred to as a first communication-path switching processing procedure RT1. After the connection of a communication between the first portable communication terminal 20A and the second portable communication terminal 20B is established in accordance with an incoming phone call received from the second portable communication terminal 20B, the control section 30 employed in the first portable communication terminal 20A starts the first communication-path switching processing procedure RT1 with a step SP1 at which the present communication path actually used in the communication between the first portable communication terminal 20A and the second portable communication terminal 20B is compared with a communication path specified by the user of the first portable communication terminal 20A in order to produce a result of determination as to whether or not the present communication path is the same communication path as the specified communication path. In this case, the communication path specified by the user is a communication path indicated by communication path information stored in the storage section 32 as information specified by the user or information set in advance at the factory manufacturing the first portable communication terminal 20A or a communication path specified by the user in an operation carried out on the input specifying section 31 by pressing the first or the second communication-path specifying button. As described before, in this specification, the specified communication path indicated by communication path information stored in the storage section 32 as information specified by the user or information set in advance at the factory manufacturing the first portable communication terminal 20A is referred to as a default communication path. On the other hand, the specified communication path specified by the user in an operation carried out on the input specifying section 31 by pressing the first or the second communication-path specifying button is referred to as a desired communication path. Then, the flow of the first communication-path switching processing procedure RT1 executed by the control section 30 goes on to a step SP2.

At the step SP2, the control section 30 executes control to produce a result of determination as to whether or not the present communication path is to be replaced with the specified communication path on the basis of the comparison result produced in the process carried out at the step SP1. A negation determination result produced in the process carried out at the step SP2 indicates that the present communication path actually used in the communication between the first portable communication terminal 20A and the second portable communication terminal 20B is not to be replaced with the specified communication path specified by the user of the first portable communication terminal 20A. The negation determination result is produced in the process carried out at the step SP2 in order to indicate that the comparison result produced in the process carried out at the step SP1 shows that the present communication path is the same communication path as the specified communication path. In this case, the flow of the first communication-path switching processing procedure RT1 executed by the control section 30 goes on to a step SP8.

On the other hand, an affirmation determination result produced in the process carried out at the step SP2 indicates that the present communication path actually used in the communication between the first portable communication terminal 20A and the second portable communication terminal 20B is to be replaced with the specified communication path specified by the user of the first portable communication terminal 20A. The affirmation determination result is produced in the process carried out at the step SP2 in order to indicate that the comparison result produced in the process carried out at the step SP1 shows that the present communication path is not the same communication path as the specified communication path. In this case, the flow of the first communication-path switching processing procedure RT1 executed by the control section 30 goes on to a step SP3.

At the step SP3, the control section 30 executes control to send a communication-path switching request signal to the second portable communication terminal 20B through a communication path other than the present communication path used in the communication carried out at the present time. The communication path other than the present communication path is, for example, the specified communication path. Then, the flow of the first communication-path switching processing procedure RT1 executed by the control section 30 goes on to a step SP4.

At the step SP4, the control section 30 enters a state of waiting for a connection permission signal to be sent by the second portable communication terminal 20B in response to the communication-path switching request signal and executes control to produce a result of determination as to whether or not the connection permission signal has been received from the second portable communication terminal 20B. An affirmation determination result produced in the process carried out at the step SP4 indicates that the connection permission signal has been received from the second portable communication terminal 20B. The affirmation determination result produced in the process carried out at the step SP4 reveals a successful process to establish a connection of a communication between the first portable communication terminal 20A and the second portable communication terminal 20B through the specified communication path other than the present communication path used in the communication carried out at the present time. In this case, the flow of the first communication-path switching processing procedure RT1 executed by the control section 30 goes on to a step SP6.

On the other hand, a negation determination result produced in the process carried out at the step SP4 indicates that the connection permission signal has not been received from the second portable communication terminal 20B. The negation determination result produced in the process carried out at the step SP4 means that a process is still being carried out to establish a connection of a communication between the first portable communication terminal 20A and the second portable communication terminal 20B through the specified communication path other than the present communication path used in the communication carried out at the present time. In this case, the flow of the first communication-path switching processing procedure RT1 executed by the control section 30 goes on to a step SP5.

At the step SP5, the control section 30 executes control to produce a result of determination as to whether or not a predetermined period to receive a connection permission signal has lapsed. An affirmation determination result produced in the process carried out at the step SP5 indicates that the predetermined period to receive a connection permission signal has lapsed. The affirmation determination result produced in the process carried out at the step SP5 reveals an unsuccessful process to establish a connection of a communication between the first portable communication terminal 20A and the second portable communication terminal 20B through the specified communication path other than the present communication path used in the communication carried out at the present time. In this case, the flow of the first communication-path switching processing procedure RT1 executed by the control section 30 goes on to the step SP8.

On the other hand, a negation determination result produced in the process carried out at the step SP5 indicates that the predetermined period to receive a connection permission signal has not lapsed. The negation determination result produced in the process carried out at the step SP5 means that a process is still being carried out to establish a connection of a communication between the first portable communication terminal 20A and the second portable communication terminal 20B through the specified communication path other than the present communication path used in the communication carried out at the present time. In this case, the flow of the first communication-path switching processing procedure RT1 executed by the control section 30 goes back to the step SP4 in order to repeat the processes of the steps SP4 and SP5. As a matter of fact, the processes of the steps SP4 and SP5 are carried out repeatedly in a loop as long as the determination results produced in the processes of both the steps SP4 and SP5 are both a negation. As the determination result produced in the process of either the step SP4 or SP5 becomes an affirmation, the flow of the first communication-path switching processing procedure RT1 executed by the control section 30 gets out from the loop.

At the step SP6, the control section 30 executes control to terminate a process to send signals to the second portable communication terminal 20B through the present communication path used in the communication carried out at the present time and starts a process to send signals to the second portable communication terminal 20B through the specified communication path other than the present communication path used in the communication carried out at the present time. That is to say, the control section 30 executes control to change the process to send signals to the second portable communication terminal 20B. Then, the control section 30 executes control to send a communication-path switching command signal for switching the communication path to the second portable communication terminal 20B. Subsequently, the flow of the first communication-path switching processing procedure RT1 executed by the control section 30 goes on to a step SP7.

At the step SP7, the control section 30 executes control to receive a communication-path switching completion signal sent by the second portable communication terminal 20B in response to the communication-path switching command signal. The communication-path switching completion signal indicates that a process carried out by the second portable communication terminal 20B to switch the communication path has been completed. When the communication-path switching completion signal is received from the second portable communication terminal 20B, the control section 30 executes control to terminate a process to receive signals from the second portable communication terminal 20B through the present communication path used in the communication carried out at the present time and starts a process to receive signals from the second portable communication terminal 20B through the specified communication path other than the present communication path used in the communication carried out at the present time. That is to say, the control section 30 executes control to change the signal receiving process. In this way, the control section 30 executes control to change the communication path used in a communication between the first portable communication terminal 20A and the second portable communication terminal 20B in the course of the communication. Subsequently, the flow of the first communication-path switching processing procedure RT1 executed by the control section 30 goes on to the step SP8.

At the step SP8, the control section 30 executes control to produce a result of determination as to whether or not the user of the first portable communication terminal 20A has operated the input specifying section 31 by pressing the first or second communication-path specifying button in the course of a communication between the first portable communication terminal 20A and the second portable communication terminal 20B. An affirmation determination result produced in the process carried out at the step SP8 indicates that the user has operated the input specifying section 31 by pressing the first or second communication-path specifying button in the course of a communication between the first portable communication terminal 20A and the second portable communication terminal 20B in order to specify a desired communication path. The affirmation determination result produced in the process carried out at the step SP8 reveals a desire to change the communication path. In this case, the flow of the first communication-path switching processing procedure RT1 executed by the control section 30 goes back to the step SP1 in order to repeat the processes of the steps SP1 to SP7.

On the other hand, a negation determination result produced in the process carried out at the step SP8 indicates that the user has not operated the input specifying section 31 by pressing the first or second communication-path specifying button in the course of a communication between the first portable communication terminal 20A and the second portable communication terminal 20B in order to specify a communication path. The negation determination result produced in the process carried out at the step SP8 reveals no desire to change the communication path. In this case, the flow of the first communication-path switching processing procedure RT1 executed by the control section 30 goes on to a step SP9.

At the step SP9, the control section 30 executes control to produce a result of determination as to whether or not the communication between the first portable communication terminal 20A and the second portable communication terminal 20B has been ended. An affirmation determination result produced in the process carried out at the step SP9 indicates that the communication between the first portable communication terminal 20A and the second portable communication terminal 20B has been ended. The affirmation determination result produced in the process carried out at the step SP9 means that the user of the first portable communication terminal 20A or the second portable communication terminal 20B has carried out a communication terminating operation determined in advance in order to discontinue the communication. In this case, the flow of the first communication-path switching processing procedure RT1 executed by the control section 30 goes on to a step SP10 in order to end the execution of the first communication-path switching processing procedure RT1.

On the other hand, a negation determination result produced in the process carried out at the step SP9 indicates that the communication between the first portable communication terminal 20A and the second portable communication terminal 20B has not been ended. The negation determination result produced in the process carried out at the step SP9 means that the user of the first portable communication terminal 20A or the second portable communication terminal 20B has not carried out a communication terminating operation determined in advance in order to discontinue the communication, that is, the phone conversation between the users of the first portable communication terminal 20A and the second portable communication terminal 20B is still going on. In this case, the flow of the first communication-path switching processing procedure RT1 executed by the control section 30 goes back to the step SP8 in order to repeat the processes of the steps SP8 and SP9. As a matter of fact, the processes of the steps SP8 and SP9 are carried out repeatedly in a loop as long as the determination results produced in the processes of both the steps SP8 and SP9 are both a negation. As the determination result produced in the process of either the step SP8 or SP9 becomes an affirmation, the flow of the first communication-path switching processing procedure RT1 executed by the control section 30 gets out from the loop.

In accordance with the first communication-path switching processing procedure RT1 described above, the control section 30 employed in the first portable communication terminal 20A serving as the originator of the communication-path switching request is capable of switching the communication path used in a communication between the first portable communication terminal 20A and the second portable communication terminal 20B from the public communication-line network 11 to the Internet 12 or vice versa in the course of the communication.

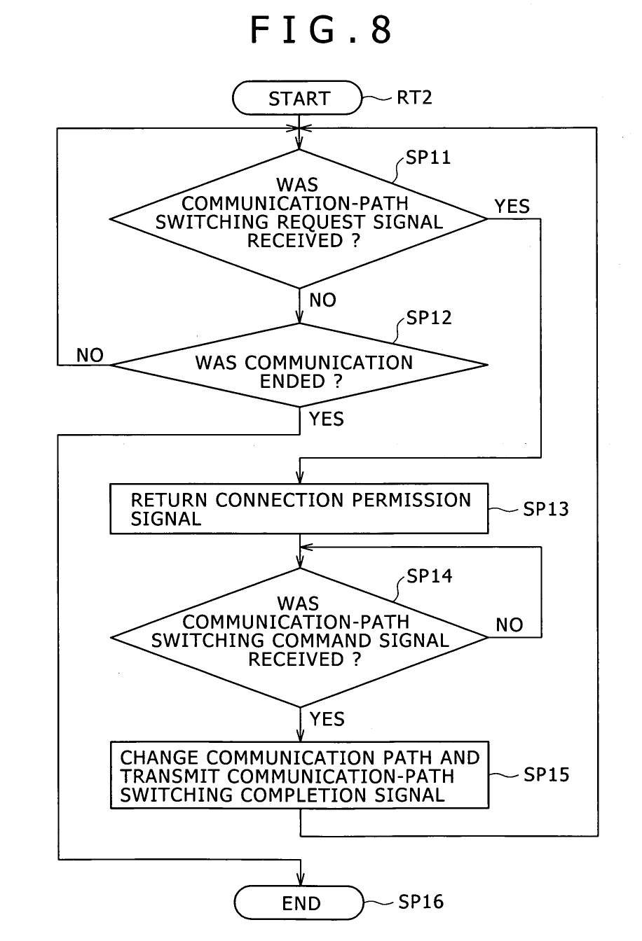

By referring to a flowchart shown in FIG. 8, the following description explains details of a procedure RT2 of processing carried out by the first portable communication terminal 20A serving as the partner of the originator of a communication-path switching request to change the communication path used in a communication between the first portable communication terminal 20A and the second portable communication terminal 20B serving as the originator of a communication-path switching request from the public communication-line network 11 to the Internet 12 or vice versa in the course of the communication. In the following description, the processing carried out by the first portable communication terminal 20A serving as the partner of the originator of a communication-path switching request to change the communication path used in a communication carried out between the first portable communication terminal 20A and the second portable communication terminal 20B from the public communication-line network 11 to the Internet 12 or vice versa in the course of the communication is referred to as second communication-path switching processing whereas the procedure for carrying out the second communication-path switching processing is referred to as a second communication-path switching processing procedure RT2. After the connection of a communication between the first portable communication terminal 20A and the second portable communication terminal 20B is established in accordance with an outgoing phone call from the first portable communication terminal 20A to the second portable communication terminal 20B, the control section 30 employed in the first portable communication terminal 20A starts the second communication-path switching processing procedure RT2 with a step SP11 at which the control section 30 executes control to set a state of waiting for a communication-path switching request signal to be sent by the second portable communication terminal 20B through a communication path not used in the present communication between the first portable communication terminal 20A and the second portable communication terminal 20B. In this state, the control section 30 executes control to produce a result of determination as to whether or not the communication-path switching request signal has been received from the second portable communication terminal 20B.

An affirmation determination result produced in the process carried out at the step SP11 indicates that the communication-path switching request signal has been received from the second portable communication terminal 20B. The affirmation determination result produced in the process carried out at the step SP11 shows the arrival of the communication-path switching request made by second portable communication terminal 20B. In this case, the flow of the second communication-path switching processing procedure RT2 executed by the control section 30 goes on to a step SP13.

At the step SP13, in response to the communication-path switching request signal, the control section 30 executes control to send a connection permission signal to the second portable communication terminal 20B through a communication path used for the sending of the communication-path switching request signal from the second portable communication terminal 20B to the first portable communication terminal 20A. Then, the flow of the second communication-path switching processing procedure RT2 executed by the control section 30 goes on to a step SP14.

At the step SP14, the control section 30 executes control to set a state of waiting for a communication-path switching command signal to be sent by the second portable communication terminal 20B through a communication path not used in the present communication between the first portable communication terminal 20A and the second portable communication terminal 20B in response to the connection permission signal. In this state, the control section 30 executes control to produce a result of determination as to whether or not the communication-path switching command signal has been received from the second portable communication terminal 20B. As the communication-path switching command signal is received from the second portable communication terminal 20B, the flow of the second communication-path switching processing procedure RT2 executed by the control section 30 goes on to a step SP15.

At the step SP15, the control section 30 executes control to terminate processing to receive a signal from the second portable communication terminal 20B through the present communication path used in the communication between the first portable communication terminal 20A and the second portable communication terminal 20B at the present point of time and start processing to receive a signal from the second portable communication terminal 20B through a specified communication path other than the present communication path used in the communication between the first portable communication terminal 20A and the second portable communication terminal 20B at the present point of time in order to switch the processing to receive a signal from the second portable communication terminal 20B. In addition, the control section 30 executes control to terminate processing to send a signal to the second portable communication terminal 20B through the present communication path used in the communication between the first portable communication terminal 20A and the second portable communication terminal 20B at the present point of time and start processing to send a signal to the second portable communication terminal 20B through a specified communication path other than the present communication path used in the communication between the first portable communication terminal 20A and the second portable communication terminal 20B at the present point of time in order to switch the processing to send a signal to the second portable communication terminal 20B. Then, in response to the communication-path switching command signal received from the second portable communication terminal 20B, the control section 30 executes control to send a communication-path switching completion signal to the second portable communication terminal 20B as a signal indicating the completion of the processing carried out by the first portable communication terminal 20A to switch the communication path. Subsequently, the flow of the second communication-path switching processing procedure RT2 executed by the control section 30 goes back to the step SP11.

On the other hand, a negation determination result produced in the process carried out at the step SP11 indicates that no communication-path switching request signal has been received from the second portable communication terminal 20B. The negation determination result produced in the process carried out at the step SP11 reveals no communication-path switching request made by second portable communication terminal 20B. In this case, the flow of the second communication-path switching processing procedure RT2 executed by the control section 30 goes on to a step SP12.

At the step SP12, the control section 30 executes control to produce a result of determination as to whether or not the communication between the first portable communication terminal 20A and the second portable communication terminal 20B has been ended. An affirmation determination result produced in the process carried out at the step SP12 indicates that the communication between the first portable communication terminal 20A and the second portable communication terminal 20B has been ended. The affirmation determination result produced in the process carried out at the step SP12 means that the user of the first portable communication terminal 20A or the second portable communication terminal 20B has carried out a communication terminating operation determined in advance in order to discontinue the communication. In this case, the flow of the second communication-path switching processing procedure RT2 executed by the control section 30 goes on to a step SP16 in order to end the execution of the second communication-path switching processing procedure RT2.

On the other hand, a negation determination result produced in the process carried out at the step SP12 indicates that the communication between the first portable communication terminal 20A and the second portable communication terminal 20B has not been ended. The negation determination result produced in the process carried out at the step SP12 means that neither the user of the first portable communication terminal 20A nor the second portable communication terminal 20B has carried out a communication terminating operation determined in advance in order to discontinue the communication, that is, the phone conversation between the users of the first portable communication terminal 20A and the second portable communication terminal 20B is still going on. In this case, the flow of the second communication-path switching processing procedure RT2 executed by the control section 30 goes back to the step SP11 in order to repeat the processes of the steps SP11 and SP12. As a matter of fact, the processes of the steps SP11 and SP12 are carried out repeatedly in a loop as long as the determination results produced in the processes of both the steps SP11 and SP12 are both a negation. As the determination result produced in the process of either the step SP11 or SP12 becomes an affirmation, the flow of the second communication-path switching processing procedure RT2 executed by the control section 30 gets out from the loop.

In accordance with the second communication-path switching processing procedure RT2 described above, the control section 30 employed in the first portable communication terminal 20A serving as the partner of the originator of the communication-path switching request is capable of switching the communication path used in a communication between the first portable communication terminal 20A and the second portable communication terminal 20B from the public communication-line network 11 to the Internet 12 or vice versa in the course of the communication.

In actuality, in the communication system 10, the first portable communication terminal 20A executes the first communication-path switching processing procedure RT1 whereas the second portable communication terminal 20B executes the second communication-path switching processing procedure RT2 at the same time or the first portable communication terminal 20A executes the second communication-path switching processing procedure RT2 whereas the second portable communication terminal 20B executes the first communication-path switching processing procedure RT1 at the same time in order to switch the communication path used in a communication between the first portable communication terminal 20A and the second portable communication terminal 20B from the public communication-line network 11 to the Internet 12 or vice versa in the course of the communication.

### (2-5) Operations and Effects of the First Embodiment

In the configuration described above, communication-path information showing a communication path specified by the user of the first portable communication terminal 20A is stored in advance in the first portable communication terminal 20A as a default communication path, which can be properly updated in a predetermined operation carried out by the user of the first portable communication terminal 20A on the input specifying section 31. While a communication making use of the public communication-line network 11 or the Internet 12 as between the first portable communication terminal 20A and the second portable communication terminal 20B is being carried out in accordance with an incoming phone call made by the user of the second portable communication terminal 20B as a phone call using the public communication-line network 11 or the Internet 12 as the present communication path, the present communication path is compared with the communication path specified by the user of the first portable communication terminal 20A as the default communication path stored in advance in the storage section 32 employed in the first portable communication terminal 20A as the communication-path information in order to produce a result of determination as to whether or not the present communication path is the same communication path as the communication path specified by the user of the first portable communication terminal 20A as the default communication path. If the result of the determination indicates that the present communication path is not the same communication path as the default communication path and a connection of a communication between the first portable communication terminal 20A and the second portable communication terminal 20B can be established through the default communication path, the present communication path currently used in a communication between the first portable communication terminal 20A and the second portable communication terminal 20B is replaced with the default communication path.

Thus, when a communication making use of the public communication-line network 11 or the Internet 12 between the first portable communication terminal 20A and the second portable communication terminal 20B is carried out in accordance with an incoming phone call made by the user of the second portable communication terminal 20B as a phone call using the public communication-line network 11 or the Internet 12 as the present communication path, the present communication path currently used in the communication between the first portable communication terminal 20A and the second portable communication terminal 20B can be replaced with the default communication path specified as the communication-path information stored in advance in the storage section 32 employed in the first portable communication terminal 20A without need for each of the users of the first portable communication terminal 20A and the second portable communication terminal 20B to carry out a cumbersome operation. As a result, the present communication path used in a communication can be replaced with the default communication path with ease in the course of the communication.

In addition, after a communication making use of the public communication-line network 11 or the Internet 12 between the first portable communication terminal 20A and the second portable communication terminal 20B is started in accordance with an incoming phone call made by the user of the second portable communication terminal 20B as a phone call using the public communication-line network 11 or the Internet 12 as the present communication path, the user of the first portable communication terminal 20A is allowed to carry out an operation to press the first or second communication-path specifying button of the input specifying section 31 in order to specify a desired communication path. If the user of the first portable communication terminal 20A carries out an operation to press the first or second communication-path specifying button in order to specify a desired communication path, the present communication path is compared with the desired communication path in order to produce a result of determination as to whether or not the present communication path is the same communication path as the desired communication path. If the result of the determination indicates that the present communication path is not the same communication path as the desired default communication path and a connection of a communication between the first portable communication terminal 20A and the second portable communication terminal 20B can be established through the desired communication path, the present communication path currently used in a communication between the first portable communication terminal 20A and the second portable communication terminal 20B is replaced with the desired communication path.

Thus, when a communication making use of the public communication-line network 11 or the Internet 12 between the first portable communication terminal 20A and the second portable communication terminal 20B is carried out in accordance with an incoming phone call made by the user of the second portable communication terminal 20B as a phone call using the public communication-line network 11 or the Internet 12 as the present communication path, the present communication path currently used in the communication between the first portable communication terminal 20A and the second portable communication terminal 20B can be replaced with a desired communication path specified by the user of the first portable communication terminal 20A in a simple operation to merely press the first or second communication-path specifying button of the input specifying section 31. As a result, the present communication path used in a communication can be replaced with the desired communication path with ease in the course of the communication.

In addition, after a communication making use of the public communication-line network 11 or the Internet 12 between the first portable communication terminal 20A and the second portable communication terminal 20B is started in accordance with an incoming phone call made by the user of the first portable communication terminal 20A as a phone call using the public communication-line network 11 or the Internet 12 as the present communication path, the second portable communication terminal 20B may send a communication-path switching request signal to the first portable communication terminal 20A through a communication path other than the present communication path. In this case, the present communication path currently used in a communication between the first portable communication terminal 20A and the second portable communication terminal 20B is replaced with the other communication path through which the communication-path switching request signal has been sent by the second portable communication terminal 20B to the first portable communication terminal 20A.

Thus, when a communication making use of the public communication-line network 11 or the Internet 12 between the first portable communication terminal 20A and the second portable communication terminal 20B is carried out in accordance with an incoming phone call made by the user of the first portable communication terminal 20A as a phone call using the public communication-line network 11 or the Internet 12 as the present communication path, the present communication path currently used in the communication between the first portable communication terminal 20A and the second portable communication terminal 20B can be replaced with another communication path specified in the communication-path switching request signal without need for the user of the first portable communication terminal 20A to carry out a cumbersome operation. As a result, the present communication path used in a communication can be replaced with the other communication path specified by the user of the second portable communication terminal 20B with ease in the course of the communication.

To put it in detail, in the configuration described above, the first communication section 34 is a unit for carrying out a communication with the second portable communication terminal 20B through the public communication-line network 11 whereas the second communication section 37 is a unit for carrying out a communication with the second portable communication terminal 20B through the Internet 12. In the course of a communication carried out as a communication with the second portable communication terminal 20B by making use of the present communication path connected to the first communication section 34 or the second communication section 37, the present communication path is compared with a communication path specified as a default communication path or a desired communication path. As described above, a default communication path is a communication path stored as communication-path information in advance in the storage section 32 employed in the first portable communication terminal 20A whereas a desired communication path is a communication path specified by the user of the first portable communication terminal 20A in an operation carried out on a communication-path specifying button of the input specifying section 31. For any present communication path currently being used in a communication, the default communication path specified as a communication path to replace the present communication path and the desired communication path specified as a communication path to replace the present communication path can be the public communication-line network 11 or the Internet 12. If the result of the comparison indicates that the present communication path is not the same communication path as the default communication path or the desired communication path, the first communication section 34 connected to the public communication-line network 11 being used as the present communication path for carrying out a communication with the second portable communication terminal 20B is replaced with the second communication section 37 connected to the Internet 12 to replace the public communication-line network 11, or the second communication section 37 connected to the Internet 12 being used as the present communication path for carrying out a communication with the second portable communication terminal 20B is replaced with the first communication section 34 connected to the public communication-line network 11 to replace the Internet 12 so that the present communication path is the same communication path as either of the default communication path and the desired communication path, which have been specified in the first portable communication terminal 20A serving as the communication-path switching originator. Thus, in the course of a communication with the second portable communication terminal 20B, the communication section can be switched from the first communication section 34 to the second communication section 37 or vice versa with ease and, in addition, the present communication path can be switched easily from the public communication-line network 11 to the Internet 12 or vice versa without need for each of the users to carry out a cumbersome operation.

On top of that, in the course of a communication with the second portable communication terminal 20B by making use of a specific one of the first communication section 34 and the second communication section 37 in accordance with an outgoing phone call from the first portable communication terminal 20A to the second portable communication terminal 20B, the first portable communication terminal 20A may receive a communication-path switching request signal from the second portable communication terminal 20B through the other one of the second communication section 37 and the first communication section 34. In this case, the first portable communication terminal 20A replaces the specific communication section used in the communication with the second portable communication terminal 20B with the other communication section used for receiving the communication-path switching request signal sent by the second portable communication terminal 20B serving as the communication-path switching originator. Thus, in the course of a communication with the second portable communication terminal 20B, the communication section can be switched from the first communication section 34 to the second communication section 37 or vice versa with ease and, in addition, the present communication path can be switched easily from the public communication-line network 11 to the Internet 12 or vice versa without need for each of the users to carry out a cumbersome operation.

### (2-6) Other Versions of the First Embodiment

In the case of the first embodiment described above, information peculiar to the first portable communication terminal 20A includes a portable phone number assigned to the first portable communication terminal 20A as an identification for uniquely identifying the first portable communication terminal 20A in the public communication-line network 11 and a network phone number assigned to the first portable communication terminal 20A as an identification for uniquely identifying the first portable communication terminal 20A in the Internet 12. By the same token, information peculiar to the second portable communication terminal 20B includes a portable phone number assigned to the second portable communication terminal 20B as an identification for uniquely identifying the second portable communication terminal 20B in the public communication-line network 11 and a network phone number assigned to the second portable communication terminal 20B as an identification for uniquely identifying the second portable communication terminal 20B in the Internet 12. It is to be noted, however, that the scope of the embodiment according to the present invention is by no means limited to such identifications. That is to say, any information is acceptable as long as the information can be used for uniquely identifying the first portable communication terminal 20A and the second portable communication terminal 20B in the public communication-line network 11 and the Internet 12. For example, an IP (Internet Protocol) address and a network ID (IDentification) can also be used for the Internet 12 and the public communication-line network 11 respectively as identifications. In other words, the information used for identifying the first portable communication terminal 20A and the second portable communication terminal 20B is by no means limited to specific identifications in particular.

In one case of the first embodiment described above, the first portable communication terminal 20A makes a request to replace the present communication path used in a communication between the first portable communication terminal 20A and the second portable communication terminal 20B with a communication path indicated by the communication-path information stored in advance in the storage section 32 employed in the first portable communication terminal 20A as a communication path specified by the user only after the communication has been started in accordance with an incoming phone call made by the user of the second portable communication terminal 20B as a phone call using the present communication path (as described above, the communication path indicated by the communication-path information stored in advance in the storage section 32 employed in the first portable communication terminal 20A as a communication path specified by the user is referred to as a default communication path). It is to be noted, however, that the scope of the embodiment according to the present invention is by no means limited to such an operation. For example, it is also possible to provide a configuration in which the present communication path cannot be replaced with the default communication path after the communication has been started in accordance with an incoming phone call made by the user of the second portable communication terminal 20B as a phone call using the present communication path due to some reasons. In this case, the first portable communication terminal 20A may repeatedly attempt to replace the present communication path with the default communication path. That is to say, the first portable communication terminal 20A may continuously attempt to replace the present communication path with the default communication path on a trial basis by monitoring the present communication path in polling operations. For example, the present communication path is the public communication-line network 11 whereas the default communication path is the Internet 12. However, when the communication is started in accordance with an incoming phone call made by the user of the second portable communication terminal 20B as a phone call using the public communication-line network 11 as the present communication path, the first portable communication terminal 20A is not located in the communication area of an access point. In this case, the first portable communication terminal 20A starting the communication making use of the public communication-line network 11 sustains the communication as it is. As the user of the first portable communication terminal 20A enters the inside of a train station or the like in the communication area of an access point, however, the public communication-line network 11 used as the present communication path is replaced with the Internet 12 specified as the default communication path without the need for the user of the first portable communication terminal 20A to operate the input specifying section 31 by pressing press the first or second communication-path specifying button. As a result, the present communication path used in a communication can be changed with ease in the course of the communication so as to make the first portable communication terminal 20A and the second portable communication terminal 20B even user-friendlier.

In addition, in the case of the first embodiment described above, the phone-number list NL is stored in advance in the storage section 32 employed in each of the first portable communication terminal 20A and the second portable communication terminal 20B. It is to be noted, however, that the scope of the embodiment according to the present invention is by no means limited to such a configuration. For example, it is also possible to provide a configuration in which the phone-number list NL is not stored in advance in the storage section 32 employed in the second portable communication terminal 20B. In this case, the first portable communication terminal 20A also sends personal information to the second portable communication terminal 20B, for example, at a time the first portable communication terminal 20A makes an outgoing phone call for the second portable communication terminal 20B, at a time the connection of a communication between the first portable communication terminal 20A and the second portable communication terminal 20B is established or at a time after the communication is assured. The personal information includes the name of the user owning the first portable communication terminal 20A as well as a portable phone number and a network phone number, which are assigned to the first portable communication terminal 20A. Then, from the personal information, the second portable communication terminal 20B receiving the outgoing phone call from the first portable communication terminal 20A as a phone call using a specific communication path as the present communication path acquires the portable phone number or network phone number to be used in a communication path not functioning as the present communication path. Thus, the phone-number list NL does not have to be stored in advance in the storage sections 32 employed in both the first portable communication terminal 20A and the second portable communication terminal 20B. As a result, the configurations of the first portable communication terminal 20A and the second portable communication terminal 20B can each be made simple.

In addition, it is also possible to provide a configuration in which either of the first portable communication terminal 20A and the second portable communication terminal 20B makes a phone call to the other one through a server determined in advance as a server used for storing the phone-number list NL in advance. In this case, since each of the first portable communication terminal 20A and the second portable communication terminal 20B is not used for storing the phone-number list NL, the configurations of the first portable communication terminal 20A and the second portable communication terminal 20B can each be made simple.

On top of that, in one case of the first embodiment described above, after the connection of a communication through a communication path specified by the user as a path other than the present communication path used in an already proceeding communication has been established, the present communication path is replaced with the specified communication path. It is to be noted, however, that the scope of the embodiment according to the present invention is by no means limited to such an operation. For example, it is also possible to provide a configuration in which, after the establishment of the connection of a communication through the specified communication path, quantities such as a communication speed and a communication load are measured in order to determine whether or not a phone conversation through the specified communication path can be assured before the present communication path is replaced with the specified communication path. That is to say, the present communication path is replaced with the specified communication path after a phone conversation through the specified communication path is assured. In this way, it is possible to prevent the phone conversation from being interrupted and being put in an unsustainable state after the present communication path is replaced with the specified communication path.

In addition, in one case of the first embodiment described above, when the user of the first portable communication terminal 20A already starting a communication with the second portable communication terminal 20B in accordance with an incoming call received from the second portable communication terminal 20B as a phone call using a specific communication path as the present communication path operates the input specifying section 31 by pressing the first or second communication-path specifying button in order to specify a desired communication path, the present communication path is replaced with the desired communication path. It is to be noted, however, that the scope of the embodiment according to the present invention is by no means limited to such a scheme. For example, it is also possible to provide a configuration in which the user of the first portable communication terminal 20A already starting a communication with the second portable communication terminal 20B in accordance with an outgoing call made by the user of the first portable communication terminal 20A for the second portable communication terminal 20B as a phone call using a specific communication path as the present communication path may also operate the input specifying section 31 by pressing the first or second communication-path specifying button in order to specify a desired communication path. Also in this case, the present communication path is replaced with the desired communication path. Let us assume for example that, when the user of the first portable communication terminal 20A starts a communication with the second portable communication terminal 20B in accordance with an outgoing call made by the user of the first portable communication terminal 20A for the second portable communication terminal 20B as a phone call using the public communication-line network 11 as the present communication path, the first portable communication terminal 20A is not located in the communication area of an access point. In this case, the user of the first portable communication terminal 20A starting the communication making use of the public communication-line network 11 sustains the communication as it is. As the user of the first portable communication terminal 20A enters the inside of a train station or the like in the communication area of an access point, however, the user of the first portable communication terminal 20A operates the input specifying section 31 by pressing the second communication-path specifying button in order to specify the Internet 12 as a desired communication path. At that time, the public communication-line network 11 used as the present communication path is replaced with the Internet 12 specified by the user provided that the second portable communication terminal 20B is also located in the communication area of an access point. As a result, the present communication path can be replaced with ease with a desired communication path, which is specified by the user in accordance with communication conditions.

In addition, in the case of the first embodiment described above, audio signals are exchanged between the first portable communication terminal 20A and the second portable communication terminal 20B, allowing the users of the first portable communication terminal 20A and the second portable communication terminal 20B to have a phone conversation with each other. It is to be noted, however, that the scope of the embodiment according to the present invention is by no means limited to such an application. For example, it is also possible to provide a configuration in which the first portable communication terminal 20A is provided with an image-signal generation section for generating an outgoing image signal to be sent to the second portable communication terminal 20B by the first communication section 34 or the second communication section 37 and an image display section for displaying an image based on an incoming image signal received by the first communication section 34 or the second communication section 37 from the second portable communication terminal 20B. With such a configuration, the first portable communication terminal 20A and the second portable communication terminal 20B are capable of exchanging audio and image signals, allowing the users of the first portable communication terminal 20A and the second portable communication terminal 20B to have a TV phone conversation with each other. Also in the case of such a configuration, the communication path used in a communication can be switched from one to another in the course of the communication in the same way as what has been described so far.

In addition, in the case of the first embodiment described above, the storage section 32 employed in each of the first portable communication terminal 20A and the second portable communication terminal 20B is used for storing communication-path information as information on a communication path specified for only the first portable communication terminal 20A or the second portable communication terminal 20B itself. It is to be noted, however, that the scope of the embodiment according to the present invention is by no means limited to such a configuration. For example, it is also possible to provide a configuration in which the storage section 32 employed in the first portable communication terminal 20A is used for storing communication-path information as information on a communication path specified for the first portable communication terminal 20A and communication paths each specified for a second portable communication terminal 20B owned by another user. To put it concretely, the information on a communication path specified for each second portable communication terminal 20B owned by another user is added to the phone-number list NL by associating the information on a communication path with the name of the user owning the second portable communication terminal 20B. With such a configuration, when the first portable communication terminal 20A starts a communication in accordance with an incoming phone call received from a second portable communication terminal 20B, the first portable communication terminal 20A is capable of acquiring communication-path information for the second portable communication terminal 20B making the phone call from the phone-number list NL and switching the communication path on the basis of the communication-path information.

It is also possible to provide a configuration in which the first portable communication terminal 20A compares the communication-path information stored in advance in the storage section 32 employed in the first portable communication terminal 20A as information provided for the first portable communication terminal 20A with the communication-path information acquired from the phone-number list NL as information for the second portable communication terminal 20B and, if the communication path indicated by the communication-path information stored in advance for the first portable communication terminal 20A is the same communication path as the communication path indicated by the communication-path information acquired from the phone-number list NL as information for the second portable communication terminal 20B, the present communication path used in the communication between the first portable communication terminal 20A and the second portable communication terminal 20B is replaced with the communication path indicated by the communication-path information acquired from the phone-number list NL as information for the second portable communication terminal 20B or indicated by the communication-path information stored in advance for the first portable communication terminal 20A in the storage section 32 employed in the first portable communication terminal 20A. In this way, it is possible to use a communication path agreed on by the users of both the first portable communication terminal 20A and the second portable communication terminal 20B.

It is also possible to provide a configuration in which communication-path information specified for the first portable communication terminal 20A and pieces of communication-path information each specified for a second portable communication terminal 20B owned by another user are put on a new communication-path information list created as a database. The database is then stored in the storage section 32 employed in the first portable communication terminal 20A and in the storage section 32 employed by each of the second portable communication terminals 20B.

In addition, in one case of the first embodiment described above, the present communication path used in a communication with the second portable communication terminal 20B (or any one of the second portable communication terminals 20) is replaced with a communication path specified by the user of the first portable communication terminal 20A. It is to be noted, however, that the scope of the embodiment according to the present invention is by no means limited to such a configuration. For example, it is also possible to provide a configuration in which the user of the first portable communication terminal 20A is allowed to specify pieces of communication-path information each for a second portable communication terminal 20B that may communicate with the first portable communication terminal 20A and the pieces of communication-path information each specified for a second portable communication terminal 20B are added to the phone-number list NL. As a typical alternative, the pieces of communication-path information each specified for a second portable communication terminal 20B are put on a new communication-path information list by associating each of the pieces of communication-path information with the name of the user owning the second portable communication terminal 20B for which the communication-path information is put on the new list. Then, the present communication path used in a communication with a second portable communication terminal 20B is replaced with a communication path indicated by communication-path information included on the phone-number list NL or the new communication-path information list. In this configuration, as communication-path information specified in advance, the user of the first portable communication terminal 20A usually selects the public communication-line network 11 for a user owning a second portable communication terminal 20B generally allowing a portable phone call to be made with ease and a user owning a second portable communication terminal 20B for which a network phone call is generally difficult to make. Thus, the communication path used in a communication with such a second portable communication terminal 20B can be switched from the Internet 12 to the public communication-line network 11 in the course of the communication. On the other hand, as communication-path information specified in advance, the user of the first portable communication terminal 20A usually selects the Internet 12 for a user owning a second portable communication terminal 20B generally allowing a network phone call to be made with ease and a user owning a second portable communication terminal 20B for which a portable phone call is generally difficult to make. Thus, the communication path used in a communication with such a second portable communication terminal 20B can be switched from the public communication-line network 11 to the Internet 12 in the course of the communication. As a result, for each other user making a phone call for the first portable communication terminal 20A, the communication path used in a communication with such the second portable communication terminal 20B owned by the other user can be switched from the public communication-line network 11 to the Internet 12 or vice versa in the course of the communication.

In addition, as a communication path, the first embodiment described above makes use of the public communication-line network 11 usable for communications by execution of the portable phone function or the Internet 12 usable for communications by execution of the network phone function such as a skype function. It is to be noted, however, that the scope of the embodiment according to the present invention is by no means limited to the public communication-line network 11 and the Internet 12. For example, it is also possible to provide a configuration in which, as a typical communication path, a stationary phone line network usable for communications by execution of a stationary phone function is utilized. In addition, the network phone function is by no means limited to the skype function. For example, an instant messenger function such as the MSN (Micro Soft Network) function or the like can also be adopted. In this case, in addition to the capability of switching the present communication path from the public communication-line network 11 to the Internet 12 or vice versa in accordance with the default communication path indicated by the communication-path information or in accordance with a desired communication path specified by pressing the first or second communication-path specifying button of the input specifying section 31, with the Internet 12 selected for example, one of the skype function, the MSN function or another instant messenger function can be selected as the network phone function in accordance with factors such as the communication speed and the communication fee. In addition, if one of the skype function, the MSN function or another instant messenger function is selected as the network phone function, the selected function can be executed for a communication path other than the public communication-line network 11 and the Internet 12. To put it concretely, the network phone numbers are classified into skype phone numbers, MSN phone-numbers and other-type network phone numbers. A skype phone number is a network phone number conforming to the skype function whereas an MSN phone number is a network phone number conforming to the MSN function. Another-type network phone number is a network phone number conforming to another instant messenger function. That is to say, not only the communication path used in a communication between the first portable communication terminal 20A and the second portable communication terminal 20B can be switched from the public communication-line network 11 to the Internet 12 or vice versa in the course of the communication, but the communication path used in the communication can also be switched among the public communication-line network 11, the Internet 12, the stationary phone line network and any other network added in accordance with the type of the network phone set.

In addition, in one case of the first embodiment described above, the first portable communication terminal 20A starting a communication with the second portable communication terminal 20B in accordance with an incoming phone call received from the second portable communication terminal 20B makes a request to change the present communication path used in the communication to another communication path according to the communication-path information stored in advance in the storage section 32 employed in the first portable communication terminal 20A. It is to be noted, however, that the scope of the embodiment according to the present invention is by no means limited to such a configuration. For example, it is also possible to provide a configuration in which, the first portable communication terminal 20A starting a communication with the second portable communication terminal 20B in accordance with an outgoing phone call made for the second portable communication terminal 20B makes a request to change the present communication path used in the communication to another communication path according to the communication-path information stored in advance in the storage section 32 employed in the first portable communication terminal 20A. For example, the user of the first portable communication terminal 20A mistakenly makes an outgoing phone call for the second portable communication terminal 20B as a phone call using the public communication-line network 11 as the present communication path in spite of the fact that the Internet 12 with no communication cost has been specified in advance as the communication-path information, and the communication environment allows the Internet 12 to be used as the path of a communication with the second portable communication terminal 20B. Even though the first portable communication terminal 20A has been undesirably connected to the second portable communication terminal 20B through the public communication-line network 11, the first portable communication terminal 20A is still capable of switching the communication path from the public communication-line network 11 to the Internet 12. In addition, the communication path can be changed with ease to a desired communication path specified by the user.

In addition, in the case of the first embodiment described above, the communication-path determination section 38 recognizes a communication path used in a communication at the present time. It is to be noted, however, that the scope of the embodiment according to the present invention is by no means limited to such a configuration. For example, it is also possible to provide a configuration in which the communication-path determination section 38 requests the control section 30 to recognize a communication path used in a communication at the present time and notify the communication-path determination section 38 of the recognized communication path.

In addition, in the case of the first embodiment described above, the communication path is switched from one to another on the basis of a communication-path switching command signal and a communication-path switching completion signal, which are exchanged between the first portable communication terminal 20A and the second portable communication terminal 20B. It is to be noted, however, that the scope of the embodiment according to the present invention is by no means limited to such a configuration. For example, it is also possible to provide a configuration in which a timer is set as a timer for generating a common timing shared by the first portable communication terminal 20A and the second portable communication terminal 20B and the communication path is switched from one to another with a timing indicated by the timer. The following description explains a typical concrete communication-path switching technique for switching the communication path from the public communication-line network 11 to the Internet 12 by making use of the timer.

When the first portable communication terminal 20A receives a connection permission signal sent by the second portable communication terminal 20B through the Internet 12 allowing a connection of a communication through the Internet 12 to be established, the control section 30 employed in the first portable communication terminal 20A controls the audio-signal generation section 35 to supply outgoing audio data being output to the first communication section 34 also to the second communication section 37. The second communication section 37 carries out processing determined in advance on the outgoing audio data received from the audio-signal generation section 35 in order to generate an outgoing audio signal and sends the signal to the second portable communication terminal 20B serving as a communication partner through the Internet 12. After the arrival of the connection permission signal, the control section 30 also controls the second communication section 37 to receive an incoming audio signal sent by the second portable communication terminal 20B through the Internet 12 as a signal representing a voice output by the user of the second portable communication terminal 20B. The second communication section 37 carries out processing determined in advance on the incoming audio signal in order to generate the same incoming audio data as incoming audio data also generated by the first communication section 34 from the same incoming audio signal also received by the first communication section 34 through the public communication-line network 11. By the way, even though the second communication section 37 is generating incoming audio data, the control section 30 is also capable of executing control to prevent the incoming audio data generated by the second communication section 37 from being output to the voice output section 36 while the first communication section 34 is receiving an incoming audio signal sent by the second portable communication terminal 20B through the public communication-line network 11. Thus, the voice output section 36 outputs a voice based only on the incoming output data generated by the first communication section 34. That is to say, the voice output section 36 outputs a voice based only on the incoming output signal received by the first communication section 34 from the second portable communication terminal 20B through the public communication-line network 11. Therefore, the control section 30 is capable of proactively preventing the voice generated by the voice output section 36 from falling into disorder and/or being interfered by another voice due to the fact that the voice output section 36 is generating a voice based on the incoming output data generated by the first communication section 34 and a voice based on the incoming output data generated by the second communication section 37 and outputting both the voices at the same time. As a result, it is possible to prevent the users having a phone conversation from feeling uncomfortable about the communication system 10.

When a connection of a communication with the second portable communication terminal 20B through the Internet 12 is established, the control section 30 controls the second communication section 37 to, for example, set an initial value in the timer for generating a common timing shared by processing carried out in the first portable communication terminal 20A and processing carried out in the second portable communication terminal 20B in order to set the first portable communication terminal 20A in a state of being synchronized to the second portable communication terminal 20B.

As described above, when a connection of a communication with the second portable communication terminal 20B through the Internet 12 is established, the second communication section 37, for example, sets an initial value in the timer for generating a common timing shared by processing carried out in the first portable communication terminal 20A and processing carried out in the second portable communication terminal 20B in order to put the first portable communication terminal 20A in a state of synchronization with the second portable communication terminal 20B. To put it in detail, a period between the present time and, for example, a time at which the communication-path switching section 39 starts a process to replace the first communication section 34 with the second communication section 37 is set at the timer for the purpose of time measurement as the initial value. That is to say, the communication-path switching section 39 sets switching timing data in the timer and sends the data to the second portable communication terminal 20B through the second communication section 37 and the Internet 12. The switching timing data is data representing a timing to switch the communication path used in the communication from one to another. In this case, the switching timing data is data showing a timing to switch the communication path used in the communication from the public communication-line network 11 to the Internet 12. Then, the timer starts counting down in order to measure the time set to reach the timing shown in the switching timing data. When the communication-path switching section 39 detects an event in which the contents counted down from the switching timing data in the timer reaches 0, indicating the switching timing, the communication-path switching section 39 controls the first communication section 34 to break the connection established between the first portable communication terminal 20A and the second portable communication terminal 20B serving as the communication partner through the public communication-line network 11 and, at the same time, the communication-path switching section 39 controls the second communication section 37 to output incoming audio data generated in the second communication section 37 to the voice output section 36 for generating a voice based on the incoming audio data. In this way, the communication section used in the voice-based phone conversation is switched from the first communication section 34 to the second communication section 37. In the mean time, by the same token, the switching timing data received by the second portable communication terminal 20B from the first portable communication terminal 20A is set in a timer employed in the second portable communication terminal 20B, and the timer starts counting down in order to measure the time set to reach the timing shown in the switching timing data. When the communication-path switching section 39 detects an event in which the contents counted down from the switching timing data in the timer reaches 0, indicating the switching timing, the second portable communication terminal 20B switches the communication section used in the voice-based phone conversation with the user of the first portable communication terminal 20A from the first communication section 34 to the second communication section 37. As a result, the first portable communication terminal 20A is capable of switching the communication path used in the voice-based phone conversation with the user of the second portable communication terminal 20B from the public communication-line network 11 to the Internet 12 with a timing synchronized to the second portable communication terminal 20B. In addition, by switching the communication path used in the voice-based phone conversation with the user of the second portable communication terminal 20B from the public communication-line network 11 to the Internet 12 with the timing indicated by the switching timing data, it is also possible to prevent the communication used for a phone conversation from being undesirably suspended for a long period of time due to forcible execution of the processing to switch the communication path in a state of the Internet 12 being incapable to sustain a communication for a phone conversation, for example, because of some communication troubles, which occur when the first portable communication terminal 20A switches the communication path used in the voice-based phone conversation with the user of the second portable communication terminal 20B from the public communication-line network 11 to the Internet 12 without synchronization to the second portable communication terminal 20B.

### (3) Second Embodiment

### (3-1) Configuration of the Communication System

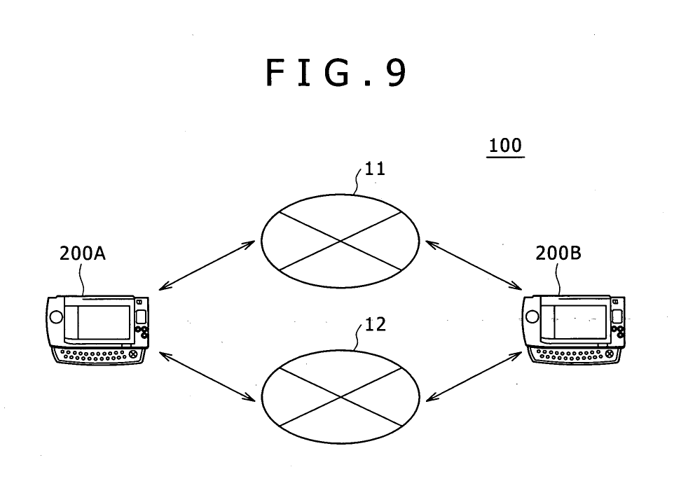

FIG. 9 is a diagram showing a communication system 100 according to a second embodiment of the present invention. As shown in the figure, the communication system 100 includes a first portable communication terminal 200A and a second portable communication terminal 200B, which each have the same configuration as the communication apparatus 1 shown in FIG. 1. In addition, the first and the second portable communication terminals 200A and 200B each have a function of a portable phone set used for a phone conversation between the users of the first and the second portable communication terminals 200A and 200B. A portable phone set is defined as a phone set making use of a public phone line network 11 as a first path of a communication through a base station provided for portable phone sets. It is to be noted that the base station is not shown in the figure. In the following description, the function of a portable phone set is referred to as a portable phone function. On top of that, the first and the second portable communication terminals 200A and 200B each also have a function of a network phone set used for a phone conversation between the users of the first and the second portable communication terminals 200A and 200B. A network phone set is defined as a phone set making use of the Internet 12 as a second path of a communication through a point of access to a LAN (Local Area Network). It is to be noted that the access point is not shown in the figure. In the following description, the function of a portable phone set is referred to as a network phone function. In actuality, the communication system 100 shown in FIG. 9 includes more portable communication terminals besides the first portable communication terminal 200A and the second portable communication terminal 200B. However, the first portable communication terminal 200A and the second portable communication terminal 200B represent any two of all portable communication terminals included in the communication system 100.

Thus, by making use of the portable phone function, either one of the first and the second portable communication terminals 200A and 200B in the communication system 100 can be connected to the base station through a radio connection and is thus made capable of carrying out a communication for a phone conversation with the other one of the first and the second portable communication terminals 200A and 200B from the base station through the public communication-line network 11, which is connected to the base station. By the same token, by making use of the network phone function, either one of the first and the second portable communication terminals 200A and 200B in the communication system 100 can be linked to the access point through a radio connection and is thus made capable of carrying out a communication for a phone conversation with the other one of the first and the second portable communication terminals 200A and 200B from the access point through the Internet 12, which is connected to the access point.

### (3-2) Circuit Configuration of the Portable Communication Terminal

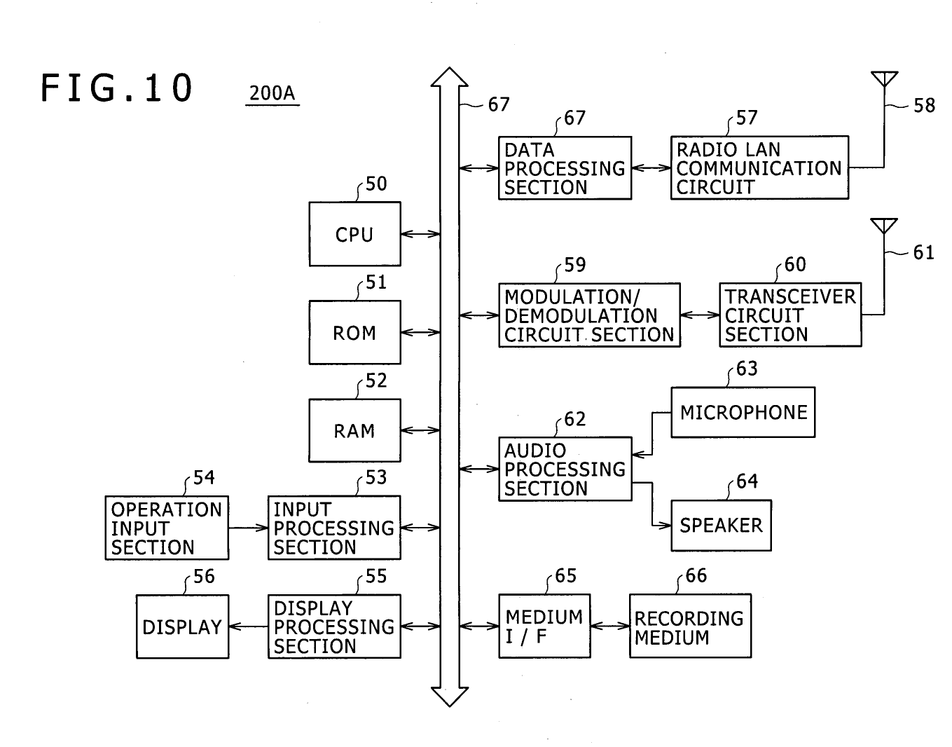

The first and the second portable communication terminals 200A and 200B, which are employed in the communication system 100, have same configurations with each other. Thus, the detailed hardware configuration of only the first portable communication terminal 200A is explained below by referring to a functional block diagram of FIG. 10. When the user carries out an operation on a operation input section 54 including a variety of operation keys provided on the surface of the first portable communication terminal 200A in order to enter an input to the first portable communication terminal 200A, the operation input section 54 recognizes the operation representing the entered input and generates an operation input signal representing the operation. The operation input section 54 then supplies the operation input signal to an input processing section 53. The input processing section 53 carries out processing determined in advance on the operation input signal in order to convert the signal into an operation command and supplies the command to a CPU 50 through a bus 67.

The CPU 50 reads out a variety of programs such as a basic program and application programs from a ROM 51 and loads the programs into a RAM 52 for execution through the bus 67. The CPU 50 controls the entire first portable communication terminal 200A by execution of the programs loaded in the RAM 52. The CPU 50 also carries out various kinds of processing determined in advance and various kinds of processing according to operation commands received from the input processing section 53.

In a portable phone mode based on execution of the portable phone function, the CPU 50 controls an audio processing section 62 to convert an outgoing audio signal obtained as a result of picking an outgoing voice output by the user of the first portable communication terminal 200A into audio data. Then, the CPU 50 controls a modulation/demodulation circuit section 59 to carry out a spectrum spreading process on the audio data generated by the audio processing section 62 and supply the result of the process to a transceiver circuit section 60. The CPU 50 then controls the transceiver circuit section 60 to carry out a digital-to-analog conversion process and a frequency transformation process on the result of the spectrum spreading process in order to generate an outgoing audio signal conveying the outgoing voice and send the outgoing audio signal to a base station connected to the public communication-line network 11 by way of a portable phone antenna 61. It is to be noted that the base station is not shown in the figure.

In the mean time, the portable phone antenna 61 receives an incoming audio signal conveying an incoming voice output by the user of the second portable communication terminal 200B. At that time, the CPU 50 controls the transceiver circuit section 60 to amplify the incoming audio signal and, then, carry out a frequency transformation process and an analog-to-digital conversion process sequentially on the amplified signal. Then, the CPU 50 controls the modulation/demodulation circuit section 59 to carry out a spectrum inverse spreading process on digital data received from the transceiver circuit section 60 as a result of the analog-to-digital conversion process in order to generate incoming audio data and supply the incoming audio data to the audio processing section 62. The audio processing section 62 converts the incoming audio data into an incoming audio data signal and supplies the signal to the speaker 64 for outputting an incoming voice based on the signal. In this way, the CPU 50 allows a phone conversation between the user of the first portable communication terminal 200A and the user holding the second portable communication terminal 200B to serve as a phone conversation partner in the portable phone mode.

In a network phone mode based on execution of the network phone function, on the other hand, the CPU 50 controls the audio processing section 62 to convert an outgoing audio signal obtained as a result of picking an outgoing voice output by the user into audio data. Then, the CPU 50 controls a data processing section 67 to carry out a compression/coding process on the audio data generated by the audio processing section 62 and supply the result of the process to a radio LAN communication circuit 57. The CPU 50 then controls the radio LAN communication circuit 57 to carry out a packetization process on the result of the compression/coding process in order to generate packets conveying the outgoing voice and send the packets to an access point connected to the Internet 12 by way of an radio LAN antenna 58. It is to be noted that the access point is not shown in the figure.

In the mean time, the radio LAN antenna 58 receives an incoming audio signal conveying an incoming voice output by the user of the second portable communication terminal 200B. At that time, the CPU 50 controls the radio LAN communication circuit 57 to carry out a depacketization process on the incoming audio signal received from the radio LAN antenna 58. Then, the CPU 50 controls the data processing section 67 to carry out a decompression/decoding process on a depacketization process result received from the radio LAN communication circuit 57 in order to generate incoming audio data and supply the data to the audio processing section 62. The audio processing section 62 converts the incoming audio data into an incoming audio data signal and supplies the signal to the speaker 64 for outputting an incoming voice based on the signal. In this way, the CPU 50 allows a phone conversation between the user of the first portable communication terminal 200A and the user holding the second portable communication terminal 200B to serve as a phone conversation partner in the network phone mode.

In addition, the CPU 50 generates notification screen data used for notifying the user that a phone conversation is being carried out between the user and the conversation partner holding the second portable communication terminal 200B by execution of the portable phone function in the portable phone mode or the network phone function in the network phone mode. The CPU 50 supplies the notification screen data to a display processing section 55. The CPU 50 controls the display processing section 55 to display a notification screen on a display section 56 to show the user a screen based on the notification screen data.

In addition, the CPU 50 creates a list including a portable phone number, a network phone number and a partner name for each phone conversation partner making use of a second portable communication terminal 200B by associating the portable phone number, the network phone number and the partner name with each other. A portable phone number is a phone number assigned to a second portable communication terminal 200B as a number used when the user of the first portable communication terminal 200A makes a phone call for the second portable communication terminal 200B by executing the portable phone function in the portable phone mode. On the other hand, a network phone number is a phone number assigned to a second portable communication terminal 200B as a number used when the user of the first portable communication terminal 200A makes a phone call for the second portable communication terminal 200B by executing the network phone function in the network phone mode. Then, the CPU 50 supplies the list to a recording medium 66 by way of a medium I/F 65 to be stored in the recording medium 66. In the network phone mode or the portable phone mode, the CPU 50 reads out the list from the recording medium 66 through the medium I/F 65 and creates phone-number display screen data on the basis of the list. The CPU 50 then controls the display processing section 55 to display a phone-number display screen based on the phone-number display screen data on a display section 56 in order to show the user a portable phone number, a network phone number and a partner name for each phone conversation partner making use of a second portable communication terminal 200B. Thus, the user can select a desired phone number from the phone-number display screen as the phone number of a phone conversation partner for which the user wants to make a phone call.

By the way, as described above, the CPU 50 employed in the first portable communication terminal 200A carries out various kinds of processing by executing a variety of programs loaded from the ROM 51 into the RAM 52 and controls each piece of hardware included in the first portable communication terminal 200A. Thus, by properly selecting a communication program from the programs stored in the ROM 51 as a communication program for implementing the first communication-path switching processing procedure RT1 and the second communication-path switching processing procedure RT2, the CPU 50 employed in the first portable communication terminal 200A can be made capable of carrying out functions in the same way as the control section 30, the communication-path switching section 39 and the communication-path determination section 38 which have been described earlier explained before by referring to the functional circuit block diagram of FIG. 3. As described earlier, the first communication-path switching processing procedure RT1 and the second communication-path switching processing procedure RT2 are procedures for executing the functions of the first portable communication terminal 20A and the second portable communication terminal 20B each having a hardware configuration explained before by referring to the functional circuit block diagram of FIG. 3.

The operation input section 54 and the input processing section 53, which are employed in the first portable communication terminal 200A, can be made capable of functioning in the same way as the input specifying section 31 included in the configuration shown in FIG. 3. By the same token, the RAM 52 and the recording medium 66, which are employed in the first portable communication terminal 200A, can be made capable of functioning in the same way as the storage section 32 included in the configuration shown in FIG. 3. Likewise, the modulation/demodulation circuit section 59, the transceiver circuit section 60 and the portable phone antenna 61, which are employed in the first portable communication terminal 200A, can be made capable of functioning in the same way as the first communication section 34 included in the configuration shown in FIG. 3. Similarly, the data processing section 67, the radio LAN communication circuit 57 and the radio LAN antenna 58, which are employed in the first portable communication terminal 200A, can be made capable of functioning in the same way as the second communication section 37 included in the configuration shown in FIG. 3. By the same token, the display processing section 55 and the display section 56, which are employed in the first portable communication terminal 200A, can be made capable of functioning in the same way as the display section 33 included in the configuration shown in FIG. 3. Likewise, the audio processing section 62 and the speaker 64, which are employed in the first portable communication terminal 200A, can be made capable of functioning in the same way as the voice output section 36 included in the configuration shown in FIG. 3. Similarly, the audio processing section 62 and the microphone 63, which are employed in the first portable communication terminal 200A, can be made capable of functioning in the same way as the audio-signal generation section 35 included in the configuration shown in FIG. 3.

Thus, by selecting proper programs from a variety of programs stored in the ROM 51 as programs to be executed to carry out the functions of the first portable communication terminal 20A and the second portable communication terminal 20B, the first portable communication terminal 200A can be made capable of executing the first communication-path switching processing procedure RT1 and the second communication-path switching processing procedure RT2, which have been described before, in the same way as the first portable communication terminal 20A and the second portable communication terminal 20B. In addition, the first portable communication terminal 200A can be made capable of demonstrating the same effects as those of the first portable communication terminal 20A and the second portable communication terminal 20B.

By the way, in the case of the first portable communication terminal 200A, the communication program can be stored in advance in the ROM 51 or the communication program can be installed into the first portable communication terminal 200A from a program recording medium used for storing the communication program. The program recording medium used for storing the communication program to be installed into the first portable communication terminal 200A in an executable form can be a package recording medium, a semiconductor memory or a magnetic disk to mention a few. Examples of the package recording medium are a flexible disk, a CD-ROM and a DVD. The semiconductor memory and the magnetic disk are each a recording medium that can be used for storing a variety of programs temporarily of permanently. Instead of storing the communication program in advance in the ROM 51 or installing the communication program into the first portable communication terminal 200A from a program recording medium, the communication program can also be downloaded from a program provider through radio or wire communication means such as a LAN (Local Area Network), the Internet and a digital broadcasting satellite. As another alternative, the communication program can also be downloaded from a program provider by way of a variety of communication interfaces such as a router and a modem.

### (3-3) Other Versions of the Second Embodiment

The second embodiment described above implements the first portable communication terminal 200A explained earlier by referring to FIG. 10 as a communication apparatus provided by the present embodiment. It is to be noted, however, that implementations of the present invention are by no means limited to the second embodiment. That is to say, the present invention can be implemented in a variety of communication apparatus such as a personal computer having a microphone as well as a speaker, a portable phone set, a PHS (Personal Handy Phone System), a PDA (Personal Digital Assistant) and a stationary phone set.

In addition, in the case of the second embodiment described above, the first communication section for connecting the portable communication terminal to another portable communication terminal and communicating with the other portable communication terminal employs the modulation/demodulation circuit section 59, the transceiver circuit section 60 and the portable phone antenna 61, which are explained earlier by referring to FIG. 10. It is to be noted, however, that configurations of the present invention are by no means limited to the second embodiment. For example, it is possible to provide a configuration in which the first communication section employs the data processing section 67, the radio LAN communication circuit 57 and the radio LAN antenna 58, which are explained earlier by referring to FIG. 10.

In addition, in the case of the second embodiment described above, the second communication section for connecting the portable communication terminal to another portable communication terminal and communicating with the other portable communication terminal employs the data processing section 67, the radio LAN communication circuit 57 and the radio LAN antenna 58, which are explained earlier by referring to FIG. 10. It is to be noted, however, that configurations of the present invention are by no means limited to the second embodiment. For example, it is possible to provide a configuration in which the second communication section employs the modulation/demodulation circuit section 59, the transceiver circuit section 60 and the portable phone antenna 61, which are explained earlier by referring to FIG. 10.

In addition, in the case of the second embodiment described above, the CPU 50 explained earlier by referring to FIG. 10 also functions as a communication-path determination section for comparing a present communication path with a specified communication path at any time during a communication carried out with another portable communication terminal in order to produce a result of determination as to whether or not the present communication path is the same communication path as the specified communication path. In this case, as described before, the present communication path is the first or second communication path currently being used in the communication carried out with the other portable communication terminal whereas the specified communication path is the first or second communication path specified as a path to be used in the communication carried out with the other portable communication terminal. It is to be noted, however, that configurations of the present invention are by no means limited to such a second embodiment. That is to say, any other communication-path determination section selected from a wide range can be employed. For example, it is possible to provide a modified version employing a special communication-path determination section other than the CPU 50. The special communication-path determination section has a hardware configuration for comparing a present communication path with a specified communication path at any time during a communication carried out with another portable communication terminal in order to produce a result of determination as to whether or not the present communication path is the same communication path as the specified communication path. As described above, the present communication path is the first or second communication path currently being used in the communication carried out with the other portable communication terminal whereas the specified communication path is the first or second communication path specified as a path to be used in the communication carried out with the other portable communication terminal.

In addition, in the case of the second embodiment described above, if the determination result produced by the communication-path determination section implemented by the CPU 50 indicates that the present communication path is not the same communication path as the specified communication path, the CPU 50 explained earlier by referring to FIG. 10 also functions as a communication-path switching section for replacing the present communication path with the specified communication path in the course of the communication carried out with the other portable communication terminal. As described above, the present communication path is the first or second communication path currently being used in the communication carried out with the other portable communication terminal whereas the specified communication path is the first or second communication path specified as a path to be used in the communication carried out with the other portable communication terminal. It is to be noted, however, that configurations of the present invention are by no means limited to such a second embodiment. That is to say, any other communication-path switching section selected from a wide range can be employed. For example, it is possible to provide a modified version employing a special communication-path switching section other than the CPU 50. The special communication-path switching section has a hardware configuration for replacing the present communication path with the specified communication path in the communication carried out with the other portable communication terminal if the determination result produced by the communication-path determination section indicates that the present communication path is not the same communication path as the specified communication path. As described above, the present communication path is the first or second communication path currently being used in the communication carried out with the other portable communication terminal whereas the specified communication path is the first or second communication path specified as a path to be used in the communication carried out with the other portable communication terminal.

The present invention can be applied to a communication apparatus, a phone set, a communication system, a communication method and a communication program.

It should be understood by those skilled in the art that various modifications, combinations, sub-combinations and alternations may occur depending on design requirements and other factors insofar as they are within the scope of the appended claims or the equivalent thereof.

1. A communication apparatus comprising:
a first communication section configured to communicate with another communication apparatus through a first communication path;
a second communication section configured to communicate with said other communication apparatus through a second communication path;
a communication-path determination section configured to produce a result of determination as to whether or not a present communication path is the same communication path as a specified communication path while communicating with said other communication apparatus where said present communication path is said first or second communication path currently being used to communicate with said other communication apparatus whereas said specified communication path is said first or second communication path specified to be used to communicate with said other communication apparatus; and
a communication-path switching section configured to replace said first communication section with said second communication section or replacing said second communication section with said first communication section in order to replace said present communication path with said specified communication path while communicating with said other communication apparatus if said determination result produced by said communication-path determination section while communicating with said other communication apparatus indicates that said present communication path is not said specified communication path.

2. The communication apparatus according to claim 1, said communication apparatus further comprising:
an audio-signal generation section configured to generate an outgoing audio signal from an outgoing voice output by a user of said communication apparatus as an audio signal to be sent to said other communication apparatus through said first communication section connected to said first communication path or said second communication section connected to said second communication path; and
a voice output section configured to output an incoming voice based on an incoming audio signal received by said first communication section from said other communication apparatus through said first communication path or received by said second communication section from said other communication apparatus through said second communication path;
wherein, if said determination result produced by said communication-path determination section while communicating with said other communication apparatus indicates that said present communication path is not said specified communication path, while communicating with said other communication apparatus, said communication-path switching section
drives said first communication section or said second communication section to stop sending said outgoing audio signal to said other communication apparatus through said present communication path,
drives said first communication section or said second communication section to stop receiving said incoming audio signal sent by said other communication apparatus through said present communication path,
drives said first communication section or said second communication section to start sending said outgoing audio signal to said other communication apparatus through said specified communication path, and
drives said first communication section or said second communication section to start receiving said incoming audio signal sent by said other communication apparatus through said specified communication path.

3. The communication apparatus according to claim 2, said communication apparatus further comprising:
an image-signal generation section configured to generate an outgoing image signal from an outgoing image generated by said communication apparatus as an image signal to be sent to said other communication apparatus through said first communication section connected to said first communication path or said second communication section connected to said second communication path; and
an image display section configured to display an incoming image based on an incoming image signal received by said first communication section from said other communication apparatus through said first communication path or received by said second communication section from said other communication apparatus through said second communication path;
wherein, if said determination result produced by said communication-path determination section while communicating with said other communication apparatus indicates that said present communication path is not said specified communication path, while communicating with said other communication apparatus, said communication-path switching section
drives said first communication section or said second communication section to stop sending said outgoing audio signal and said outgoing image signal to said other communication apparatus through said present communication path,
drives said first communication section or said second communication section to stop receiving said incoming audio signal and said incoming image signal sent by said other communication apparatus through said present communication path,
drives said first communication section or said second communication section to start sending said outgoing audio signal and said outgoing image signal to said other communication apparatus through said specified communication path, and
drives said first communication section or said second communication section to start receiving said incoming audio signal and said incoming image signal sent by said other communication apparatus through said specified communication path.

4. The communication apparatus according to claim 1, wherein one of said first communication path and said second communication path is a public phone-line network whereas the other is the Internet.

5. The communication apparatus according to claim 1, said communication apparatus further comprising a list storage section configured to store an identification list showing a first identification used by said first communication section to connect with said other communication apparatus through said first communication path and a second identification used by said second communication section to connect with said other communication apparatus through said second communication path,
wherein, if said determination result produced by said communication-path determination section while communicating with said other communication apparatus indicates that said present communication path is not the same communication path as said specified communication path, while communicating with said other communication apparatus, said communication-path switching section
searches said identification list stored in said list storage section for said first or second identification to be used by said first or second communication section respectively to connect with said other communication apparatus through said specified communication path connected to respectively said first or second communication section not used for communicating with said other communication apparatus through said present communication path, and
changes said first or second communication section used for communicating with said other communication apparatus through said present communication path to respectively said second or first communication section not used for communicating with said other communication apparatus through said present communication path by making use of respectively said first or second identification obtained by searching.

6. The communication apparatus according to claim 1, said communication apparatus further comprising a communication-path information storage section configured to store information about said specified communication path,
wherein, while communicating with said other communication apparatus, said communication-path determination section
reads out said information about said specified communication path from said communication-path information storage section, and
compares said specified communication path read out from said communication-path information storage section with said present communication path in order to produce the result of determination as to whether or not said specified communication path is said present communication path.

7. The communication apparatus according to claim 6, wherein
said communication-path information storage section is used for storing information about said specified communication path for each of a plurality of other communication apparatus each capable of communicating with said communication apparatus,
wherein, while communicating with a particular one of said other communication apparatus, said communication-path determination section
reads out said information about said specified communication path used in communicating with said particular other communication apparatus from said communication-path information storage section, and
compares said specified communication path read out from said communication-path information storage section with said present communication path in order to produce the result of determination as to whether or not said specified communication path is as said present communication path.

8. The communication apparatus according to claim 1, said communication apparatus further comprising an input specifying section configured to specify said first or second communication path as a desired communication path for communications with said other communication apparatus,
wherein said communication-path determination section compares said present communication path with said desired communication path specified by said input specifying section in order to produce another result of determination as to whether or not said desired communication path is as said present communication path.

9. A phone set configured to communicate with another phone set, said phone set comprising:
a first communication section configured to communicate with another phone set through a first communication path;
a second communication section configured to communicate with said other phone set through a second communication path;
an audio-signal generation section configured to generate an outgoing audio signal from an outgoing voice output by a user of said phone set as an audio signal to be sent to said other phone set through said first communication section connected to said first communication path or said second communication section connected to said second communication path;
a voice output section configured to output an incoming voice based on an incoming audio signal received by said first communication section from said other phone set through said first communication path or received by said second communication section from said other phone set through said second communication path;
a communication-path determination section configured to produce a result of determination as to whether or not a present communication path is a specified communication path while communicating with said other phone set where said present communication path is said first or second communication path currently being used to communicate with said other phone set whereas said specified communication path is said first or second communication path specified to be used to communicate with said other phone set; and
a communication-path switching section configured to replace said first communication section with said second communication section or replacing said second communication section with said first communication section in order to replace said present communication path with said specified communication path while communicating with said other phone set;
wherein, if said determination result produced by said communication-path determination section while communicating with said other phone set indicates that said present communication path is not as said specified communication path, said communication-path switching section
drives said first communication section or said second communication section to stop sending said outgoing audio signal to said other phone set through said present communication path,
drives said first communication section or said second communication section to stop receiving said incoming audio signal sent by said other phone set through said present communication path,
drives said first communication section or said second communication section to start sending said outgoing audio signal to said other phone set through said specified communication path, and
drives said first communication section or said second communication section to start receiving said incoming audio signal sent by said other phone set through said specified communication path.

10. The phone set according to claim 9, said phone set further comprising:
an image-signal generation section configured to generate an outgoing image signal from an outgoing image generated by said phone set as an image signal to be sent to said other phone set through said first communication section connected to said first communication path or said second communication section connected to said second communication path; and
an image display section configured to display an incoming image based on an incoming image signal received by said first communication section from said other phone set through said first communication path or received by said second communication section from said other phone set through said second communication path;
wherein, if said determination result produced by said communication-path determination section while communicating with said other phone set indicates that said present communication path is not the same communication path as said specified communication path, while communicating with said other phone set, said communication-path switching section
drives said first communication section or said second communication section to stop sending said outgoing audio signal and said outgoing image signal to said other phone set through said present communication path,
drives said first communication section or said second communication section to stop receiving said incoming audio signal and said incoming image signal sent by said other phone set through said present communication path,
drives said first communication section or said second communication section to start sending said outgoing audio signal and said outgoing image signal to said other phone set through said specified communication path, and
drives said first communication section or said second communication section to start receiving said incoming audio signal and said incoming image signal sent by said other phone set through said specified communication path.

11. The phone set according to claim 9, wherein one of said first communication path and said second communication path is a public phone-line network whereas the other is the Internet.

12. The phone set according to claim 9, said phone set further comprising a list storage section configured to store an identification list showing a first identification used by said first communication section to a connect with said other phone set through said first communication path and a second identification used by said second communication section to connect with said other phone set through said second communication path,
wherein, if said determination result produced by said communication-path determination section while communicating with said other phone set indicates that said present communication path is not the same communication path as said specified communication path, while communicating with said other phone set, said communication-path switching section
searches said identification list stored in said list storage section for said first or second identification to be used by said first or second communication section respectively to connect with said other phone set through said specified communication path connected to respectively said first or second communication section not used for communicating with said other phone set through said present communication path, and
changes said first or second communication section used for communicating with said other phone set through said present communication path to respectively said second or first communication section not used for communicating with said other phone set through said present communication path by making use of respectively said first or second identification obtained by searching.

13. The phone set according to claim 9, said phone set further comprising a communication-path information storage section configured to store information about said specified communication path,
wherein, in the course of a communication with said other phone set, said communication-path determination section
reads out said information about said specified communication path from said communication-path information storage section, and
compares said specified communication path read out from said communication-path information storage section with said present communication path in order to produce the result of determination as to whether or not said specified communication path is as said present communication path.

14. The phone set according to claim 13,
wherein said communication-path information storage section is used for storing information about said specified communication path for each of a plurality of other phone sets each capable of communicating with said phone set; and
said communication-path determination section, in the course of a communicating with a particular one of said other phone sets,
reads out said information about said specified communication path used in communicating with said particular other phone set from said communication-path information storage section, and
compares said specified communication path read out from said communication-path information storage section with said present communication path in order to produce the result of determination as to whether or not said specified communication path is as said present communication path.

15. The phone set according to claim 9, said phone set further comprising an input specifying section configured to specify said first or second communication path as a desired communication path for communications with said other phone set,
wherein said communication-path determination section compares said present communication path with said desired communication path specified by said input specifying section in order to produce another result of determination as to whether or not said desired communication path is said present communication path.

16. A communication system for communicating between a first communication apparatus and a second communication apparatus,
wherein said first communication apparatus includes
a first communication section configured to communicate with said second communication apparatus through a first communication path,
a second communication section configured to communicate with said second communication apparatus through a second communication path,
a communication-path determination section configured to produce a result of determination as to whether or not a present communication path is a specified communication path while communicating with said second communication apparatus where said present communication path is said first or second communication path currently being used in said communication with said second communication apparatus whereas said specified communication path is said first or second communication path specified to be used to communicate with said second communication apparatus, and
a first communication-path switching section configured to replace said first communication section with said second communication section or replacing said second communication section with said first communication section in order to replace said present communication path with said specified communication path in the course of communicating with said second communication apparatus if said determination result produced by said communication-path determination section while communicating with said second communication apparatus indicates that said present communication path is not said specified communication path, and
wherein said second communication apparatus includes
a third communication section configured to communicate with said first communication apparatus through said first communication path,
a fourth communication section configured to communicate with said first communication apparatus through said second communication path, and
a second communication-path switching section configured to replace said third communication section with said fourth communication section or replacing said fourth communication section with said third communication section while communicating with said first communication apparatus in accordance with replacement of said first communication section with said second communication section or replacement of said second communication section with said first communication section carried out by said first communication-path switching section of said first communication apparatus.

17. The communication system according to claim 16,
wherein said first communication apparatus further includes:
a first audio-signal generation section configured to generate a first outgoing audio signal from a first outgoing voice output by a user of said first communication apparatus as a first audio signal to be sent to said second communication apparatus through said first communication section connected to said first communication path or said second communication section connected to said second communication path, and
a first voice output section configured to output a first incoming voice based on a first incoming audio signal received by said first communication section from said second communication apparatus through said first communication path or received by said second communication section from said second communication apparatus through said second communication path,
wherein said second communication apparatus further includes:
a second audio-signal generation section configured to generate a second outgoing audio signal from a second outgoing voice output by a user of said second communication apparatus as a second audio signal to be sent to said first communication apparatus through said third communication section connected to said first communication path or said fourth communication section connected to said second communication path, and
a second voice output section configured to output a second incoming voice based on a second incoming audio signal received by said third communication section from said first communication apparatus through said first communication path or received by said fourth communication section from said first communication apparatus through said second communication path,
wherein said first communication-path switching section, if said determination result produced by said communication-path determination section while communicating with said second communication apparatus indicates that said present communication path is not as said specified communication path, in the course of communicating with said second communication apparatus,
drives said first communication section or said second communication section to stop sending said first outgoing audio signal to said second communication apparatus through said present communication path,
drives said first communication section or said second communication section to stop receiving said first incoming audio signal sent by said second communication apparatus through said present communication path,
drives said first communication section or said second communication section to start sending said first outgoing audio signal to said second communication apparatus through said specified communication path, and
drives said first communication section or said second communication section to start receiving said first incoming audio signal sent by said second communication apparatus through said specified communication path, and
wherein said second communication-path switching section while communicating with said first communication apparatus, in accordance with replacement of said first communication section with said second communication section or replacement of said second communication section with said first communication section carried out by said first communication-path switching section of said first communication apparatus,
drives said third communication section or said fourth communication section to stop a sending said second outgoing audio signal to said first communication apparatus through said present communication path,
drives said third communication section or said fourth communication section to stop receiving said second incoming audio signal sent by said first communication apparatus through said present communication path,
drives said third communication section or said fourth communication section to start sending said second outgoing audio signal to said first communication apparatus through said specified communication path, and
drives said third communication section or said fourth communication section to start receiving said second incoming audio signal sent by said first communication apparatus through said specified communication path.

18. The communication system according to claim 17,
Wherein said first communication apparatus further includes
a first image-signal generation section configured to generate a first outgoing image signal from a first outgoing image generated by said first communication apparatus as a first image signal to be sent to said second communication apparatus through said first communication section connected to said first communication path or said second communication section connected to said second communication path, and
a first image display section configured to display a first incoming image based on a first incoming image signal received by said first communication section from said second communication apparatus through said first communication path or received by said second communication section from said second communication apparatus through said second communication path,
wherein said second communication apparatus further includes
a second image-signal generation section configured to generate a second outgoing image signal from a second outgoing image generated by said second communication apparatus as a second image signal to be sent to said first communication apparatus through said third communication section connected to said first communication path or said fourth communication section connected to said second communication path, and
a second image display section configured to display a second incoming image based on a second incoming image signal received by said third communication section from said first communication apparatus through said first communication path or received by said fourth communication section from said first communication apparatus through said second communication path,
wherein said first communication-path switching section, if said determination result produced by said communication-path determination section while communicating with said second communication apparatus indicates that said present communication path is not said specified communication path,
while communicating with said second communication apparatus,
drives said first communication section or said second communication section to stop sending said first outgoing audio signal and said first outgoing image signal to said second communication apparatus through said present communication path,
drives said first communication section or said second communication section to stop receiving said first incoming audio signal and said first incoming image signal sent by said second communication apparatus through said present communication path,
drives said first communication section or said second communication section to start sending said first outgoing audio signal and said first outgoing image signal to said second communication apparatus through said specified communication path, and
drives said first communication section or said second communication section to start receiving said first incoming audio signal and said first incoming image signal sent by said second communication apparatus through said specified communication path, and
wherein said second communication-path switching section in the course of said communication with said first communication apparatus, in accordance with replacement of said first communication section with said second communication section or replacement of said second communication section with said first communication section carried out by said first communication-path switching section of said first communication apparatus,
drives said third communication section or said fourth communication section to stop sending said second outgoing audio signal and said second outgoing image signal to said first communication apparatus through said present communication path,
drives said third communication section or said fourth communication section to stop receiving said second incoming audio signal and said second incoming image signal sent by said first communication apparatus through said present communication path,
drives said third communication section or said fourth communication section to start sending said second outgoing audio signal and said second outgoing image signal to said first communication apparatus through said specified communication path, and
drives said third communication section or said fourth communication section to start receiving said second incoming audio signal and said second incoming image signal sent by said first communication apparatus through said specified communication path.

19. The communication system according to claim 16, one of said first communication path and said second communication path is a public phone-line network whereas the other is the Internet.

20. A communication method adopted by a communication apparatus including a first communication section communicate with another communication apparatus through a first communication path and a second communication section configured to communicate with said other communication apparatus through a second communication path, said communication method comprising the steps of:
producing a result of determination as to whether or not a present communication path is a specified communication path while communicating with said other communication apparatus where said present communication path is said first or second communication path currently being used to communicate with said other communication apparatus whereas said specified communication path is said first or second communication path specified to be used to communicate with said other communication apparatus; and
replacing said first communication section with said second communication section or replacing said second communication section with said first communication section in order to replace said present communication path with said specified communication path in the course of communicating with said other communication apparatus if said determination result indicates that said present communication path is as said specified communication path.

21. A communication program implementing a communication method adopted by a communication apparatus including a first communication section configured to communicate with another communication apparatus through a first communication path and a second communication section configured to communicate with said other communication apparatus through a second communication path, said communication method comprising the steps of:
producing a result of determination as to whether or not a present communication path is as a specified communication path while communicating with said other communication apparatus where said present communication path is said first or second communication path currently being used to communicate with said other communication apparatus whereas said specified communication path is said first or second communication path specified to be used to communicate with said other communication apparatus; and
replacing said first communication section with said second communication section or replacing said second communication section with said first communication section in order to replace said present communication path with said specified communication path while communicating with said other communication apparatus if said determination result indicates that said present communication path is not as said specified communication path.

22. A communication apparatus comprising:
first communication means for communicating with another communication apparatus through a first communication path;
second communication means for communicating with said other communication apparatus through a second communication path;
communication-path determination means for producing a result of determination as to whether or not a present communication path is a specified communication path while communicating with said other communication apparatus where said present communication path is said first or second communication path currently being used to communicate with said other communication apparatus whereas said specified communication path is said first or second communication path specified to be used to communicate with said other communication apparatus; and
communication-path switching means for replacing said first communication means with said second communication means or replacing said second communication means with said first communication means in order to replace said present communication path with said specified communication path while communicating with said other communication apparatus if said determination result produced by said communication-path determination means while communicating with said other communication apparatus indicates that said present communication path is not said specified communication path.

23. A phone set configured to communicate with another phone set, said phone set comprising:
first communication means for communicating with said other phone set through a first communication path;
second communication means for communicating with said other phone set through a second communication path;
audio-signal generation means for generating an outgoing audio signal from an outgoing voice output by the user of said phone set as an audio signal to be sent to said other phone set through said first communication means connected to said first communication path or said second communication means connected to said second communication path;
voice output means for outputting an incoming voice based on an incoming audio signal received by said first communication means from said other phone set through said first communication path or received by said second communication means from said other phone set through said second communication path;
communication-path determination means for producing a result of determination as to whether or not a present communication path as a specified communication path while communicating with said other phone set where said present communication path is said first or second communication path currently being used in said communication with said other phone set whereas said specified communication path is said first or second communication path specified to be used in communicating with said other phone set; and
communication-path switching means for replacing said first communication means with said second communication means or replacing said second communication means with said first communication means in order to replace said present communication path with said specified communication path while communicating with said other phone set;
wherein, if said determination result produced by said communication-path determination means while communicating with said other phone set indicates that said present communication path is not said specified communication path, said communication-path switching means
drives said first communication means or said second communication means to stop sending said outgoing audio signal to said other phone set through said present communication path,
drives said first communication means or said second communication means to stop receiving said incoming audio signal sent by said other phone set through said present communication path,
drives said first communication means or said second communication means to start sending said outgoing audio signal to said other phone set through said specified communication path, and
drives said first communication means or said second communication means to start receiving said incoming audio signal sent by said other phone set through said specified communication path.

24. A communication system for communicating between a first communication apparatus and a second communication apparatus,
wherein said first communication apparatus includes
first communication means for communicating with said second communication apparatus through a first communication path,
second communication means for communicating with said second communication apparatus through a second communication path,
communication-path determination means for producing a result of determination as to whether or not a present communication path is a specified communication path while communicating with said second communication apparatus where said present communication path is said first or second communication path currently being used to communicate with said second communication apparatus whereas said specified communication path is said first or second communication path specified to be used to communicate with said second communication apparatus, and
first communication-path switching means for replacing said first communication means with said second communication means or replacing said second communication means with said first communication means in order to replace said present communication path with said specified communication path while communicating with said second communication apparatus if said determination result produced by said communication-path determination means in while communicating with said second communication apparatus indicates that said present communication path is not the same communication path as said specified communication path, and
wherein said second communication apparatus includes
third communication means for communicating with said first communication apparatus through said first communication path,
fourth communication means for communicating with said first communication apparatus through said second communication path, and
second communication-path switching means for replacing said third communication means with said fourth communication means or replacing said fourth communication means with said third communication means while communicating with said first communication apparatus in accordance with replacement of said first communication means with said second communication means or replacement of said second communication means with said first communication means carried out by said first communication-path switching means of said first communication apparatus.
